(19) United States
(12) Patent Application Publication
(10) Pub. No.: US 2006/0260115 A1
(43) Pub. Date: Nov. 23, 2006

(54) Method and apparatus for upsetting cylindrical material

(75) Inventor: Atsushi Otaki, Oyama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: SHOWA DENKO K.K., Minato-ku (JP)

(21) Appl. No.: 11/342,534

(22) Filed: Jan. 31, 2006

Related U.S. Application Data
(60) Provisional application No. 60/649,552, filed on Feb. 4, 2005.

(30) Foreign Application Priority Data
Jan. 31, 2005 (JP) 2005-24164

(51) Int. Cl. B23P 11/00

(52) U.S. Cl. 29/505; 29/34 R

(57) ABSTRACT

To provide an upsetting method for a cylindrical raw material capable of assuredly expanding a processing scheduled portion of the cylindrical raw material inwardly or outwardly so that the wall thickness increases. A core bar 40 is disposed in hollow portions 2a and 3a of a processing scheduled portion 2 and a non-processing scheduled portion 3 of the cylindrical raw material 1. The non-processing scheduled portion 3 of the raw material 1 is disposed in the restraining hole 11 of the restraining die 10. The processing scheduled portion 2 of the raw material 1 is disposed in a molding dented portion 12. The processing scheduled portion 2 of the raw material 1 is disposed in an insertion hole 21 of a guide 20. Next, the guide 20 is moved in a direction opposite to a moving direction 35 of the punch while pressurizing the processing scheduled portion 2 of the raw material 1 with the punch 30 in the axial direction, to thereby outwardly expand the processing scheduled portion 2 of the raw material 1 so that the wall thickness increased.

### CROSS REFERENCE TO RELATED APPLICATIONS

This application is an application filed under 35 U.S.C. §111(a) claiming the benefit pursuant to 35 U.S.C. §119(e)(1) of the filing date of U.S. Provisional Application No. 60/649,552 filed on Feb. 4, 2005, pursuant to 35 U.S.C. §111(b).

This application claims priority to Japanese Patent Application No. 2005-24164 filed on Jan. 31, 2005, and U.S. Provisional Application No. 60/649,552 filed on Feb. 4, 2005, the entire disclosures of which are incorporated herein by reference in their entireties.

### FIELD OF THE INVENTION

The present invention relates to an upsetting method for a cylindrical raw material and an upsetting apparatus for a cylindrical raw material for outwardly or inwardly expanding a prescribed portion of the cylindrical raw material by increasing the wall thickness thereof.

### DESCRIPTION OF THE RELATED ART

In general, upsetting is executed to expand a diameter of a processing scheduled portion of a bar-shaped material by pressurizing the bar-shaped raw material in an axial direction thereof. In this upsetting, if a material buckles at the time of the working, the obtained product (upsetting manufactured product) becomes poor in shape (e.g., wrinkles, scratches, etc.), which causes degradation in value as a product. Therefore, in order to prevent the occurrence of such buckling, the following upsetting method is conventionally known.

That is, in this method, a raw material is secured to a securing die, and the processing scheduled portion of the raw material is inserted into an insertion hole formed in a guide to be held in a buckling prevention state. Subsequently, a guide is moved in a direction opposite to a punch moving direction while pressurizing the processing scheduled portion of the raw material in the axial direction with a punch, to thereby radially expand the processing scheduled of the raw material exposed between the tip end portion of the guide and the securing die (see Patent Documents 1 and 2).

The aforementioned conventional upsetting method has been applied at the time of expanding the diameter of the processing scheduled portion of the solid raw material.

[Patent Document 1] Japanese Unexamined Laid-open Patent Publication No. S48-62646

[Patent document 2] Japanese Unexamined Laid-open Patent Publication No. H09-253782

### DISCLOSURE OF THE INVENTION

### Problems to be Solved by the Invention

In cases where only an axial part of a cylindrical raw material of a cylindrical shape, such as, e.g., a pipe shape, is to be expanded inwardly or outwardly so as to increase the wall thickness by the conventional upsetting method, in other words, in cases where wall thickness increasing processing of a cylindrical raw member is executed, there were the following problems.

That is, since the cylindrical raw material has a hollow portion therein, at the time of the upsetting, a part of the raw material tends to bend (buckles) inwardly or outwardly, causing a defective shape.

The present invention was made in view of the aforementioned technical background, and aims to provide an upsetting method for a cylindrical raw material capable of assuredly expanding a processing scheduled portion of the cylindrical raw material inwardly or outwardly so as to increase the wall thickness of the processing scheduled portion, an upsetting manufactured product obtained by the upsetting method, and an upsetting apparatus for a cylindrical raw material suitably used for the upsetting method.

### Means to Solve the Problems

The present invention provides the following means.

[1] An upsetting method for a cylindrical raw material, comprising:

disposing a core bar in hollow portions of a processing scheduled portion and a non-processing scheduled portion of the cylindrical raw material, to thereby restrain internal peripheral surfaces of the processing scheduled portion and the non-processing scheduled portion by a peripheral surface of the core bar;

disposing the non-processing scheduled portion of the raw material in a restraining hole formed in a restraining die and extended in an axial direction thereof, to thereby restrain an external peripheral surface of the non-processing scheduled portion with a peripheral surface of the restraining hole;

disposing the processing scheduled portion of the raw material in a molding dented portion formed at an axial end portion of the restraining die;

disposing the processing scheduled portion of the raw material in an insertion hole formed in a guide and extended in the axial direction thereof; and

then, moving the guide in a direction opposite to a moving direction of a punch while pressurizing the processing scheduled portion of the raw material with the punch in an axial direction to thereby outwardly expand the processing scheduled portion of the raw material within the molding dented portion so that a wall thickness of the raw material increases.

[2] The upsetting method for a cylindrical raw material as recited in the aforementioned Item 1, wherein the guide is moved by driving force of a guide driving apparatus.

[3] The upsetting method for a cylindrical raw material as recited in the aforementioned Item 1 or 2, wherein “G” satisfies an equation of
G=(X_{g}−X)P/(L₀−Xₚ−Pt₀)

where

“P” denotes an average moving speed of the punch from the moving initiation thereof,

“G” denotes an average moving speed of the guide from the moving initiation thereof,

“X₀” denotes a buckling limit length at a cross-sectional area of the processing scheduled portion of the raw material before the upsetting,

“X” denotes an initial clearance between a tip end portion of the guide and a bottom portion of the molding dented portion (0≦X≦X₀),

“L₀” denotes a length of the raw material before the upsetting required for the expanded portion,

“X_{P}” denotes a stop position of the tip end portion of the punch with respect to the bottom portion of the molding dented portion obtained from a design volume of the expanded portion,

“X_{g}” denotes a stop position of the tip end portion of the guide with respect to the bottom portion of the molding dented portion defined by the design, and

“t₀” denotes a time lag from the moving initiation of the punch to the moving initiation of the guide (0≦t₀).

[4] The upsetting method for a cylindrical raw material as recited in the aforementioned Item 1, wherein the guide is moved by pressing-back force acting on the guide generated by press-fitting the material of the processing scheduled portion of the raw material into the molding dented portion.

[5] The upsetting method for a cylindrical raw material as recited in any one of the aforementioned Items 1 to 4, wherein the tip end portion of the punch is formed into a cross-sectional shape corresponding to a cross-sectional shape of an axial end portion of the raw material.

[6] The upsetting method for a cylindrical raw material as recited in any one of the aforementioned Items 1 to 5, wherein the core bar is connected to the punch in such a manner that the core bar extends in an axial direction of the punch.

[7] The upsetting method for a cylindrical raw material as recited in the aforementioned Item 6, wherein the core bar is connected to the punch via an extensible device capable of being extended and contracted in an axial direction, and

wherein the extensible device is contracted with a movement of the punch.

[8] The upsetting method for a cylindrical raw material as recited in any one of the aforementioned Items 1 to 7, wherein the processing scheduled portion of the raw material is expanded in a state in which the portion of the processing scheduled portion of the raw material corresponding to the tip end portion of the guide is partially heated.

[9] The upsetting method for a cylindrical raw material as recited in the aforementioned Item 8, wherein the portion of the processing scheduled portion of the raw material corresponding to the tip end portion of the guide is partially induction-heated by an induction heating means.

[10] The upsetting method for a cylindrical raw material as recited in the aforementioned Item 8, wherein the axial end portion of the restraining die is partially induction-heated by an induction heating means to thereby partially heat the portion of the processing scheduled portion of the raw material corresponding to the tip end portion of the guide.

[11] The upsetting method for a cylindrical raw material as recited in any one of the aforementioned Items 8 to 10, wherein the portion of the processing scheduled portion of the raw material corresponding to the tip end portion of the guide is partially heated into a half-molten state.

[12] The upsetting method for a cylindrical raw material as recited in any one of the aforementioned Items 8 to 11, wherein the processing scheduled portion of the raw material is expanded in a state in which the portion of the processing scheduled portion of the raw material corresponding to the portion of the basal end side of the guide rather than the tip end portion of the guide is partially cooled by a cooling means.

[13] An upsetting manufactured product obtained by the upsetting method for a cylindrical raw material as recited in any one of the aforementioned Items 1 to 12.

[14] An upsetting method for a cylindrical raw material, comprising:

disposing a core bar in hollow portions of a non-processing scheduled portion of an axial intermediate portion of a cylindrical raw material and a processing scheduled portion of both axial end portions of the cylindrical raw material, to thereby restrain internal peripheral surfaces of the non-processing scheduled portion and both the processing scheduled portions by a peripheral surface of the core bar;

disposing the non-processing scheduled portion of the raw material in a restraining hole formed in a restraining die and extended in an axial direction thereof, to thereby restrain an external peripheral surface of the non-processing scheduled portion with a peripheral surface of the restraining hole;

disposing both the processing scheduled portions of the raw material in molding dented portions formed at both axial end portions of the restraining die;

disposing each processing scheduled portion of the raw material in an insertion hole formed in a guide and extended in the axial direction thereof; and

then, moving each guide in a direction opposite to a moving direction of the punch while simultaneously pressurizing each processing scheduled portion of the raw material with the punch in an axial direction to thereby outwardly expand each processing scheduled portion of the raw material within the corresponding molding dented portion so that a wall thickness of the raw material increases.

[15] The upsetting method for a cylindrical raw material as recited in the aforementioned Item 14, wherein each guide is moved by driving force of a corresponding guide driving apparatus.

[16] The upsetting method for a cylindrical raw material as recited in the aforementioned Item 14 or 15, wherein, in at least one of guides and a punch corresponding to the one of guides, “G” satisfies an equation of
G=(X_{g}−X)P/(L₀−Xₚ−Pt₀)

where

“P” denotes an average moving speed of the punch from the moving initiation thereof,

“G” denotes an average moving speed of the guide from the moving initiation thereof,

“X₀” denotes a buckling limit length at a cross-sectional area of the processing scheduled portion of the raw material before the upsetting,

“X” denotes an initial clearance between a tip end portion of the guide and a bottom portion of the molding dented portion (1≦X≦X₀),

“L₀” denotes a length of the raw material before the upsetting required for the expanded portion, “X_{P}” denotes a stop position of the tip end portion of the punch with respect to the bottom portion of the molding dented portion obtained from a design volume of the expanded portion,

“X_{g}” denotes a stop position of the tip end portion of the guide with respect to the bottom portion of the molding dented portion defined by the design, and

“t₀” denotes a time lag from the moving initiation of the punch to the moving initiation of the guide (0≦t₀).

[17] The upsetting method for a cylindrical raw material as recited in the aforementioned Item 14, wherein each guide is moved by pressing-back force acting on the guide generated by press-fitting the material of the corresponding processing scheduled portion of the raw material into the molding dented portion.

[18] The upsetting method for a cylindrical raw material as recited in any one of the aforementioned Items 14 to 17, wherein the tip end portion of each punch is formed into a cross-sectional shape corresponding to a cross-sectional shape of a corresponding axial end portion of the raw material.

[19] The upsetting method for a cylindrical raw material as recited in any one of the aforementioned Items 14 to 18, wherein the core bar is divided into divided core bar halves at the axial intermediate portion thereof, and

wherein each core bar half is connected to a corresponding punch with the divided core bar half extended in an axial direction of the punch.

[20] The upsetting method for a cylindrical raw material as recited in the aforementioned Item 19, wherein each core bar half is connected to the corresponding punch via an extensible device capable of being extended and contracted in an axial direction, and

wherein each extensible device is contracted with a movement of the corresponding punch.

[21] The upsetting method for a cylindrical raw material as recited in any one of the aforementioned Items 14 to 20, wherein each processing scheduled portion of the raw material is expanded in a state in which the portion of each processing scheduled portion of the raw material corresponding to the tip end portion of the guide is partially heated.

[22] The upsetting method for a cylindrical raw material as recited in the aforementioned Item 21, wherein the portion of each processing scheduled portion of the raw material corresponding to the tip end portion of the guide is partially induction-heated by an induction heating means.

[23] The upsetting method for a cylindrical raw material as recited in the aforementioned Item 21, wherein both the axial end portions of the restraining die are partially induction-heated by induction heating means to thereby partially heat the portion of each processing scheduled portion of the raw material corresponding to the tip end portion of the guide.

[24] The upsetting method for a cylindrical raw material as recited in any one of the aforementioned Items 21 to 23, wherein the portion of each processing scheduled portion of the raw material corresponding to the tip end portion of the guide is partially heated into a half-molten state.

[25] The upsetting method for a cylindrical raw material as recited in any one of the aforementioned Items 21 to 24, wherein each processing scheduled portion of the raw material is expanded in a state in which the portion of each processing scheduled portion of the raw material corresponding to the portion of the basal end side of the guide rather than the tip end portion of the guide is partially cooled by a cooling means.

[26] An upsetting manufactured product obtained by the upsetting method for a cylindrical raw material as recited in any one of the aforementioned Items 14 to 25.

[27] An upsetting method for a cylindrical raw material, comprising:

preparing a core bar having a core bar main body and a small diameter portion formed at an axial end portion of the core bar main body and smaller in diameter than the core bar main body;

disposing the core bar main body and the small diameter portion of the core bar in a hollow portion of a non-processing scheduled portion of a cylindrical raw material and a hollow portion of the processing scheduled portion of the cylindrical raw material, respectively, to thereby restrain the internal peripheral surface of the non-processing scheduled portion by a peripheral surface of the core bar main body and form a molding dented portion between an internal peripheral surface of the processing scheduled portion and the small diameter portion;

disposing the processing scheduled portion and the non-processing scheduled portion of the raw material in a restraining hole formed in a restraining die and extended in an axial direction, to thereby restrain external peripheral surfaces of the processing scheduled portion and the non-processing scheduled portion by a peripheral surface of the restraining hole;

disposing a guide in the hollow portion of the processing scheduled portion of the raw material, to thereby restrain the internal peripheral surface of the processing scheduled portion by the peripheral surface of the guide; and

then, moving the guide in a direction opposite to a moving direction of the punch while pressurizing the processing scheduled portion of the raw material with the punch in an axial direction to thereby inwardly expand the processing scheduled portion of the raw material with in the molding dented portion so that a wall thickness of the raw material increases.

[28] The upsetting method for a cylindrical raw material as recited in the aforementioned Item 27, wherein the guide is moved by driving force of a guide driving apparatus.

[29] The upsetting method for a cylindrical raw material as recited in the aforementioned Item 27 or 28, wherein “G” satisfies an equation of
G=(X_{g}−X)P/(L₀−Xₚ−Pt₀)

where

“P” denotes an average moving speed of the punch from the moving initiation thereof,

“G” denotes an average moving speed of the guide from the moving initiation thereof,

“X₀” denotes a buckling limit length at a cross-sectional area of the processing scheduled portion of the raw material before the upsetting,

“X” denotes an initial clearance between a tip end portion of the guide and a bottom portion of the molding dented portion (0≦X≦X₀),

“L₀” denotes a length of the raw material before the upsetting required for the expanded portion,

“X_{P}” denotes a stop position of the tip end portion of the punch with respect to the bottom portion of the molding dented portion obtained from a design volume of the expanded portion,

“X_{g}” denotes a stop position of the tip end portion of the guide with respect to the bottom portion of the molding dented portion defined by the design, and

“t₀” denotes a time lag from the moving initiation of the punch to the moving initiation of the guide (0≦t₀).

[30] The upsetting method for a cylindrical raw material as recited in the aforementioned Item 27, wherein the guide is moved by pressing-back force acting on the guide generated by press-fitting the material of the processing scheduled portion of the raw material into the molding dented portion.

[31] The upsetting method for a cylindrical raw material as recited in any one of the aforementioned Items 27 to 30, wherein the tip end portion of the punch is formed into a cross-sectional shape corresponding to a cross-sectional shape of an axial end portion of the raw material.

[32] The upsetting method for a cylindrical raw material as recited in any one of the aforementioned Items 27 to 31, wherein the core bar is connected to the guide in such a manner that the core bar extends in an axial direction of the guide.

[33] The upsetting method for a cylindrical raw material as recited in the aforementioned Item 32, wherein the core bar is connected to the guide via an extensible device capable of being extended and contracted in an axial direction, and

wherein the extensible device is extended with a movement of the guide.

[34] The upsetting method for a cylindrical raw material as recited in any one of the aforementioned Items 27 to 33, wherein the processing scheduled portion of the raw material is expanded in a state in which the portion of the processing scheduled portion of the raw material corresponding to the tip end portion of the guide is partially heated.

[35] The upsetting method for a cylindrical raw material as recited in the aforementioned Item 34, wherein the portion of the processing scheduled portion of the raw material corresponding to the tip end portion of the guide is partially induction-heated by an induction heating means.

[36] The upsetting method for a cylindrical raw material as recited in the aforementioned Item 34, wherein the axial end portion of the restraining die is partially induction-heated by an induction heating means to thereby partially heat the portion of the processing scheduled portion of the raw material corresponding to the tip end portion of the guide.

[37] The upsetting method for a cylindrical raw material as recited in any one of the aforementioned Items 34 to 36, wherein the portion of the processing scheduled portion of the raw material corresponding to the tip end portion of the guide is partially heated into a half-molten state.

[38] The upsetting method for a cylindrical raw material as recited in any one of the aforementioned Items 34 to 37, wherein the processing scheduled portion of the raw material is expanded in a state in which the portion of the processing scheduled portion of the raw material corresponding to the portion of the basal end side of the guide rather than the tip end portion of the guide is partially cooled by a cooling means.

[39] A cylindrical upsetting manufactured product obtained by the upsetting method for a cylindrical raw material as recited in any one of the aforementioned Items 27 to 38.

[40] An upsetting apparatus for a cylindrical raw material for outwardly expanding a processing scheduled portion of the cylindrical raw material so that a wall thickness of the processing scheduled portion increases, the upsetting apparatus, comprising:

a core bar disposed in hollow portions of the processing scheduled portion and a non-processing scheduled portion of the cylindrical raw material;

a restraining die having a restraining hole extended in an axial direction, wherein the non-processing scheduled portion of the raw material is to be disposed in the restraining hole;

a molding dented portion formed at an axial end portion of the restraining die;

a guide having an insertion hole extended in an axial direction, wherein the processing scheduled portion of the raw material is to be disposed in the insertion hole; and

a punch for pressurizing the processing scheduled portion of the raw material in the axial direction,

wherein the guide is movable in a direction opposite to a moving direction of the punch.

[41] The upsetting apparatus for a cylindrical raw material as recited in the aforementioned Item 40, further comprising a guide driving apparatus for moving the guide in a direction opposite to the moving direction of the punch.

[42] The upsetting apparatus for a cylindrical raw material as recited in the aforementioned Item 40 or 41, wherein the tip end portion of the punch is formed into a cross-sectional shape corresponding to a cross-sectional shape of an axial end portion of the raw material.

[43] The upsetting apparatus for a cylindrical raw material as recited in any one of the aforementioned Items 40 to 42, wherein the core bar is connected to the punch in such a manner that the core bar extends in an axial direction of the punch.

[44] The upsetting apparatus for a cylindrical raw material as recited in the aforementioned Item 43, wherein the core bar is connected to the punch via an extensible device capable of being extended and contracted in an axial direction.

[45] The upsetting apparatus for a cylindrical raw material as recited in the aforementioned Item 44, wherein the punch is equipped with the extensible device therein.

[46] The upsetting apparatus for a cylindrical raw material as recited in the aforementioned Item 44 or 45, wherein the extensible device has a fluid pressure cylinder or a spring capable of being extended and contracted in an axial direction.

[47] The upsetting apparatus for a cylindrical raw material as recited in any one of the aforementioned Items 40 to 46, wherein chamfering work is given to the insertion hole opening edge portion of the tip end portion of the guide.

[48] The upsetting apparatus for a cylindrical raw material as recited in any one of the aforementioned Items 40 to 47, further comprising a heating means for partially heating the portion of the processing scheduled portion of the raw material corresponding to the tip end portion of the guide.

[49] The upsetting apparatus for a cylindrical raw material as recited in the aforementioned Items 48, wherein the heating means is an induction heating means configured to partially induction-heat the portion of the processing scheduled portion of the raw material corresponding to the tip end portion of the guide.

[50] The upsetting apparatus for a cylindrical raw material as recited in the aforementioned Item 48, wherein the heating means is an induction heating means configured to partially induction-heat the axial end portion of the restraining die to thereby partially heat the portion of the processing scheduled portion of the raw material corresponding to the tip end portion of the guide.

[51] The upsetting apparatus for a cylindrical raw material as recited in any one of the aforementioned Items 48 to 50, wherein the heating means is capable of partially heating the portion of the processing scheduled portion of the raw material corresponding to the tip end portion of the guide into a half-molten state.

[52] The upsetting apparatus for a cylindrical raw material as recited in any one of the aforementioned Items 48 to 51, further comprising a cooling means configured to partially cool the portion of the processing scheduled portion of the raw material corresponding to the portion of the basal end side of the guide rather than the tip end portion of the guide.

[53] An upsetting apparatus for a cylindrical raw material for outwardly expanding processing scheduled portions of both axial end portions of the cylindrical raw material so that a wall thickness of each processing scheduled portion increases, the upsetting apparatus, comprising:

a core bar disposed in hollow portions of a non-processing scheduled potion of an axial intermediate portion of the cylindrical raw material and the processing scheduled portion of both axial end portions of the cylindrical raw material;

a restraining die having a restraining hole extended in an axial direction, wherein the non-processing scheduled portion of the raw material is to be disposed in the restraining hole;

two molding dented portions formed at axial both end portions of the restraining die;

two guides each having an insertion hole extended in an axial direction, wherein each processing scheduled portion of the raw material is to be disposed in the insertion hole; and

two punches each for pressurizing each processing scheduled portion of the raw material in the axial direction,

wherein each guide is movable in a direction opposite to a moving direction of the punch.

[54] The upsetting apparatus for a cylindrical raw material as recited in the aforementioned Item 53, further comprising two guide driving apparatuses each for moving the corresponding guide in a direction opposite to the moving direction of the punch.

[55] The upsetting apparatus for a cylindrical raw material as recited in the aforementioned Item 53 or 54, wherein the tip end portion of each punch is formed into a cross-sectional shape corresponding to a cross-sectional shape of a corresponding axial end portion of the raw material.

[56] The upsetting apparatus for a cylindrical raw material as recited in any one of the aforementioned Items 53 to 55, wherein the core bar is divided into divided core bar halves at the axial intermediate portion thereof, and

wherein each core bar half is connected to a corresponding punch with the divided core bar half extended in an axial direction of the punch.

[57] The upsetting apparatus for a cylindrical raw material as recited in the aforementioned Item 56, wherein each core bar half is connected to the corresponding punch via an extensible device capable of being extended and contracted in an axial direction.

[58] The upsetting apparatus for a cylindrical raw material as recited in the aforementioned Item 57, wherein each punch is equipped with the corresponding extensible device therein.

[59] The upsetting apparatus for a cylindrical raw material as recited in the aforementioned Item 57 or 58, wherein the extensible device has a fluid pressure cylinder or a spring capable of being extended and contracted in an axial direction.

[60] The upsetting apparatus for a cylindrical raw material as recited in any one of the aforementioned Items 53 to 59, wherein chamfering work is given to the insertion hole opening edge portion of the tip end portion of each guide.

[61] The upsetting apparatus for a cylindrical raw material as recited in any one of the aforementioned Items 53 to 60, further comprising two heating means each for partially heating the portion of each processing scheduled portion of the raw material corresponding to the tip end portion of the guide.

[62] The upsetting apparatus for a cylindrical raw material as recited in the aforementioned Item 61, wherein each heating means is an induction heating means configured to partially induction-heat the portion of each processing scheduled portion of the raw material corresponding to the tip end portion of the guide.

[63] The upsetting apparatus for a cylindrical raw material as recited in the aforementioned Item 61, wherein each heating means is an induction heating means configured to partially induction-heat both the axial end portions of the restraining die to thereby partially heat the portion of each processing scheduled portion of the raw material corresponding to the tip end portion of the guide.

[64] The upsetting apparatus for a cylindrical raw material as recited in any one of the aforementioned Items 61 to 63, wherein each heating means is capable of partially heating the portion of the processing scheduled portion of the raw material corresponding to the tip end portion of the guide into a half-molten state.

[65] The upsetting apparatus for a cylindrical raw material as recited in any one of the aforementioned Items 61 to 64, further comprising two cooling means each configured to partially cool the portion of each processing scheduled portion of the raw material corresponding to the portion of the basal end side of the guide rather than the tip end portion of the guide.

[66] An upsetting apparatus for a cylindrical raw material for inwardly expanding a processing scheduled portion of a cylindrical raw material so that a wall thickness increases, the upsetting apparatus, comprising:

a core bar having a core bar main body and a small diameter portion formed at an axial end portion of the core bar main body and smaller in diameter than the core bar main body, wherein the core bar main body and the small diameter portion are disposed in a hollow portion of the processing scheduled portion of the cylindrical raw material and a hollow portion of a non-processing scheduled portion of the cylindrical raw material, respectively, to thereby form a molding dented portion between an internal peripheral surface of the non-processing scheduled portion and the small diameter portion;

a restraining die having a restraining hole extended in an axial direction, wherein the processing scheduled portion and the non-processing scheduled portion of the raw material are to be disposed in the restraining hole;

a guide to be disposed in the hollow portion of the processing scheduled portion of the raw material; and

a punch configured to pressurize the processing scheduled portion of the raw material in an axial direction,

wherein the guide is movable in a direction opposite to a moving direction of the punch.

[67] The upsetting apparatus for a cylindrical raw material as recited in the aforementioned Item 66, further comprising a guide driving apparatus for moving the guide in a direction opposite to the moving direction of the punch.

[68] The upsetting apparatus for a cylindrical raw material as recited in the aforementioned Item 66 or 67, wherein the tip end portion of the punch is formed into a cross-sectional shape corresponding to a cross-sectional shape of an axial end portion of the raw material.

[69] The upsetting apparatus for a cylindrical raw material as recited in any one of the aforementioned Items 66 to 68, wherein the guide is disposed in a hollow portion formed in the punch and extended in an axial direction in a manner such that the guide is movable in an axial direction of the punch.

[70] The upsetting apparatus for a cylindrical raw material as recited in any one of the aforementioned Items 66 to 69, wherein the core bar is connected to the guide in such a manner that the core bar extends in an axial direction of the guide.

[71] The upsetting apparatus for a cylindrical raw material as recited in the aforementioned Item 70, wherein the core bar is connected to the guide via an extensible device capable of being extended and contracted in an axial direction.

[72] The upsetting apparatus for a cylindrical raw material as recited in the aforementioned Item71, wherein the guide is equipped with the extensible device therein.

[73] The upsetting apparatus for a cylindrical raw material as recited in the aforementioned Item 71 or 72, wherein the extensible device has a fluid pressure cylinder or a spring capable of being extended and contracted in an axial direction.

[74] The upsetting apparatus for a cylindrical raw material as recited in any one of the aforementioned Items 66 to 73, wherein chamfering work is given to a peripheral edge portion of a tip end portion of the guide.

[75] The upsetting apparatus for a cylindrical raw material as recited in any one of the aforementioned Items 66 to 74, further comprising a heating means for partially heating the portion of the processing scheduled portion of the raw material corresponding to the tip end portion of the guide.

[76] The upsetting apparatus for a cylindrical raw material as recited in the aforementioned Item 75, wherein the heating means is an induction heating means configured to partially induction-heat the portion of the processing scheduled portion of the raw material corresponding to the tip end portion of the guide.

[77] The upsetting apparatus for a cylindrical raw material as recited in the aforementioned Item 75, wherein the heating means is an induction heating means configured to partially induction-heat the axial end portion of the restraining die to thereby partially heat the portion of the processing scheduled portion of the raw material corresponding to the tip end portion of the guide.

[78] The upsetting apparatus for a cylindrical raw material as recited in any one of the aforementioned Items 75 to 77, wherein the heating means is capable of partially heating the portion of the processing scheduled portion of the raw material corresponding to the tip end portion of the guide into a half-molten state.

[79] The upsetting apparatus for a cylindrical raw material as recited in any one of the aforementioned Items 75 to 78, further comprising a cooling means configured to partially cool the portion of the processing scheduled portion of the raw material corresponding to the portion of the basal end side of the guide rather than the tip end portion of the guide.

[80] An upsetting method for a cylindrical raw material, comprising:

filling hollow portions of a processing scheduled portion and a non-processing scheduled portion of a cylindrical raw material with pressure fluid, to thereby pressurize and restrain internal peripheral surfaces of the processing scheduled portion and the non-processing scheduled portion with the fluid pressure;

disposing the non-processing scheduled portion of the raw material in a restraining hole formed in a restraining die and extended in an axial direction, to thereby restrain an external peripheral surface of the non-processing scheduled portion with a peripheral surface of the restraining hole;

disposing the processing scheduled portion of the raw material in a molding dented portion formed at an axial end portion of the restraining die;

disposing the processing scheduled portion of the raw material in an insertion hole formed in a guide and extended in an axial direction;

then, moving the guide in a direction opposite to a moving direction of the punch while pressurizing the processing scheduled portion of the raw material with the punch in an axial direction to thereby outwardly expand the processing scheduled portion of the raw material within the molding dented portion so that a wall thickness of the raw material increases.

[81] An upsetting method for a cylindrical raw material as recited in the aforementioned Item 80, wherein the guide is moved by driving force of a guide driving apparatus.

[82] The upsetting method for a cylindrical raw material as recited in the aforementioned Item 80 or 81, wherein “G” satisfies an equation of
G=(X_{g}−X)P/(L₀−Xₚ−Pt₀)

where

“P” denotes an average moving speed of the punch from the moving initiation thereof,

“G” denotes an average moving speed of the guide from the moving initiation thereof,

“X₀” denotes a buckling limit length at a cross-sectional area of the processing scheduled portion of the raw material before the upsetting,

“X” denotes an initial clearance between a tip end portion of the guide and a bottom portion of the molding dented portion (0≦X≦X₀),

“L₀” denotes a length of the raw material before the upsetting required for the expanded portion,

“X_{P}” denotes a stop position of the tip end portion of the punch with respect to the bottom portion of the molding dented portion obtained from a design volume of the expanded portion,

“X_{g}” denotes a stop position of the tip end portion of the guide with respect to the bottom portion of the molding dented portion defined by the design, and

“t₀” denotes a time lag from the moving initiation of the punch to the moving initiation of the guide (0≦t₀).

[83] The upsetting method for a cylindrical raw material as recited in the aforementioned Item 80, wherein the guide is moved by pressing-back force acting on the guide generated by press-fitting the material of the processing scheduled portion of the raw material into the molding dented portion.

[84] The upsetting method for a cylindrical raw material as recited in any one of the aforementioned Items 80 to 83, wherein the tip end portion of the punch is formed into a cross-sectional shape corresponding to a cross-sectional shape of an axial end portion of the raw material.

[85] The upsetting method for a cylindrical raw material as recited in any one of the aforementioned Items 80 to 84, wherein the processing scheduled portion of the raw material is expanded in a state in which the portion of the processing scheduled portion of the raw material corresponding to the tip end portion of the guide is partially heated.

[86] The upsetting method for a cylindrical raw material as recited in the aforementioned Item 85, wherein the portion of the processing scheduled portion of the raw material corresponding to the tip end portion of the guide is partially induction-heated by an induction heating means.

[87] The upsetting method for a cylindrical raw material as recited in the aforementioned Item 85, wherein the axial end portion of the restraining die is partially induction-heated by an induction heating means to thereby partially heat the portion of the processing scheduled portion of the raw material corresponding to the tip end portion of the guide.

[88] The upsetting method for a cylindrical raw material as recited in any one of the aforementioned Items 85 to 87, wherein the portion of the processing scheduled portion of the raw material corresponding to the tip end portion of the guide is partially heated into a half-molten state.

[89] The upsetting method for a cylindrical raw material as recited in any one of the aforementioned Items 85 to 88, wherein the processing scheduled portion of the raw material is expanded in a state in which the portion of the processing scheduled portion of the raw material corresponding to the portion of the basal end side of the guide rather than the tip end portion of the guide is partially cooled by a cooling means.

[90] A cylindrical upsetting manufactured product obtained by the upsetting method for a cylindrical raw material as recited in any one of the aforementioned Items 80 to 89.

[91] An upsetting method for a cylindrical raw material, comprising:

filling hollow portions of a non-processing scheduled potion of an axial intermediate portion of the cylindrical raw material and a processing scheduled portion of both axial end portions of the cylindrical raw material with pressure fluid, to thereby pressurize and restrain internal peripheral surfaces of the processing scheduled portion and the non-processing scheduled portion with the fluid pressure;

disposing the non-processing scheduled portion of the raw material in a restraining hole formed in a restraining die and extended in an axial direction, to thereby restrain an external peripheral surface of the non-processing scheduled portion with a peripheral surface of the restraining hole;

disposing both the processing scheduled portions of the raw material in molding dented portions formed at both axial end portions of the restraining die;

disposing each processing scheduled portion of the raw material in an insertion hole formed in a guide and extended in an axial direction;

then, moving each guide in a direction opposite to a moving direction of the punch while simultaneously pressurizing each processing scheduled portion of the raw material with the punch in an axial direction to thereby outwardly expand each processing scheduled portion of the raw material within the corresponding molding dented portion so that a wall thickness of the raw material increases.

[92] The upsetting method for a cylindrical raw material as recited in the aforementioned Item 91, wherein each guide is moved by driving force of a corresponding guide driving apparatus.

[93] The upsetting method for a cylindrical raw material as recited in the aforementioned Item 91 or 92, wherein, in at least one of guides and a punch corresponding to the one of guides, “G” satisfies an equation of
G=(X_{g}−X)P/(L₀−Xₚ−Pt₀)

where

“P” denotes an average moving speed of the punch from the moving initiation thereof,

“G” denotes an average moving speed of the guide from the moving initiation thereof,

“X₀” denotes a buckling limit length at a cross-sectional area of the processing scheduled portion of the raw material before the upsetting,

“X” denotes an initial clearance between a tip end portion of the guide and a bottom portion of the molding dented portion (0≦X≦X₀),

“L₀” denotes a length of the raw material before the upsetting required for the expanded portion,

“X_{P}” denotes a stop position of the tip end portion of the punch with respect to the bottom portion of the molding dented portion obtained from a design volume of the expanded portion,

“X_{g}” denotes a stop position of the tip end portion of the guide with respect to the bottom portion of the molding dented portion defined by the design, and

“t₀” denotes a time lag from the moving initiation of the punch to the moving initiation of the guide (0≦t₀).

[94] The upsetting method for a cylindrical raw material as recited in the aforementioned Item 91, wherein each guide is moved by pressing-back force acting on the guide generated by press-fitting the material of the corresponding processing scheduled portion of the raw material into the molding dented portion.

[95] The upsetting method for a cylindrical raw material as recited in any one of the aforementioned Items 91 to 94, wherein the tip end portion of each punch is formed into a cross-sectional shape corresponding to a cross-sectional shape of a corresponding axial end portion of the raw material.

[96] The upsetting method for a cylindrical raw material as recited in any one of the aforementioned Items 91 to 95, wherein each processing scheduled portion of the raw material is expanded in a state in which the portion of each processing scheduled portion of the raw material corresponding to the tip end portion of the guide is partially heated.

[97] The upsetting method for a cylindrical raw material as recited in the aforementioned Item 96, wherein the portion of each processing scheduled portion of the raw material corresponding to the tip end portion of the guide is partially induction-heated by an induction heating means.

[98] The upsetting method for a cylindrical raw material as recited in the aforementioned Item 96, wherein both the axial end portions of the restraining die are partially induction-heated by induction heating means to thereby partially heat the portion of each processing scheduled portion of the raw material corresponding to the tip end portion of the guide.

[99] The upsetting method for a cylindrical raw material as recited in any one of the aforementioned Items 96 to 98, wherein the portion of each processing scheduled portion of the raw material corresponding to the tip end portion of the guide is partially heated into a half-molten state.

[100] The upsetting method for a cylindrical raw material as recited in any one of the aforementioned Items 96 to 99, wherein each processing scheduled portion of the raw material is expanded in a state in which the portion of each processing scheduled portion of the raw material corresponding to the portion of the basal end side of the guide rather than the tip end portion of the guide is partially cooled by a cooling means.

[101] A cylindrical upsetting manufactured product obtained by the upsetting method for a cylindrical raw material as recited in any one of the aforementioned Items 91 to 100.

[102] An upsetting apparatus for a cylindrical raw material for outwardly expanding a processing scheduled portion of the cylindrical raw material so that a wall thickness of the processing scheduled portion increases, the upsetting apparatus, comprising:

a pressure fluid filling means configured to fill hollow portions of a processing scheduled portion and a non-processing scheduled portion of the cylindrical raw material with pressure fluid;

a restraining die having a restraining hole extended in an axial direction, wherein the non-processing scheduled portion of the raw material is to be disposed in the restraining hole;

a molding dented portion formed in an axial end portion of the restraining die;

a guide having an insertion hole extended in an axial direction, wherein the processing scheduled portion of the raw material is to be disposed in the insertion hole; and

a punch for pressurizing the processing scheduled portion of the raw material in the axial direction,

wherein the guide is movable in a direction opposite to a moving direction of the punch.

[103] The upsetting apparatus for a cylindrical raw material as recited in the aforementioned Item 102, further comprising a guide driving apparatus for moving the guide in a direction opposite to the moving direction of the punch.

[104] The upsetting apparatus for a cylindrical raw material as recited in the aforementioned Item 102 or 103, wherein the tip end portion of the punch is formed into a cross-sectional shape corresponding to a cross-sectional shape of an axial end portion of the raw material.

[105] The upsetting apparatus for a cylindrical raw material as recited in any one of the aforementioned Items 102 to 104, wherein chamfering work is given to the insertion hole opening edge portion of the tip end portion of the guide.

[106] The upsetting apparatus for a cylindrical raw material as recited in any one of the aforementioned Items 102 to 105, further comprising a heating means for partially heating the portion of the processing scheduled portion of the raw material corresponding to the tip end portion of the guide.

[107] The upsetting apparatus for a cylindrical raw material as recited in the aforementioned Item 106, wherein the heating means is an induction heating means configured to partially induction-heat the portion of the processing scheduled portion of the raw material corresponding to the tip end portion of the guide.

[108] The upsetting apparatus for a cylindrical raw material as recited in the aforementioned Item 106, wherein the heating means is an induction heating means configured to partially induction-heat the axial end portion of the restraining die to thereby partially heat the portion of the processing scheduled portion of the raw material corresponding to the tip end portion of the guide.

[109] The upsetting apparatus for a cylindrical raw material as recited in any one of the aforementioned Items 106 to 108, wherein the heating means is capable of partially heating the portion of the processing scheduled portion of the raw material corresponding to the tip end portion of the guide into a half-molten state.

[110] The upsetting apparatus for a cylindrical raw material as recited in any one of the aforementioned Items 106 to 109, further comprising a cooling means configured to partially cool the portion of the processing scheduled portion of the raw material corresponding to the portion of the basal end side of the guide rather than the tip end portion of the guide.

[111] An upsetting apparatus for a cylindrical raw material for outwardly expanding processing scheduled portions of both axial end portions of the cylindrical raw material so that a wall thickness of the processing scheduled portion increases, the upsetting apparatus, comprising:

a pressure fluid filling means configured to fill hollow portions of a non-processing scheduled portion of an axial intermediate portion of the cylindrical raw material and processing scheduled portions of both axial end portions of the cylindrical raw material with pressure fluid;

a restraining die having a restraining hole extended in an axial direction, wherein the non-processing scheduled portion of the raw material is to be disposed in the restraining hole;

two molding dented portions formed at both axial end portions of the restraining die;

two guides each having an insertion hole extended in an axial direction, wherein the processing scheduled portion of the raw material is to be disposed in the insertion hole; and

two punches each for pressurizing the processing scheduled portion of the raw material in the axial direction, wherein each guide is movable in a direction opposite to a moving direction of the punch.

[112] The upsetting apparatus for a cylindrical raw material as recited in the aforementioned Item 111, further comprising two guide driving apparatuses each for moving the corresponding guide in a direction opposite to the moving direction of the punch.

[113] The upsetting apparatus for a cylindrical raw material as recited in the aforementioned Item 111 or 112, wherein the tip end portion of each punch is formed into a cross-sectional shape corresponding to a cross-sectional shape of a corresponding axial end portion of the raw material.

[114] The upsetting apparatus for a cylindrical raw material as recited in any one of the aforementioned Items 111 to 113, wherein chamfering work is given to the insertion hole opening edge portion of the tip end portion of each guide.

[115] The upsetting apparatus for a cylindrical raw material as recited in any one of the aforementioned Items 111 to 114, further comprising two heating means each for partially heating the portion of each processing scheduled portion of the raw material corresponding to the tip end portion of the guide.

[116] The upsetting apparatus for a cylindrical raw material as recited in the aforementioned Item 115, wherein each heating means is an induction heating means configured to partially induction-heat the portion of each processing scheduled portion of the raw material corresponding to the tip end portion of the guide.

[117] The upsetting apparatus for a cylindrical raw material as recited in the aforementioned Item 115, wherein each heating means is an induction heating means configured to partially induction-heat both the axial end portions of the restraining die to thereby partially heat the portion of the processing scheduled portion of the raw material corresponding to the tip end portion of the guide.

[118] The upsetting apparatus for a cylindrical raw material as recited in any one of the aforementioned Items 115 to 117, wherein each heating means is capable of partially heating the portion of the processing scheduled portion of the raw material corresponding to the tip end portion of the guide into a half-molten state.

[119] The upsetting apparatus for a cylindrical raw material as recited in any one of the aforementioned Items 115 to 118, further comprising two cooling means each configured to partially cool the portion of each processing scheduled portion of the raw material corresponding to the portion of the basal end side of the guide rather than the tip end portion of the guide.

### Effects of the Invention

The present invention has the following effects.

According to the invention as recited in the aforementioned Item [1], at the time of pressurizing the processing scheduled portion of the raw material with the punch, the internal peripheral surfaces of the processing scheduled portion and the non-processing scheduled portion of the raw material are restrained by the peripheral surface of the core bar and the external peripheral surface of the non-processing scheduled portion is restrained by the peripheral surface of the restraining hole of the restraining die. Therefore, the inward and outward buckling of the non-processing scheduled portion of the raw material is prevented, and the inward buckling of the processing scheduled portion is prevented. And, the processing scheduled portion of the raw material is disposed in the insertion hole of the guide and therefore the external peripheral surface of the processing scheduled portion is restrained by the peripheral surface of the insertion hole. This prevents the outward buckling of the processing scheduled portion. In this state, by moving the guide in a direction opposite to the moving direction of the punch while pressurizing the processing scheduled portion of the raw material with the punch in the axial direction, the processing scheduled portion of the raw material exposed between the tip end portion of the guide and the bottom portion of the molding dented portion can be outwardly expanded assuredly and preferably so that the wall thickness increases within the molding dented portion. Consequently, a high quality cylindrical upsetting manufactured product can be obtained.

According to the invention as recited in the aforementioned Item [2], the guide can be moved assuredly.

According to the invention as recited in the aforementioned Item [3], the processing scheduled portion of the raw material can be assuredly formed into a designed shape.

According to the invention as recited in the aforementioned Item [4], the guide can be moved without using a guide driving apparatus, resulting in simplification of the upsetting apparatus.

According to the invention as recited in the aforementioned Item [5], the processing scheduled portion of the raw material can be assuredly pressurized with the punch.

According to the invention as recited in the aforementioned Item [6], the setting work for disposing the core bar in the hollow portions of the processing scheduled portion and the non-processing scheduled portion of the raw material and the setting work for disposing the punch at the axial end portion side of the raw material to pressurize the processing scheduled portion of the raw material with the punch can be performed simultaneously, which can improve the upsetting operation efficiency.

Furthermore, after completion of the processing, the pulling out work of the core bar for pulling out the core bar from the hollow portions of the processing scheduled portion and the non-processing scheduled portion of the raw material and the removal work of the punch for removing the punch from the position of the axial end portion of the raw material can be done simultaneously, which can further improve the upsetting operation efficiency.

According to the invention as recited in the aforementioned Item [7], the defect that the position of the core bar shifts in accordance with the movement of the punch or the expansion of the processing scheduled portion of the raw material can be prevented assuredly.

According to the invention as recited in the aforementioned Item [8], only the deformation resistance of the portion of the processing scheduled portion of the raw material corresponding to the tip end portion of the guide decreases partially. Therefore, the molding pressure can be reduced. On the other hand, since the portion of the processing scheduled portion of the raw material corresponding to the portion of the basal end side of the guide rather than the tip end portion of the guide does not decrease in deformation resistance, an increase in molding pressure produced when the end portion of the raw material is crushed in the insertion hole of the guide by the pressure from the punch can be prevented.

According to the invention as recited in the aforementioned Item [9], the portion of the processing scheduled portion of the raw material corresponding to the tip end portion of the guide can be heated assuredly and very efficiently.

According to the invention as recited in the aforementioned Item [10], the portion of the processing scheduled portion of the raw material corresponding to the tip end portion of the guide can be heated assuredly and efficiently.

According to the invention as recited in the aforementioned Item [11], the molding pressure can be reduced substantially.

According to the invention as recited in the aforementioned Item [12], it is possible to assuredly control that the portion of the processing scheduled portion of the raw material corresponding to the portion of the basal end side of the guide rather than the tip end portion of the guide is heated, which assuredly can prevent deterioration of the deformation resistance of the portion of the raw material.

According to the invention as recited in the aforementioned Item [13], a high quality cylindrical upsetting manufactured product with an expanded portion outwardly expanded at a prescribed axial portion so that the wall thickness increases can be offered.

According to the invention as recited in the aforementioned Item [14], a cylindrical upsetting manufactured product in which outwardly expanded portions are formed at axial both end portions so that the wall thickness increases can be manufactured efficiently.

According to the invention as recited in the aforementioned Item [15], each guide can be moved assuredly.

According to the invention as recited in the aforementioned Item [16], the processing scheduled portion of the raw material can be assuredly formed into a designed shape.

According to the invention as recited in the aforementioned Item [17], each guide can be moved without using a guide driving apparatus, resulting in simplification of the upsetting apparatus.

According to the invention as recited in the aforementioned Item [18], each processing scheduled portion of the raw material can be assuredly pressurized with the punch.

According to the invention as recited in the aforementioned Item [19], the setting work of the core bar halves for disposing each core bar half in the hollow portions of the processing scheduled portion and the non-processing scheduled portion of the raw material and the setting work of the punch for disposing each punch at both the axial end portion sides of the raw material to pressurize the corresponding processing scheduled portion of the raw material with each punch can be performed simultaneously, resulting in enhanced upsetting operation efficiency.

Furthermore, after completion of the processing, the pull out work of the core bar half for pulling out each core bar half from the hollow portions of the processing scheduled portion and the non-processing scheduled portion of the raw material and the removal work of the punch for removing each punch from the position of the axial end portion of the raw material can be performed simultaneously, which can further improve the upsetting operation efficiency.

Furthermore, since the core bar is halved in length by being divided at the axial intermediate portion, the insertion time of the core bar into the prescribed hollow portion can be shortened, which can further improve the upsetting operation efficiency.

According to the invention as recited in the aforementioned Item [20], the defect that the position of the core bar half shifts in accordance with the movement of the punch or the expansion of the processing scheduled portion of the raw material can be prevented assuredly.

According to the invention as recited in the aforementioned Item [21], the molding pressure can be reduced for the same reasons as in the invention as recited in the aforementioned Item [8].

According to the invention as recited in the aforementioned Item [22], the portion of each processing scheduled portion of the raw material corresponding to the tip end portion of the guide can be heated assuredly and very efficiently.

According to the invention as recited in the aforementioned Item [23], the portion of each processing scheduled portion of the raw material corresponding to the tip end portion of the guide in can be heated assuredly and efficiently.

According to the invention as recited in the aforementioned Item [24], the molding pressure can be reduced substantially.

According to the invention as recited in the aforementioned Item [25], it is possible to assuredly control that the portion of each processing scheduled portion of the raw material corresponding to the portion of the basal end side of the guide rather than the tip end portion of the guide is heated, which can assuredly prevent deterioration of the deformation resistance of each portion of the raw material.

According to the invention as recited in the aforementioned Item [26], a high quality cylindrical upsetting manufactured product in which expanded portions outwardly expanded so that the wall thickness increases are formed at axial both end portions can be provided.

According to the invention as recited in the aforementioned Item [27], at the time of pressuring the processing scheduled portion of the raw material with the punch, the internal peripheral surface of the non-processing scheduled portion of the raw material is restrained by the peripheral surface of the core bar main body, and the external peripheral surfaces of the processing scheduled portion and the non-processing scheduled portion are restrained by the peripheral surface of the restraining hole of the restraining die. Therefore, the inward or outward buckling of the non-processing scheduled portion of the raw material can be prevented, and the outward buckling of the processing scheduled portion is prevented. Furthermore, the guide is disposed in the hollow portion of the processing scheduled portion of the raw material to thereby restrain the internal peripheral surface of the processing scheduled portion by the peripheral surface of the guide. With this, the inward buckling of the processing scheduled portion is prevented. With this state, by moving the guide in a direction opposite to the moving direction of the punch while pressurizing the processing scheduled portion of the raw material with the punch in the axial direction, the processing scheduled portion of the raw material exposed between the tip end portion of the guide and the bottom portion of the molding dented portion can be assuredly and preferably expanded inwardly in the molding dented portion so that the wall thickness increases. Consequently, a high quality cylindrical upsetting manufactured product can be obtained.

According to the invention as recited in the aforementioned Item [28], the guide can be moved assuredly.

According to the invention as recited in the aforementioned Item [29], the processing scheduled portion of the raw material can be assuredly formed in a designed shape.

According to the invention as recited in the aforementioned Item [30], the guide can be moved without using a guide driving apparatus, resulting in simplification of upsetting apparatus.

According to the invention as recited in the aforementioned Item [31], the predetermined portion of the raw material can be assuredly pressurized with the punch.

According to the invention as recited in the aforementioned Item [32], the setting work of the core bar for disposing the core bar main body and the small diameter portion in the hollow portion of the non-processing scheduled portion of the raw material and the hollow portion of the processing scheduled portion of the raw material, respectively, and the setting work of the guide for disposing the guide in the hollow portion of the processing scheduled portion of the raw material can be performed simultaneously, which can improve the upsetting operation efficiency.

According to the invention as recited in the aforementioned Item [33], the defect that the position of the core bar shifts in accordance with the movement of the guide or the expansion of the processing scheduled portion of the raw material can be prevented assuredly.

According to the invention as recited in the aforementioned Item [34], the molding pressure can be reduced for the same reasons as in the invention as recited in the aforementioned Item [8].

According to the invention as recited in the aforementioned Item [35], the portion of the processing scheduled portion of the raw material corresponding to the tip end portion of the guide can be heated assuredly and very efficiently.

According to the invention as recited in the aforementioned Item [36], the portion of the processing scheduled portion of the raw material corresponding to the tip end portion of the guide can be heated assuredly and efficiently.

According to the invention as recited in the aforementioned Item [37], the molding pressure can be reduced substantially.

According to the invention as recited in the aforementioned Item [38], it is possible to assuredly control that the portion of each processing scheduled portion of the raw material corresponding to the portion of the basal end side of the guide rather than the tip end portion of the guide is heated, which can assuredly prevent deterioration of the deformation resistance of each portion of the raw material.

According to the invention as recited in the aforementioned Item [39], a high quality cylindrical upsetting manufactured product in which an inwardly expanded portion is formed at the prescribed portion so that the wall thickness increases can be provided.

According to the invention as recited in the aforementioned Item [40] to [52], an upsetting apparatus for a cylindrical raw material which can be suitably used for any one of the upsetting methods for a cylindrical raw material according to the aforementioned Items [1] to [12] can be provided.

According to the invention as recited in the aforementioned Item [53] to [65], an upsetting apparatus for a cylindrical raw material which can be suitably used for any one of the upsetting methods for a cylindrical raw material according to the aforementioned Items [14] to [25] can be provided.

According to the invention as recited in the aforementioned Item [66] to [79], an upsetting apparatus for a cylindrical raw material which can be suitably used for any one of the upsetting methods for a cylindrical raw material according to the aforementioned Items [27] to [38] can be provided.

According to the invention as recited in the aforementioned Item [80], at the time of pressurizing the processing scheduled portion of the raw material with the punch, the internal peripheral surfaces of the processing scheduled portion and the non-processing scheduled portion of the raw material are restrained by the fluid pressure and the external peripheral surface of the non-processing scheduled portion is restrained by the peripheral surface of the restraining hole of the restraining die. Therefore, the inward and outward buckling of the non-processing scheduled portion of the raw material is prevented, and the inward buckling of the processing scheduled portion is prevented. And, the processing scheduled portion of the raw material is disposed in the insertion hole of the guide and therefore the external peripheral surface of the processing scheduled portion is restrained by the peripheral surface of the insertion hole. This prevents the outward buckling of the processing scheduled portion. In this state, by moving the guide in a direction opposite to the moving direction of the punch while pressurizing the processing scheduled portion of the raw material with the punch in the axial direction, the processing scheduled portion of the raw material exposed between the tip end portion of the guide and the bottom portion of the molding dented portion can be outwardly expanded assuredly and preferably so that the wall thickness increases within the molding dented portion. Consequently, a high quality cylindrical upsetting manufactured product can be obtained.

Furthermore, since the hollow portions of the non-processing scheduled portion and the processing scheduled portion of the raw material are filled not with a core bar but with pressure fluid, the frictional force acting on the processing scheduled portion of the raw material at the time of the processing can be reduced. Therefore, the molding pressure can be reduced substantially. Furthermore, there is an advantage that it is not required to pull out the core bar from the hollow portion of the upsetting manufactured product after completion of the processing.

According to the invention as recited in the aforementioned Item [81], the guide can be moved assuredly.

According to the invention as recited in the aforementioned Item [82], the processing scheduled portion of the raw material can be assuredly formed in a designed shape.

According to the invention as recited in the aforementioned Item [83], the guide can be moved without using a guide driving apparatus, resulting in simplification of upsetting apparatus.

According to the invention as recited in the aforementioned Item [84], the processing scheduled portion of the raw material can be assuredly pressurized with the punch.

According to the invention as recited in the aforementioned Item [85], only the portion of the processing scheduled portion of the raw material corresponding to the tip end portion of the guide partially decreases in deformation resistance. Therefore, the molding pressure can be further reduced.

On the other hand, since the portion of the processing scheduled portions of the raw material corresponding to the portion of the basal end side of the guide rather than the tip end portion of the guide is not heated, the portion does not deteriorate in deformation resistance. Therefore, the defect that the end portion of the raw material is crushed by the pressure from the punch into a defective shape can be prevented.

According to the invention as recited in the aforementioned Item [86], the portion of the processing scheduled portion of the raw material corresponding to the tip end portion of the guide can be heated assuredly and very efficiently.

According to the invention as recited in the aforementioned Item [87], the portion of the processing scheduled portion of the raw material corresponding to the tip end portion of the guide can be heated assuredly and efficiently.

According to the invention as recited in the aforementioned Item [88], the molding pressure can be reduced substantially.

According to the invention as recited in the aforementioned Item [89], it is possible to assuredly control that the portion of each processing scheduled portion of the raw material corresponding to the portion of the basal end side of the guide rather than the tip end portion of the guide is heated, which can assuredly prevent deterioration of the deformation resistance of each portion of the raw material.

According to the invention as recited in the aforementioned Item [90], a high quality cylindrical upsetting manufactured product in which an outwardly expanded portion is formed at the prescribed portion so that the wall thickness increases can be provided.

According to the invention as recited in the aforementioned Item [91], a high quality cylindrical upsetting manufactured product in which outwardly expanded portions are formed at both the axial end portions so that the wall thickness increases can be provided.

According to the invention as recited in the aforementioned Item [92], each guide can be moved assuredly.

According to the invention as recited in the aforementioned Item [93], the processing scheduled portion of the raw material can be assuredly formed into a designed shape.

According to the invention as recited in the aforementioned Item [94], the guide can be moved without using a guide driving apparatus, resulting in simplification of upsetting apparatus.

According to the invention as recited in the aforementioned Item [95], each processing scheduled portion of the raw material can be assuredly pressurized with the punch.

According to the invention as recited in the aforementioned Item [96], for the same reasons as in the invention of the aforementioned Item [85], the molding pressure can be further reduced, and the defect that each end portion of the raw material is crushed by the pressure from the punch into a defective shape can be prevented.

According to the invention as recited in the aforementioned Item [97], the portion of each processing scheduled portion of the raw material corresponding to the tip end portion of the guide can be heated assuredly and very efficiently.

According to the invention as recited in the aforementioned Item [98], the portion each processing scheduled portion of the raw material corresponding to the tip end portion of the guide can be heated assuredly and efficiently.

According to the invention as recited in the aforementioned Item [99], the molding pressure can be reduced substantially.

According to the invention as recited in the aforementioned Item [100], it is possible to assuredly control that the portion of each processing scheduled portion of the raw material corresponding to the portion of the basal end side of the guide rather than the tip end portion of the guide is heated, which can assuredly prevent deterioration of the deformation resistance of each portion of the raw material.

According to the invention as recited in the aforementioned Item [101], a high quality cylindrical upsetting manufactured product in which outwardly expanded portions are formed at axial both end portions so that the wall thickness increases can be provided.

According to the invention as recited in the aforementioned Item [102] to [110], an upsetting apparatus for a cylindrical raw material which can be suitably used for any one of the upsetting methods for a cylindrical raw material according to the aforementioned Items [80] to [89] can be provided.

According to the invention as recited in the aforementioned Item [111] to [119], an upsetting apparatus for a cylindrical raw material which can be suitably used for any one of the upsetting methods for a cylindrical raw material according to the aforementioned Items [91] to [100] can be provided.

### BRIEF EXPLANATION OF THE DRAWINGS

FIG. 1 is a schematic vertical cross-sectional perspective view showing a principal portion of an upsetting apparatus according to the first embodiment of the present invention.

FIG. 2 is a vertical cross-sectional view of the upsetting apparatus showing the state in which a core bar and a punch are being set to prescribed positions.

FIG. 3 is a vertical cross-sectional view of the upsetting apparatus showing the state before processing the processing scheduled portion of the raw material with the upsetting apparatus.

FIG. 4 is a vertical cross-sectional view of the upsetting apparatus showing the state in which the processing scheduled portion of the raw material is being processed with the upsetting apparatus.

FIG. 5 is a vertical cross-sectional view of the upsetting apparatus showing the state after processing the processing scheduled portion of the raw material with the upsetting apparatus.

FIG. 6 is a perspective view of the upsetting manufactured product obtained by the upsetting apparatus.

FIG. 7 is a schematic cross-sectional perspective view of the principal portion of the upsetting apparatus according to the second embodiment of the present invention.

FIG. 8 is a vertical cross-sectional view of the upsetting apparatus showing the state before processing the processing scheduled portion of the raw material by the upsetting apparatus.

FIG. 9 is a vertical cross-sectional view of the upsetting apparatus showing the state in which the processing scheduled portion of the raw material is being processed with the upsetting apparatus.

FIG. 10 is a vertical cross-sectional view of the upsetting apparatus showing the state after processing the processing scheduled portion of the raw material with the upsetting apparatus.

FIG. 11 is a perspective view of the upsetting manufactured product obtained by the upsetting apparatus.

FIG. 12 is a vertical cross-sectional view of the upsetting apparatus showing the state before processing the processing scheduled portion of the raw material with the upsetting apparatus according to the third embodiment of the present invention.

FIG. 13 is a vertical cross-sectional view of the upsetting apparatus showing the state in which the processing scheduled portion of the raw material is being processed with the upsetting apparatus.

FIG. 14 is a vertical cross-sectional view of the upsetting apparatus showing the state after processing the processing scheduled portion of the raw material with the upsetting apparatus.

FIG. 15 is a vertical cross-sectional view of the upsetting apparatus showing a modification of the first embodiment of the upsetting apparatus.

FIG. 16 is a vertical cross-sectional view of an upsetting apparatus showing another modification of the upsetting apparatus of the third embodiment.

FIG. 17 is a vertical cross-sectional view of the upsetting apparatus showing the state before processing the processing scheduled portion of the raw material with the upsetting apparatus according to the fourth embodiment of the present invention.

FIG. 18 is a vertical cross-sectional view of the upsetting apparatus showing the state in which the processing scheduled portion of the raw material is being processed with the upsetting apparatus.

FIG. 19 is a vertical cross-sectional view of this upsetting apparatus showing the state after processing the working predetermined portion of the raw material with the upsetting apparatus.

FIG. 20 is a vertical cross-sectional view of the upsetting apparatus showing the state before processing the processing scheduled portion of the raw material with the upsetting apparatus according to the fifth embodiment of the present invention.

FIG. 21 is a vertical cross-sectional view of the upsetting apparatus showing the state in which the processing scheduled portion of the raw material is being processed with the upsetting apparatus.

FIG. 22 is a vertical cross-sectional view of the upsetting apparatus showing the state after processing the processing scheduled portion of the raw material with the upsetting apparatus.

FIG. 23 is a vertical cross-sectional view of the upsetting apparatus showing the state before processing the processing scheduled portion of the raw material with he upsetting apparatus according to the sixth embodiment of the present invention.

FIG. 24 is a vertical cross-sectional view of the upsetting apparatus showing the state in which the processing scheduled portion of the raw material is being processed with the upsetting apparatus.

FIG. 25 is a vertical cross-sectional view of the upsetting apparatus showing the state after processing the processing scheduled portion of the raw material with the upsetting apparatus.

### DETAILED DESCRIPTION OF THE PREFERRED EMBODIMENTS

Next, some embodiments of the present invention will be explained below with reference to the drawings.

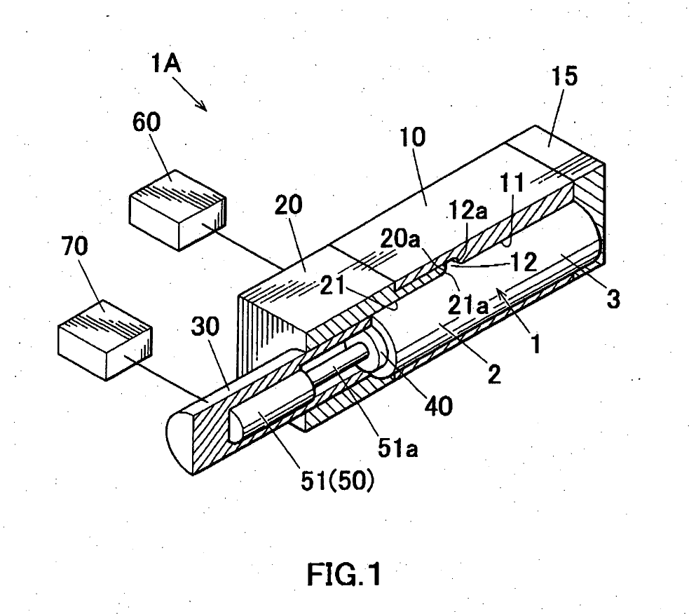

FIGS. 1 to 6 are schematic views for explaining an upsetting method using an upsetting apparatus of a cylindrical raw material according to a first embodiment of the present invention.

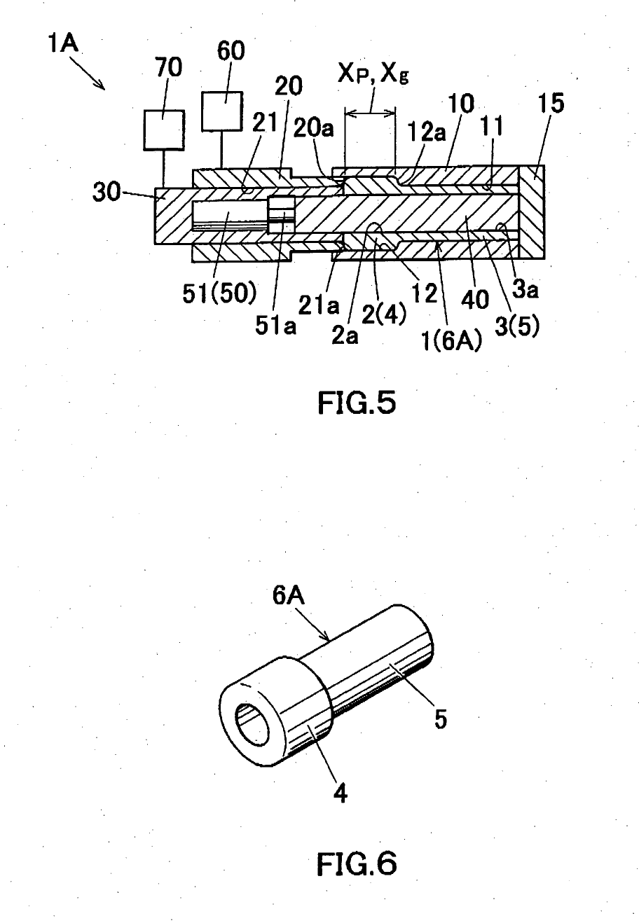

In FIG. 1, “1A” denotes an upsetting apparatus according to the first embodiment, and “1” denotes a cylindrical raw material. Furthermore, in FIG. 6, “6A” denotes a cylindrical upsetting manufactured product manufactured by the upsetting apparatus 1A. This upsetting manufactured product 6A is used as, for example, a preform for manufacturing a part of a cylindrical color component to be mounted at the central portion of a bush (e.g., vibration reduction bush) for vehicles, such as, e.g., automobiles or railroad vehicles, a preform for manufacturing a part of a shank member of an arm for vehicles, or a preform for manufacturing a component in which a screw hole is to be formed at the end portion of a cylindrical shank portion. In addition, “5” denotes a shank portion of the upsetting manufactured product 6A constituted by the non-processing scheduled portion 3 of the raw material 1, and “4” denotes an expanded portion formed at the end portion of the shank portion 5. This expanded portion 4 is expanded in the wall thickness outwardly of the raw material 1 (i.e., in the radially outward direction of the raw material 1).

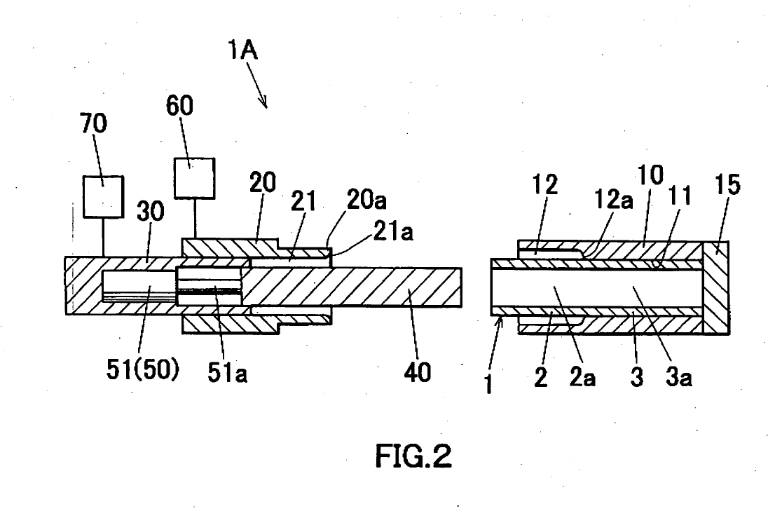

As shown in FIGS. 1 and 2, the raw material 1 is a straight cylindrical member, in detail, a straight round pipe made of, e.g., aluminum (including its alloy, hereinafter simply referred to as “aluminum”). The raw material 1 is round in cross-section, and the internal diameter, the external diameter, and the wall thickness of the raw material 1 are constant in the axial direction, respectively. Moreover, the raw material 1 is made of, e.g., an extruded material.

In the meantime, in the present invention, the material of the raw material 1 is not limited to aluminum, but can be metal, such as, e.g., brass, copper, or stainless steel, or plastic.

The processing scheduled portion 2 of the raw material 1 is located at one end portion of the axial end portions of the raw material 1, or at one axial end portion of the raw material 1. In other words, the axial one end portion of the raw material 1 corresponds to the processing scheduled portion 2. On the other hand, the non-processing scheduled portion 3 of this raw material 1 is located at the axial other end portion of the raw material 1. In other words, the axial other end portion of the raw material 1 corresponds to the non-processing scheduled portion 3. By processing the processing scheduled portion 2 of the raw material 1 to increase the wall thickness into a designed shape, as shown in FIG. 5, an outwardly expanded portion 4 increased in wall thickness is formed at one end portion of the raw material 1 (the shank portion 5).

The upsetting apparatus 1A is configured to expand the processing scheduled portion 2 of the raw material 1 so as to increase the wall thickness thereof. This upsetting apparatus 1A is equipped with a core bar 40, a restraining die 10, a molding dented portion 12, a guide 20, a punch 30, a guide driving apparatus 60, and a punch driving apparatus 70.

The core bar 40 is a straight bar-shaped member circular in cross-section to be inserted into the hollow portions 2a and 3a of the processing scheduled portion 2 and the non-processing scheduled portion 3 of the raw material 1 to thereby restrain the internal peripheral surfaces of the processing scheduled portion 2 and the non-processing scheduled portion 3 with the peripheral surface of the core bar 40 in a buckling preventing state. The core bar 40 is set to be constant in diameter in the axial direction.

The restraining die 10 has a restraining hole 11 round in cross-section extended in the axial direction. This restraining hole 11 is configured to hold the non-processing scheduled portion 3 of the raw material 1 inserted therein to restrain the external peripheral surface of this non-processing scheduled portion 3 with the peripheral surface of the restraining hole 11 in the buckling preventing state.

“15” denotes a bottom portion of the restraining die 10. This bottom portion 15 closes the bottom of the restraining die so that the non-processing scheduled portion 3 of the raw material 1 disposed in the restraining hole 11 is unexpectedly extruded through the opening of the bottom of the restraining hole 11.

The restraining die 10 is longitudinally divided into a plurality of pieces (e.g., two pieces). That is, it is a split mold.

The molding dented portion 12 is, as shown in FIG. 2, formed at the axial one end portion of the restraining die 10 continuously from the restraining hole 11. That is, this molding dented portion 12 is formed by forming an annular dented portion in the peripheral surface of the axial one end portion of the restraining hole 11 of the restraining die 10.

The guide 20 has an insertion hole 21 round in cross-section extended in the axial direction. This insertion hole 21 is configured to hold the processing scheduled portion 2 of the raw material 1 inserted therein so as to allow the axial movement in a buckling preventing state. This insertion hole 21 penetrates the guide 20 in the axial direction thereof.

The guide 20 is movable in a direction 25 opposite to the moving direction 35 of the punch (see FIG. 4).

Moreover, the opening edge portion of the insertion hole 21 of the tip end portion 20a of the guide 20 is chamfered, and therefore the edge portion is formed into around cross-sectional shape. “21a” denotes a chamfered portion formed at the edge portion.

The punch 30 is for axially pressurizing the processing scheduled portion 2 of the raw material 1. The tip end portion of this punch 30 is formed into a cross-sectional shape corresponding to the cross-sectional shape of the axial end portion (i.e., processing scheduled portion 2) of the raw material 1, i.e., the tip end portion of the punch 30 is cylindrical in cross-section.

Furthermore, a hollow portion extended in the axial direction is formed in the punch 30, and an extensible device 50 extensible in the axial direction is disposed in this hollow portion. And, as shown in FIG. 2, the core bar 40 is connected to the punch 30 via the extensible device 50 so as to extend in the axial direction of the punch 30.

In this embodiment, the extensible device 50 is a fluid pressure cylinder 51 operated by fluid pressure, such as, e.g., hydraulic pressure or gas pressure. At the tip end portion of the extensible rod 51a of this fluid pressure cylinder 51, the core bar 40 is fixed.

The punch driving apparatus 70 is for moving the punch 30 in the axial direction of the raw material 1 to give a pressure for pressurizing the processing scheduled portion 2 of the raw material 1 to the punch 30. This punch driving apparatus 70 is connected to the punch 30 to give driving force to the punch 30 by fluid pressure (hydraulic pressure, gas pressure, etc.) This punch driving apparatus 70 does not require a speed controller since it is possible to make the speed of a punch constant when the target shape (designed shape) is determined. However, by employing a pressurizing speed controller, it becomes possible to arbitrarily control the upset shape (shape of expanded portion).

The guide driving apparatus 60 is for moving the guide 20 in a direction opposite 25 to the moving direction 35 (i.e., the pressure direction to the raw material processing scheduled 2 with the punch 30) (see FIG. 4). This guide driving apparatus 60 is connected to the guide 20 to give driving force to the guide 20 with, e.g., fluid pressure (hydraulic pressure, gas pressure), an electric motor, a spring. This guide driving apparatus 60 does not require a speed controller since it is possible to make the speed of the guide constant when the target shape (designed shape) is determined. However, by employing a speed controller, it becomes possible to control the upset shape (shape of expanded portion).

Next, an upsetting method using the aforementioned upsetting apparatus 1A of the first embodiment will be explained below.

First, as shown in FIG. 2, the non-processing scheduled portion 3 of the raw material 1 is inserted in the restraining hole 11 of the restraining die 10. With this, the processing scheduled portion 2 of the raw material 1 is placed in the molding dented portion 12 of the restraining die 10. In this state, the external peripheral surface of the non-processing scheduled portion 3 of the raw material 1 is restrained by the peripheral surface of the restraining hole

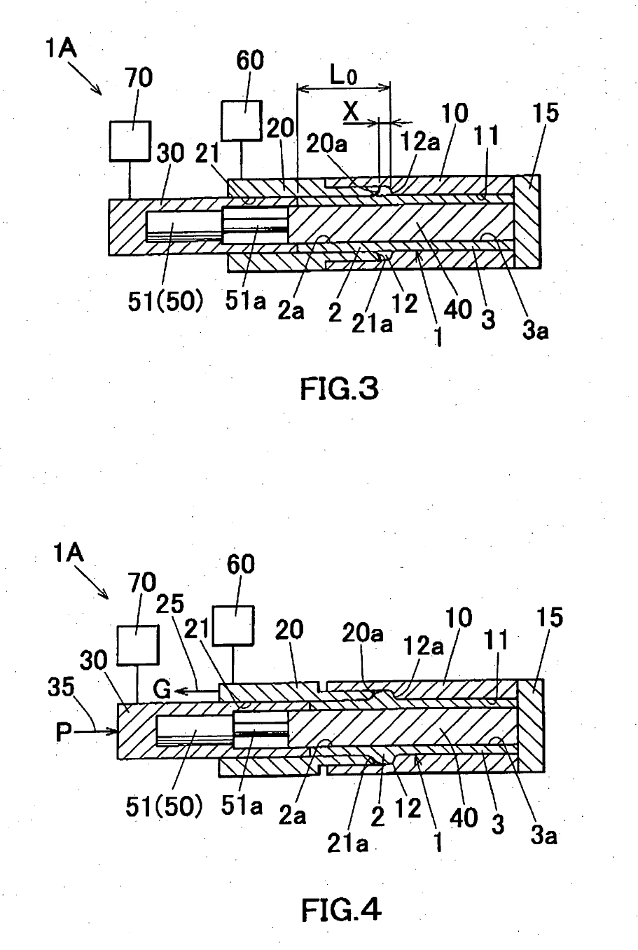

Subsequently, in a state in which the core bar 40 is connected to the punch 30 via the fluid pressure cylinder 51 as the extensible device 50, the core bar 40 is inserted into the hollow portions 2a and 3a of the processing scheduled portion 2 and the non-processing scheduled portion 3 of the raw material 1 [Setting work of the core bar 40]. Through this operation, as shown in FIGS. 1 and 3, the punch 30 is placed at the initial position located at the axial end portion side of the raw material 1 [Setting work of the punch 30]. In this state, the internal peripheral surfaces of the processing scheduled portion 2 and the non-processing scheduled portion 3 of the raw material 1 are restrained by the peripheral surface of the core bar 40.

Furthermore, the processing scheduled portion 2 of the raw material 1 is inserted in the insertion hole 21 of the guide 20. With this, the external peripheral surface of the processing scheduled portion 2 of the raw material 1 is restrained by the peripheral surface of the insertion hole 21 of the guide 20.

Furthermore, as shown in FIG. 3, an initial clearance X is set between the tip end portion 20a of the guide 20 and the bottom portion 12a of the molding dented portion 12. In the state before initiating the movement of the punch 30 (i.e., pressurization to the raw material processing scheduled portion 2 with the punch 30), the distance of this initial clearance X is set to be not larger than the buckling limit length X₀ (preferably, less than the buckling limit length X₀) at the cross-sectional area of the exposed portion of the processing scheduled portion 2 of the raw material 1 exposed between the tip end portion 20a of the guide 20 and the bottom portion 12a of the molding dented portion 12. In the present invention, the buckling limit length denotes a buckling limit length at the punch pressurizing force.

Subsequently, as shown in FIG. 4, while axially pressurizing the processing scheduled portion 2 of the raw material 1 with the punch 30 by moving the punch by operating the punch driving apparatus 70, the guide 20 is moved in a direction 25 opposite to the moving direction 35 of the punch 30 by operating the guide driving apparatus 60. With this, the processing scheduled portion 2 of the raw material 1 exposed between the tip end portion 20a of the guide 20 and the bottom portion 12a of the molding dented portion 12 is outwardly expanded so that the wall thickness increases within the molding dented portion 12. Furthermore, the rod 51a of the fluid pressure cylinder 51 is retracted in accordance with the movement of the punch 30 to prevent the axial displacement of the core bar 40.

Here, it is preferable to set a time lag to between the moving initiation of the punch 30 and the moving initiation of the guide 20. That is, in the case of initiating the pressurization of the processing scheduled portion 2 of the raw material 1 with the punch 30, the position of the guide 20 is fixed to the initial position, and then the processing scheduled portion 2 of the raw material 1 is axially pressurized with the punch 30 by moving the punch 30. After the lapse of the time lag to, while continuously pressurizing the processing scheduled portion 2 of the raw material 1 with the punch 30, the guide 20 is moved in a direction 25 opposite to the moving direction 35 of the punch 30. At this time, the traveling speed of the guide 20 is controlled by the controller of the guide driving apparatus 60 so as not to exceed the buckling limit length at the cross-sectional area of the exposed portion of the processing scheduled portion 2 of the raw material 1 exposed between the tip end portion 20a of the guide 20 and the bottom portion 12a of the molding dented portion 12. Moreover, when the processing conditions are determined, a cylinder or a machine cam of a designed constant speed can be used.

With the movements of the punch 30 and the guide 20, the processing scheduled portion 2 of the raw material 1 is gradually outwardly expanded so that the wall thickness increases within the molding dented portion 12, and the material of the processing scheduled portion 2 is gradually filled in the molding dented portion 12 under pressure.

As shown in FIG. 5, when the tip end portion of the punch 30 has reached the stop position X_{P} corresponding to the bottom portion 12a of the molding dented portion 12 obtained from the design volume of the expanded portion 4, the movement of the punch 30 is terminated. When the tip end portion 20a of the guide 20 has reached the stop position X_{g} corresponding to the bottom portion 12a of the molding dented portion 12 defined by the tip end portion 20a of the guide 20, the movement of the guide 20 is terminated. At this time, the material of the processing scheduled portion 2 of the raw material 1 has been completely filled in the molding dented portion 12, and the processing scheduled portion 2 has been expanded into the designed shape.

Through the aforementioned procedures, the wall thickening processing for the processing scheduled portion 2 of the raw material 1 is completed.

Next, in order to pull the core bar 40 out of the hollow portions 2a and 3a of the processing scheduled portion 2 and the non-processing scheduled portion 3 of the raw material 1, the punch 30 is moved in the axially outward direction of the raw material 1 from the position of the axial end portion of the raw material 1. Thus, the punch 30 is removed from the position of the axial end portion of the raw material 1, and the core bar 40 is pulled out [Pulling out work of the core bar 40 and removal work of the punch 30]. Then, the upsetting manufactured product 6A is pulled out of the restraining hole 11 of the restraining die 10.

In the first embodiment, the stop position X_{P} of the tip end portion of the punch 30 with respect to the bottom portion 12a of the molding dented portion 12 and the stop position X_{g} of the tip end portion 20a of the guide 20 with respect to the bottom portion 12a of the molding dented portion 12 coincide with each other. However, in the present invention, it is not always required that X_{P} and X_{g} coincide with each other.

Thus, in the aforementioned upsetting method of the first embodiment, in pressurizing the processing scheduled portion 2 of the raw material 1 with the punch 30, the internal peripheral surfaces of the processing scheduled portion 2 and the non-processing scheduled portion 3 of the raw material 1 are restrained by the peripheral surface of the core bar 40, and the external peripheral surface of the non-processing scheduled portion 3 is restrained by the peripheral surface of the restraining hole 11 of the restraining die 10. Therefore, inward and outward buckling of the non-processing scheduled portion 3 of the raw material 1 is prevented, and the inward buckling of the processing scheduled portion 2 is prevented. Furthermore, the processing scheduled portion 2 of the raw material 1 is placed in the insertion hole 21 of the guide 20, so that the external peripheral surface of the processing scheduled portion 2 is restrained by the peripheral surface of the insertion hole 21. With this, the outward buckling of the processing scheduled portion 2 is prevented. In this state, by moving the guide 20 in a direction 25 opposite to the moving direction 35 of the punch 30 while axially pressurizing the processing scheduled portion 2 of the raw material 1 with the punch 30, the processing scheduled portion 2 of the raw material 1 exposed between the tip end portion 20a of the guide 20 and the bottom portion 12a of the molding dented portion 12 is outwardly expanded assuredly and favorably so that the wall thickness is increased within the molding dented portion 12. Consequently, a high quality cylindrical upsetting manufactured product 6A can be obtained.

As mentioned above, this upsetting manufactured product 6A is used as, e.g., a preform for manufacturing a part of a color member for bushes, a preform for manufacturing a part of a shank member of an arm for vehicles, or a preform for manufacturing a member in which a screw hole is formed at an end portion of a cylindrical shank portion. Furthermore, this upsetting manufactured product 6A is used as a member in which another member is to be integrally secured to an end portion of a cylindrical shank portion by a friction stir welding, i.e., a joint member for a friction stir welding. Concretely, it can be used as a preform for manufacturing the aforementioned shank portion of an arm for vehicles.

In order to obtain a cylindrical upsetting manufactured product in which an expanded portion 4 is outwardly expanded so that the wall thickness increases at prescribed portion, conventionally, the processing was usually performed by a hydroform method or a hot bulge method, which required an expensive and large-scale facility. Moreover, the hydroform method and the hot bulge method were mainly used as a processing method for obtaining a large product. As processing for obtaining a small product, machining, such as, e.g., cutting, was conventionally used. According to the upsetting method of the aforementioned embodiment, since no large molding pressure is not required at the time of the processing, the processing apparatus can be simplified. Furthermore, it also becomes possible to remarkably improve the tact time as compared with a conventional method in cases where the punch 30 and the guide 20 are combined with a high-speed hydraulic cylinder or a machine cam into a die set and this die set is installed in a mechanical press machine. Furthermore, the yield can be significantly improved as compared with machining, which in turn can attain a large cost cut effect.

Furthermore, in this embodiment, since the guide 20 is moved by the driving force of the guide driving apparatus 60, the guide 20 can be moved assuredly.

Furthermore, since the tip end portion of the punch 30 is formed into a cross-sectional shape corresponding to the cross-sectional shape of the axial end portion of the raw material 1, the processing scheduled portion 2 of the raw material 1 can be assuredly pressurized with the punch 30.

Furthermore, since the core bar 40 is connected to the punch 30 so as to extend in the axial direction of the punch 30, the setting work of the core bar 40 for placing the core bar 40 into the hollow portions 2a and 3a of the processing scheduled portion 2 and the non-processing scheduled portion 3 of the raw material 1, and the setting work of the punch 30 for placing the punch 30 to the axial end portion side of the raw material 1 in order to pressurize the processing scheduled portion 2 of the raw material 1 with the punch 30, can be performed simultaneously, resulting in an improved operation efficiency of the upsetting.

Furthermore, after completion of the processing, a pull-out work of the core bar 40 for pulling out the core bar 40 from the hollow portion 2a and 3a of the processing scheduled portion 2 and the non-processing scheduled portion 3 of the raw material 1 and the removal work of the punch 30 for removing the punch 30 from the position of the axial end portion of the raw material 1, can be performed simultaneously, resulting in further improved operation efficiency of the upsetting.

Furthermore, since the core bar 40 is connected to the punch 30 via the extensible device 50 which can be extended and contracted in the axial direction and the extensible device 50 is contracted with the movement of the punch 30, a problem that the position of the core bar 40 shifts in accordance with the movement of the punch 30 or the expansion of the processing scheduled portion 2 of the raw material 1 can be prevented assuredly.

Furthermore, since the fluid pressure cylinder 51 is used as the extensible device 50, such fault can be prevented assuredly.

Furthermore, since the chamfering work (the chamfered portion 21a) is given to the insertion hole opening edge portion of the tip end portion 20a of the guide 20, the back pressure of the material of the processing scheduled portion 2 of the raw material 1 effectively acts on the tip end portion 20a of the guide 20 at the time of the processing. Consequently, the driving force of the guide driving apparatus 60 for moving the guide 20 can be decreased, which makes it possible to miniaturize the guide driving apparatus 60.

Next, preferable processing conditions for the upsetting method of this embodiment will be explained below.

Hereinafter, “P” denotes an average moving speed of the punch 30 from the moving initiation thereof,

“G” denotes an average moving speed of the guide 20 from the moving initiation thereof,

“X₀” denotes a buckling limit length at the cross-sectional area of the processing scheduled portion 2 of the raw material 1 before the upsetting,

“X” denotes an initial clearance between the tip end portion 20a of the guide 20 and the bottom portion 12a of the molding dented portion 12 (0≦X≦X₀),

“L₀” denotes the length of the raw material 1 before the upsetting required for the expanded portion 4,

“X_{P}” denotes the stop position of the tip end portion of the punch 30 with respect to the bottom portion 12a of the molding dented portion 12 obtained from the design volume of the expanded portion 4,

“X_{g}” denotes the stop position of the tip end portion 20a of the guide 20 with respect to the bottom portion 12a of the molding dented portion 12 defined by the design, and

“t₀” denotes the time lag from the moving initiation of the punch 30 to the moving initiation of the guide 20 (0≦t₀).

In this upsetting method, it is preferable that “G” satisfies the following expression (i).
G=(X_{g}−X)P/(L₀−Xₚ−Pt₀) (i)

When G satisfies the aforementioned equation (i), the processing scheduled portion 2 of the raw material 1 can be assuredly formed into the designed shape.

The reasons for setting aforementioned equation (i) about G will be explained below.

If “t” denotes a time (i.e., upsetting time) from the moving initiation of the punch 30 to the upsetting completion, the distance between the tip end portions of punch 30 and the bottom portion 12a of the molding dented portion 12 at the time t of the upsetting completion, i.e., the position X_{P} of the tip end portion of punch 30 with respect to the bottom portion 12a of the molding dented portion 12, can be given by the following equation (i-a).
L₀−Pt=X_{P} (i-a)
∴t=(L₀−X_{P})/P (i-b)

And, the distance between the tip end portion 20a of the guide 20 and the bottom portion 12a of the molding dented portion 12 at the time t of the upsetting completion, i.e., the position X_{P} of the tip end portion 20a of the guide 20 with respect to the bottom portion 12a of the molding dented portion 12 is given by the following equation (i-c).
X+G(t−t₀)=X_{g} (i-c)

The equation (i) can be derived by substituting the equation (i-b) for the equation (i-c), and arranging about G.

Here, in the first embodiment, at the time of the upsetting, the guide 20 is moved by the driving force of the guide driving apparatus 60. However, in the present invention, it is not required that the guide 20 is moved by such driving force. That is, in the present invention, the guide 20 can be moved by the pressing-back force acting on the guide 20 by pressing the material of the processing scheduled portion 2 of the raw material 1 into the molding dented portion 12. In this case, the guide 20 can be moved without using the guide driving apparatus 60, which in turn can simplify the setting apparatus 1A.

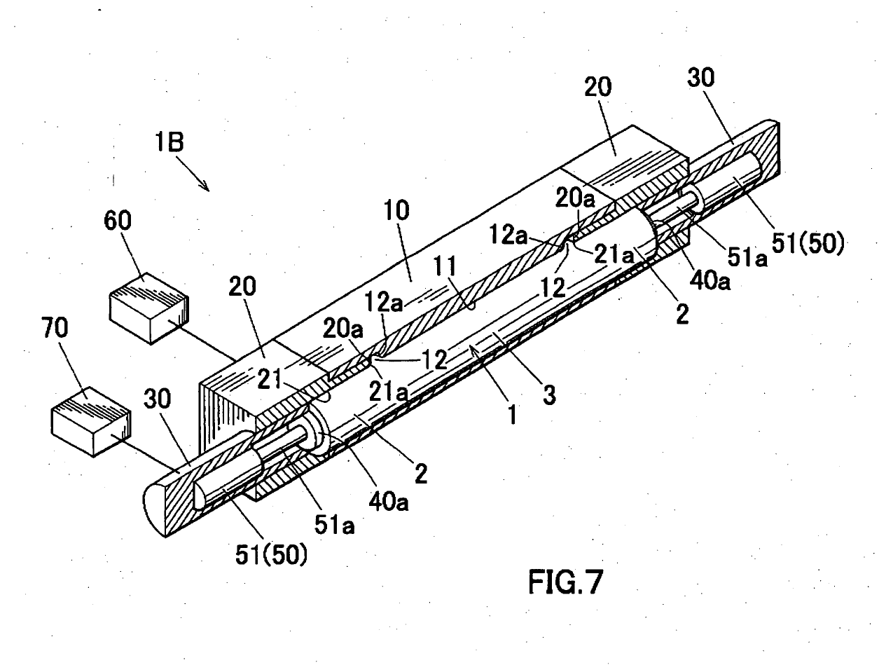

FIGS. 7 to 11 are schematic views for explaining an upsetting method using an upsetting apparatus for a cylindrical raw material according to a second embodiment of the present invention.

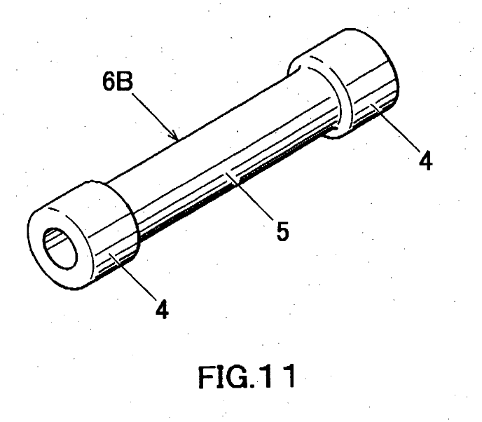

In FIG. 7, “1B” denotes an upsetting apparatus according to the second embodiment, and “1” denotes a cylindrical raw material. In FIG. 11, “6B” denotes a cylindrical upsetting manufactured product manufactured by the upsetting apparatus 1B. This upsetting manufactured product 1B can be used as, e.g., a preform for manufacturing a cylindrical color member to be mounted in the center portion of a bush for automobiles, a preform for manufacturing a shank member of an arm for vehicles, or a preform for manufacturing a member in which a screw hole is formed at both end portions of a cylindrical shank portion. Furthermore, this upsetting manufactured product can be used as a member in which another member is to be integrally secured to an end portion of a cylindrical shank portion by a friction stir welding, i.e., a joint member for a friction stir welding. In other words, this upsetting apparatus 1B can be, for example, an manufacturing apparatus of a preform for bush color members, a manufacturing apparatus of a preform for a shank portion member for vehicle arms, or a manufacturing apparatus of a joining member for friction stir welding. In addition, “5” denotes a shank portion of the upsetting manufactured product 6B made of the non-processing scheduled portion 3 of the raw material 1, “4” denotes an expanded portion formed at each of both end portions of the shank portion 5. Each of the expanded portion 4 is expanded so that the wall thickness of the raw material 1 increases outwardly.

The structure of the upsetting apparatus 1B of this second embodiment will be explained below focusing on the differences with that of the first embodiment 1A.

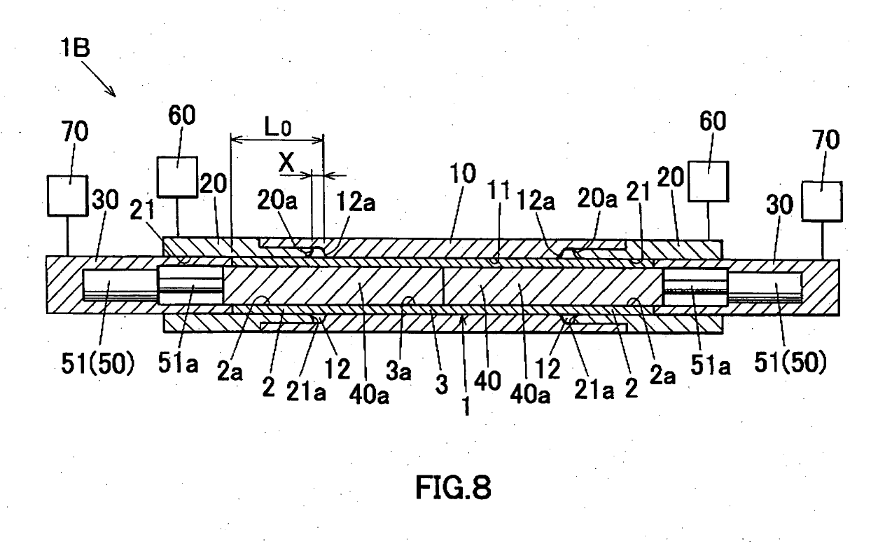

As shown in FIGS. 7 and 8, this raw material 1 is a straight cylindrical member, in detail, a straight round pipe, like the raw material of the first embodiment.

In this raw material 1, the axial intermediate portion of the raw material 1 corresponds to the non-processing scheduled portion 3, and the axial both side portions of the raw material 1, i.e., the axial both end portions of the raw material 1, correspond to the processing scheduled portions 2 and 2, respectively. By executing the wall thickening processing of each processing scheduled portion 2 and 2 of the raw material 1 into a designed shape, expanded portions 4 and 4 outwardly expanded so that the wall thickness increases are formed at both end portions of the raw material 1 (shank portion 5).

The upsetting apparatus 1B is for outwardly expanding the processing scheduled portion 2 and 2 of the axial both end portions of the raw material 1 so that the wall thickness increases. This upsetting apparatus 1B is equipped with a core bar 40, a restraining die 10, two molding dented portion 12 and 12, two guides 20 and 20, two punches 30 and 30, two guide driving apparatuses 60 and 60, and two punch driving apparatuses 70 and 70.

The core bar 40 is a straight bar-shaped member round in cross-section, and is inserted in the hollow portions 2a, 2a and 3a of both processing scheduled portions 2 and 2 and the non-processing scheduled portion 3 of the raw material 1 to restrain the internal peripheral surfaces of both the processing scheduled portion 2 and 2 and the non-processing scheduled portion 3 in a buckling preventing state by the peripheral surface of the core bar 40. The core bar 40 is set to be constant in diameter in the axial direction.

Furthermore, this core bar 40 is evenly divided into two pieces at the axial intermediate portion, i.e., it is constituted by two pieces of core bar halves 40a and 40a. These two core bar halves 40a and 40a are the same in length.

The restraining die 10 has a restraining hole 11 extended in the axial direction thereof. The non-processing scheduled portion 3 of the raw material 1 is inserted into the restraining hole 11, and the external peripheral surface of the non-processing scheduled portion 3 is restrained by the peripheral surface of the restraining hole 11 in a buckling preventing state. This restraining hole 11 is formed in the restraining die 10 in the axial penetrated manner.

Each molding dented portion 12 is formed at the axial both side portions (in detail, both end portions) of the restraining die 10 continuously from the corresponding restraining hole 11.

Each guide 20 has an insertion hole 21 extended in the axial direction of the guide. The corresponding processing scheduled portion 2 of the raw material 1 is inserted in each of this insertion hole 21 so that the corresponding processing scheduled portion 2 is movably held in the insertion hole 21 in a buckling preventing state. Each insertion hole 21 penetrates the guide 20 in the axial direction thereof.

Each guide 20 is movable in a direction 25 opposite to the moving direction 35 of the punch.

Moreover, the opening edge portion of the insertion hole 21 of the tip end portion 20a of each guide 20 is chamfered, and therefore the edge portion is formed into a round cross-sectional shape. “21a” denotes a chamfered portion formed at the edge portion.

Each punch 30 is for axially pressurizing the corresponding processing scheduled portion 2 of the raw material 1.

Furthermore, a hollow portion extended in the axial direction is formed in each punch 30, and an extensible device 50 extensible in the axial direction is disposed in this hollow portion. And, the corresponding core bar half 40a is connected to each punch 30 via the extensible device 50 so as to extend in the axial direction of the punch 30.

The extensible device 50 is a fluid pressure cylinder 51. At the tip end portion of the extensible rod 51a of this fluid pressure cylinder 51, the core bar half 40a is fixed.

Each punch driving apparatus 70 is for moving each punch 30 in the axial direction of the raw material 1 to give a pressure for pressurizing the corresponding processing scheduled portion 2 of the raw material 1 to the punch 30. Each punch driving apparatus 70 is connected to the corresponding punch 30.

Each guide driving apparatus 60 is for moving each guide 20 in a direction opposite 25 to the corresponding moving direction 35. Each guide driving apparatus 60 is connected to the corresponding guide 20.

Next, an upsetting method using the aforementioned upsetting apparatus 1B of the second embodiment will be explained below.

First, as shown in FIGS. 7 and 8, the non-processing scheduled portion 3 of the raw material 1 is inserted in the restraining hole 11 of the restraining die 10. With this, each processing scheduled portion 2 of the raw material 1 is placed in the molding dented portion 12 of the restraining die 10. In this state, the external peripheral surface of the non-processing scheduled portion 3 of the raw material 1 is restrained by the peripheral surface of the restraining hole 11.

Subsequently, in a state in which the core bar half 40a is connected to each punch 30 via the fluid pressure cylinder 51 as the extensible device 50, one of the core bar halves 40a is inserted into the hollow portions 2a and 3a of one of the processing scheduled portions 2 of the raw material 1 and one of the non-processing scheduled portions 3 of the raw material 1, and the other of the core bar halves 40a is inserted into the hollow portions 2a and 3a of the other of the processing scheduled portions 2 of the raw material 1 and the other of the non-processing scheduled portions 3 of the raw material 1 [Setting work of the core bar 40]. Through this operation, each punch 30 is placed at the initial position located at the corresponding axial end portion side of the raw material 1 [Setting work of the punch 30]. Simultaneously with this, the tip end portions of both the core bar halves 40a and 40a come into contact with each other in the hollow portion 3a of the non-processing scheduled portion 3 of the raw material 1. In this state, the internal peripheral surfaces of the processing scheduled portion 2 and the non-processing scheduled portion 3 of the raw material 1 are restrained by the peripheral surface of both the core bar halves 40a and 40a.

Furthermore, the corresponding processing scheduled portion 2 of the raw material 1 is inserted in the insertion hole 21 of each guide 20. With this, the external peripheral surface of each processing scheduled portion 2 of the raw material 1 is restrained by the peripheral surface of the insertion hole 21 of the guide 20.

Furthermore, as shown in FIG. 8, an initial clearance X is set between the tip end portion 20a of each guide 20 and the corresponding bottom portion 12a of the molding dented portion 12. In the same manner as in the first embodiment, the distance of each initial clearance X is set to be not larger than the buckling limit length X₀ at the cross-sectional area of the exposed portion of the processing scheduled portion 2 of the raw material 1 exposed between the tip end portion 20a of each guide 20 and the corresponding bottom portion 12a of the molding dented portion 12.

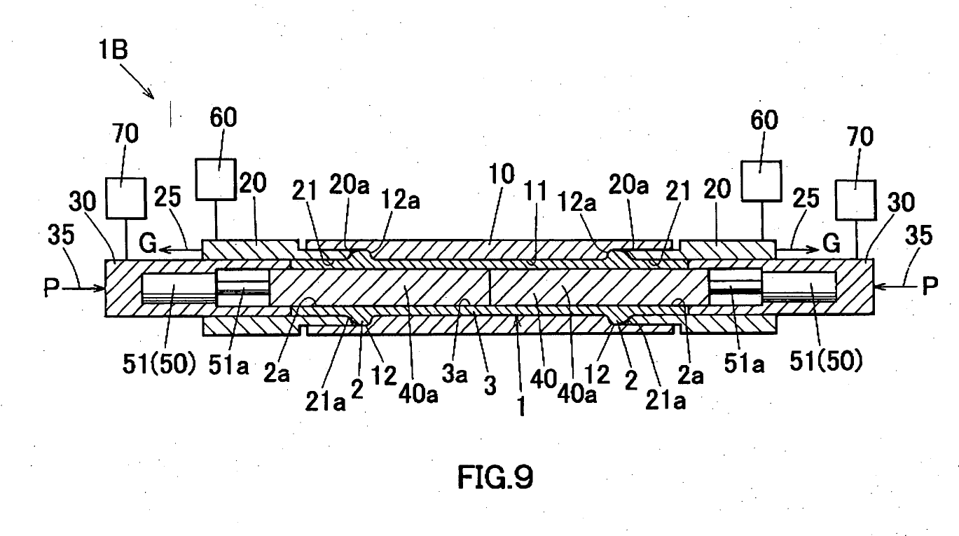

Subsequently, as shown in FIG. 9, while axially simultaneously pressurizing each processing scheduled portion 2 of the raw material 1 with the corresponding punch 30 by simultaneously moving both the punches 30 and 30 by operating both the punch driving apparatuses 70 and 70, each guide 20 is moved in a direction 25 opposite to the moving direction 35 of the corresponding punch 30 by simultaneously operating both the guide driving apparatuses 60 and 60. With this, the processing scheduled portion 2 of the raw material 1 exposed between the tip end portion 20a of each guide 20 and the corresponding bottom portion 12a of the molding dented portion 12 is outwardly expanded so that the wall thickness increases within the corresponding molding dented portion 12. Furthermore, the rod 51a of the fluid pressure cylinder 51 is retracted in accordance with the movement of each punch 30 to prevent the axial displacement of the core bar half 40a.

Here, a time lag to is set between the moving initiation of each punch 30 and the moving initiation of the guide 20. That is, in the case of initiating the pressurization of the processing scheduled portion 2 of the raw material 1 with each punch 30, the position of each guide 20 is fixed to the initial position, and then each processing scheduled portion 2 of the raw material 1 is axially pressurized with the corresponding punch 30 by moving the punch 30. After the lapse of the time lag to, while continuously pressurizing the corresponding processing scheduled portion 2 of the raw material 1 with each punch 30, each guide 20 is moved in a direction 25 opposite to the moving direction 35 of the corresponding punch 30. At this time, the traveling speed of each guide 20 is controlled by the controller of the guide driving apparatus 60 so as not to exceed the buckling limit length at the cross-sectional area of the exposed portion of the processing scheduled portion 2 of the raw material 1 exposed between the tip end portion 20a of the guide 20 and the bottom portion 12a of the molding dented portion 12. Moreover, when the processing conditions are determined, a cylinder or a machine cam of a designed constant speed can be used.

With the movement of each punch 30 and each guide 20, each processing scheduled portion 2 of the raw material 1 is gradually outwardly expanded so that the wall thickness increases within the corresponding molding dented portion 12, and the material of the processing scheduled portion 2 is gradually filled in the molding dented portion 12.

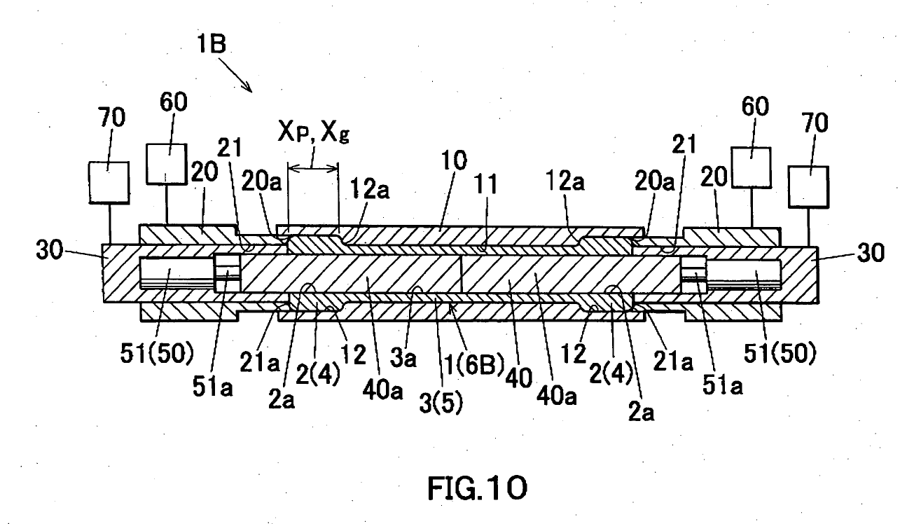

As shown in FIG. 10, when the tip end portion of each punch 30 has reached the stop position X_{P} with respect to the bottom portion 12a of the molding dented portion 12 obtained from the design volume of the corresponding expanded portion 4, the movement of the punch 30 is terminated. When the tip end portion 20a of each guide 20 has reached the stop position X_{g} with respect to the bottom portion 12a of the molding dented portion 12 defined by the tip end portion 20a of the guide 20, the movement of each guide 20 is terminated. At this time, the material of the processing scheduled portion 2 of the raw material 1 has been completely filled in the corresponding molding dented portion 12, and the processing scheduled portion 2 has been expanded into the designed shape.

Through the procedures, the wall thickening processing for both the processing scheduled portions 2 of the raw material 1 are completed.

Next, in order to pull each core bar half 40a out of the hollow portions 2a, 2a and 3a of both the processing scheduled portions 2 and the non-processing scheduled portion 3 of the raw material 1, each punch 30 is moved in the axial direction of the raw material 1 from each position of the axial end portion of the raw material 1. Thus, each punch 30 is removed from the position of the axial end portion of the raw material 1, and at the same time each core bar half 40a is pulled out [Pulling out work of the core bar half 40a and removal work of the punch 30]. Then, the upsetting manufactured product 6B is pulled out of the restraining hole 11 of the restraining die 10.

In the second embodiment, the stop position X_{P} of the tip end portion of each punch 30 with respect to the bottom portion 12a of the molding dented portion 12 and the stop position X_{g} of the tip end portion 20a of each guide 20 with respect to the bottom portion 12a of the molding dented portion 12 coincide with each other. However, in the present invention, it is not always required that X_{P} and X_{g} coincide with each other.

The average moving speed G from the moving initiation of each guide 20 preferably satisfies the aforementioned equation (i).

In the upsetting method of the second embodiment, by moving each guide 20 in a direction 25 opposite to the moving direction 35 of the corresponding punch 30 while simultaneously pressurizing each processing scheduled portion 2 of the raw material 1 with the corresponding punch 30 in the axial direction, both the processing scheduled portions 2 and 2 of the raw material 1 are simultaneously expanded outwardly. Therefore, an upsetting manufactured product 6B in which expanded portions 4 and 4 are outwardly expanded in the axial both end portions can be manufactured efficiently.

Furthermore, the setting work of the core bar half 40a for placing each core bar half 40a in the hollow portions 2a and 3a of the processing scheduled portion 2 and the non-processing scheduled portion 3 of the raw material 1 and the setting work of the punch 30 for placing each punch 30 at the axial end portion side of the raw material 1 to pressurize the corresponding processing scheduled portion 2 of the raw material 1 with each punch 30 can be performed simultaneously, resulting in improved upsetting operation efficiency.

Furthermore, after completion of the processing, the pulling out work of the core bar half 40a for pulling each core bar half 40a out of the hollow portions 2a and 3a of the processing scheduled portion 2 and the non-processing scheduled portion 3 of the raw material 1 and the removal work of the punch 30 for removing each punch 30 from the position of the axial end portion of the raw material 1 can be performed simultaneously, resulting in further improved upsetting operation efficiency.

Furthermore, since the core bar 40 is divided into two halves at the axial intermediate portion and therefore the length is shortened, the insertion time for inserting the core bar 40 into the prescribed hollow portions 2a and 3b can be shortened, which can further improve the operation efficiency of the upsetting.

In the second embodiment, although each guide 20 is moved by the driving force of the guide driving apparatus 60 at the time of the upsetting, the present invention does not necessarily require that each guide 20 is moved by such driving force. That is, in the present invention, each guide 20 can be moved by the pressing-back force acting on the guide 20 by press-fitting the material of each processing scheduled portion 2 of the raw material 1 into the molding dented portion 12. In this case, even if each guide driving apparatus 60 is not always used, each guide 20 can be moved. Therefore, the upsetting apparatus 1B can be simplified.

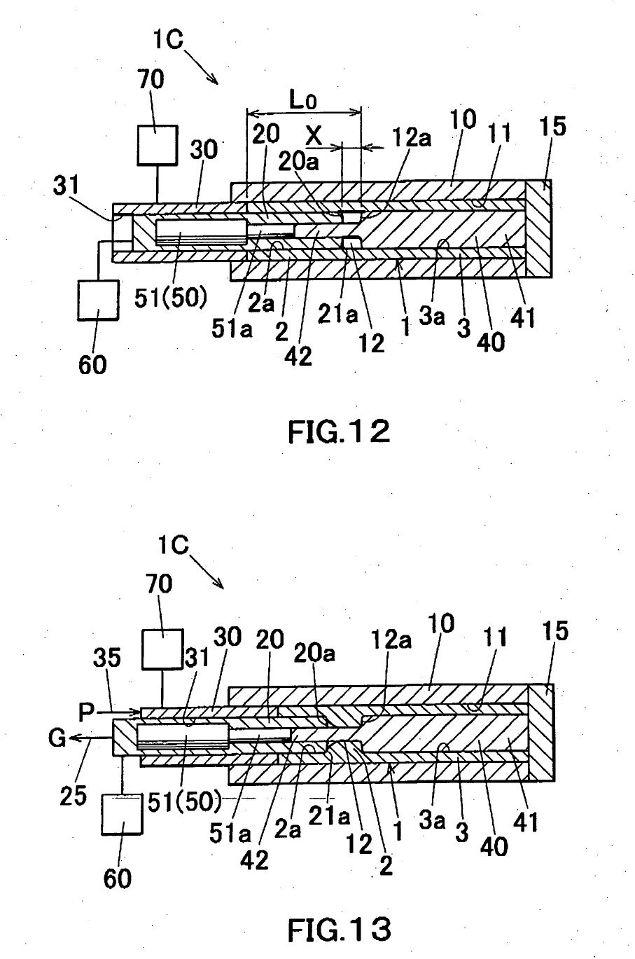

FIGS. 12 to 14 are schematic views for explaining an upsetting method using an upsetting apparatus of a cylindrical raw material according to the third embodiment of the present invention.

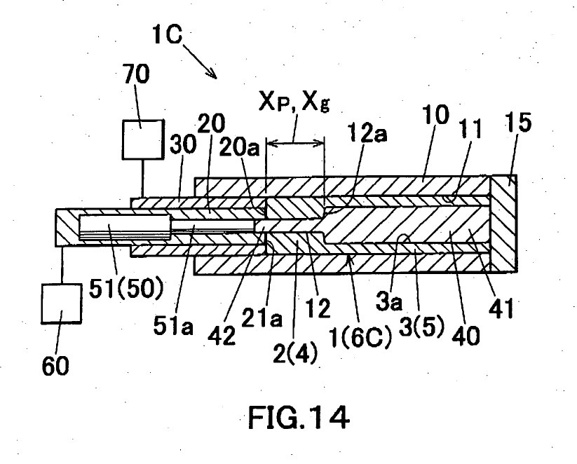

In FIG. 12, “1C” denotes an upsetting apparatus according to the third embodiment, and “1” denotes a cylindrical raw material. Furthermore, in FIG. 14, “6C” denotes a cylindrical upsetting manufactured product manufactured by the upsetting apparatus 1C. This upsetting manufactured product 6C is used as, for example, a preform for manufacturing a shank member of an arm for vehicles, or a preform for manufacturing a component in which a screw hole is to be formed at both end portions of a cylindrical shank portion. Or, the product can be used as a member in which another member is to be integrally secured to an end portion of a cylindrical shank portion by a friction stir welding, i.e., a joining cylindrical member for a friction stir welding. “5” denotes a shank portion of the upsetting manufactured product 6C constituted by the non-processing scheduled portion 3 of the raw material 1, and “4” denotes an expanded portion formed at the end portion of the shank portion 5. This expanded portion 4 is expanded so that the wall thickness of the raw material 1 increases inwardly (i.e., toward the radially inward direction of the raw material 1).

The structure of the upsetting apparatus 1C of this third embodiment will be explained below focusing on the differences with the apparatus 1A of the first enforcement.

As shown in FIG. 12, just like the raw material of the first embodiment, the raw material 1 is a straight cylindrical member, in detail, a straight pipe round in cross-section.

The processing scheduled portion 2 of the raw material 1 is located at one end portion of the axial end portions of the raw material 1, or at one axial end portion of the raw material 1. In other words, the axial one end portion of the raw material 1 corresponds to the processing scheduled portion 2. On the other hand, the non-processing scheduled portion 3 of this raw material 1 is located at the axial other end portion of the raw material 1. In other words, the axial other end portion of the raw material 1 corresponds to the non-processing scheduled portion 3. By processing the processing scheduled portion 2 of the raw material 1 to increase the wall thickness into a designed shape, as shown in FIG. 14, an inwardly expanded portion 4 increased in wall thickness is formed at one end portion of the raw material 1 (the shank portion 5).

The upsetting apparatus 1C is configured to inwardly expand the processing scheduled portion 2 of the raw material 1 so as to increase the wall thickness thereof. This upsetting apparatus 1C is equipped with a core bar 40, a restraining die 10, a molding dented portion 12, a guide 20, a punch 30, a guide driving apparatus 60, and a punch driving apparatus 70.

The core bar 40 has a core bar main body 41 and a small diameter portion 42 integrally formed at the axial one end portion of the core bar main body 41 and smaller than the core bar main body 41 in diameter. In this core bar 40, the core bar main body 41 is inserted in the hollow portion 3a of the non-processing scheduled portion 3 of the raw material 1, and restrains the internal peripheral surface of the non-processing scheduled portion 3 in a buckling preventing state with the peripheral surface of the core bar main body 41. The small diameter portion 42 of the core bar 40 is placed in the hollow portion 2a of the processing scheduled portion 2 of the raw material 1, and forms the molding dented portion 12 between the internal peripheral surface of the processing scheduled portion 2 and the small diameter portion 42.

The restraining die 10 has a restraining hole 11 extended in the axial direction. This restraining hole 11 is configured to hold the processing scheduled portion 2 and the non-processing scheduled portion 3 of the raw material 1 inserted therein to restrain the external peripheral surfaces of the processing scheduled portion 2 and the non-processing scheduled portion 3 with the peripheral surface of the restraining hole 11 in the buckling preventing state.

The restraining die 10 is longitudinally divided into a plurality of pieces. That is, it is a split mold.

The punch 30 is for axially pressurizing the processing scheduled portion 2 of the raw material 1. The tip end portion of this punch 30 is formed into a cross-sectional shape corresponding to the cross-sectional shape of the axial end portion (i.e., processing scheduled portion 2) of the raw material 1, i.e., the tip end portion of the punch 30 is cylindrical in cross-section.

Furthermore, a hollow portion 31 extended in the axial direction is formed in the punch 30. This hollow portion 31 penetrates the punch 30 in the axial direction.

The guide 20 is placed in the hollow portion 2a of the processing scheduled portion 2 of the raw material 1, and restrains the internal peripheral surface of the processing scheduled portion 2 by the peripheral surface of the guide 20.

This guide 20 is movable in a direction 25 opposite to the moving direction 35 of the punch. This guide 20 is placed in the hollow portion 31 of the punch 30 in the axially movable manner.

Moreover, the peripheral edge portion of the tip end portion 20a of the guide 20 is chamfered, and therefore the peripheral edge portion is formed into a round cross-sectional shape. “21a” denotes a chamfered portion formed at the peripheral edge portion.

Furthermore, the guide 20 has a hollow portion extended in the axial direction, and a fluid pressure cylinder 51 is placed in the hollow portion as an extensible device 50 capable of being extended and contracted in the axial direction. To this guide 20, the core bar 40 is connected via the fluid pressure cylinder 51 so as to extend in the axial direction of the guide 20. At the tip end portion of the extensible rod 51a of this fluid pressure cylinder 51, the small diameter portion 42 of the core bar 40 is detachably attached.

The punch driving apparatus 70 is for giving pressurizing force for pressurizing the processing scheduled portion 2 of the raw material 1 to the punch 30 by moving the punch 30 in the axial direction of the raw material 1. This punch driving apparatus 70 is connected to the punch 30.

The guide driving apparatus 60 is for moving the guide 20 in a direction opposite 25 to the moving direction 35 of the punch. This guide driving apparatus 60 is connected to the guide 20.

Next, an upsetting method using the aforementioned upsetting apparatus 1C of the third embodiment will be explained below.

Initially, as shown in FIG. 12, the processing scheduled portion 2 and the non-processing scheduled portion 3 of the raw material 1 are inserted in the restraining hole 11 of the restraining die 10. With this, the external peripheral surfaces of the processing scheduled portion 2 and the non-processing scheduled portion 3 of the raw material 1 are restrained by the peripheral surface of the restraining hole 11.

Subsequently, in a state in which the core bar 40 is connected to the guide 20 via the fluid pressure cylinder 51, the core bar main body 41 is inserted into the hollow portion 3a of the non-processing scheduled portion 3 of the raw material 1, and the small diameter portion 42 of the core bar 41 is inserted into the hollow portion 2a of the processing scheduled portion 2 of the raw material 1 [Setting work of the core bar 40]. Through this operation, the guide 20 is placed at the hollow portion 2a of the processing scheduled portion 2 of the raw material 1 [Setting work of the guide 20]. In this state, the internal peripheral surface of the processing scheduled portion 2 of the raw material 1 is restrained by the peripheral surface of the guide 20.

Furthermore, the guide 20 is inserted into the hollow portion 31 of the punch 30, and this punch 30 is placed at the initial position at the axial end portion side of the raw material 1.

Furthermore, an initial clearance X is set between the tip end portion 20a of the guide 20 and the bottom portion 12a of the molding dented portion 12. In the state before initiating the movement of the punch 30, the distance of this initial clearance X is set to be not larger than the buckling limit length X₀ at the cross-sectional area of the exposed portion of the processing scheduled portion 2 of the raw material 1 exposed between the tip end portion 20a of the guide 20 and the bottom portion 12a of the molding dented portion 12.

Subsequently, as shown in FIG. 13, while axially pressurizing the processing scheduled portion 2 of the raw material 1 with the punch 30 by moving the punch by operating the punch driving apparatus 70, the guide 20 is moved in a direction 25 opposite to the moving direction 35 of the punch 30 by operating the guide driving apparatus 60. With this, the processing scheduled portion 2 of the raw material 1 exposed between the tip end portion 20a of the guide 20 and the bottom portion 12a of the molding dented portion 12 is inwardly expanded so that the wall thickness increases within the molding dented portion 12. Furthermore, the rod 51a of the fluid pressure cylinder 51 is extended in accordance with the movement of the punch 30 to prevent the axial displacement of the core bar 41.

Here, it is preferable to set a time lag to between the moving initiation of the punch 30 and the moving initiation of the guide 20. That is, in the case of initiating the pressurization of the processing scheduled portion 2 of the raw material 1 with the punch 30, the position of the guide 20 is fixed to the initial position, and then the processing scheduled portion 2 of the raw material 1 is axially pressurized with the punch 30 by moving the punch 30. After the lapse of the time lag to, while continuously pressurizing the processing scheduled portion 2 of the raw material 1 with the punch 30, the guide 20 is moved in a direction 25 opposite to the moving direction 35 of the punch 30.

With the movement of the punch 30 and the guide 20, the processing scheduled portion 2 of the raw material 1 is gradually inwardly expanded so that the wall thickness increases within the molding dented portion 12, and the material of the processing scheduled portion 2 is gradually filled in the molding dented portion 12 under pressure.

As shown in FIG. 14, when the tip end portion of the punch 30 has reached the stop position X_{P} with respect to the bottom portion 12a of the molding dented portion 12 obtained from the design volume of the expanded portion 4, the movement of the punch 30 is terminated. When the tip end portion 20a of the guide 20 has reached the stop position X_{g} with respect to the bottom portion 12a of the molding dented portion 12 defined by the tip end portion 20a of the guide 20, the movement of the guide 20 is terminated. At this time, the material of the processing scheduled portion 2 of the raw material 1 has been completely filled in the molding dented portion 12, and the processing scheduled portion 2 has been expanded into the designed shape.

Through the aforementioned procedures, the wall thickening processing for the processing scheduled portion 2 of the raw material 1 is completed.

Subsequently, the fluid pressure cylinder 51 and the core bar 40 are separated, and the bottom portion 15 of the restraining die 10 is removed. Then, the core bar 40 is pulled out of the hollow portion 3a of the non-processing scheduled portion 3 of the raw material 1, and the guide 20 and the punch 30 are also removed.

In the third embodiment, the stop position X_{P} of the tip end portion of the punch 30 with respect to the bottom portion 12a of the molding dented portion 12 and the stop position X_{g} of the tip end portion 20a of the guide 20 with respect to the bottom portion 12a of the molding dented portion 12 coincide with each other. However, in the present invention, it is not always required that X_{P} and X_{g} coincide with each other.

It is preferable that the average moving speed G of the guide 20 from the moving initiation satisfies the aforementioned equation (i).

Thus, in the aforementioned upsetting method of the third embodiment, at the time of pressurizing the processing scheduled portion 2 of the raw material 1 with the punch 30, the internal peripheral surface of the non-processing scheduled portion 3 of the raw material 1 is restrained by the peripheral surface of the core bar main body 41, and the external peripheral surfaces of the processing scheduled portion 2 and the non-processing scheduled portion 3 are restrained by the peripheral surface of the restraining hole 11 of the restraining die 10. Therefore, inward and outward buckling of the non-processing scheduled portion 3 of the raw material 1 is prevented, and the outward buckling of the processing scheduled portion 2 is prevented. Furthermore, the guide 20 is placed in the hollow portion 2a of the processing scheduled portion 2 of the raw material 1, and therefore the internal peripheral surface of the processing scheduled portion 2 is restrained by the peripheral surface of the guide 20. With this, the inward buckling of the processing scheduled portion 2 is prevented. In this state, by moving the guide 20 in a direction 25 opposite to the moving direction 35 of the punch 30 while axially pressurizing the processing scheduled portion 2 of the raw material 1 with the punch 30, the processing scheduled portion 2 of the raw material 1 exposed between the tip end portion 20a of the guide 20 and the bottom portion 12a of the molding dented portion 12 is expanded assuredly and favorably so that the wall thickness increases within the molding dented portion 12. Consequently, a high quality cylindrical upsetting manufactured product 6C can be obtained.

Furthermore, since the guide 20 is moved by the driving force of the guide driving apparatus 60, the guide 20 can be moved assuredly.

Furthermore, since the tip end portion of punch 30 is formed into the cross-sectional shape corresponding to the cross-sectional shape of the axial end portion of the raw material 1, the processing scheduled portion 2 of the raw material 1 can be assuredly pressurized with the punch 30.

Furthermore, since the core bar 40 is connected to the guide 20 so as to extend in the axial direction of the guide 20, the setting work of the core bar 40 for placing the core bar main body 41 into the hollow portion 3a of the non-processing scheduled portion 3 of the raw material 1 and placing the small diameter portion 42 into the hollow portion 2a of the processing scheduled portion 2 and the setting work of the guide 20 for placing the guide 20 into the hollow portion 2a of the processing scheduled portion 2 of the raw material 1 can be performed simultaneously, which makes it possible to improve the operation efficiency of the upsetting.

Furthermore, since the fluid pressure cylinder 51 is extended with the movement of the guide 20, the problem that the position of the core bar 40 shifts in accordance with the movement of the guide 20 or the expansion of the processing scheduled portion 2 of the raw material 1 can be prevented assuredly.

Furthermore, since the fluid pressure cylinder 51 is used as the extensible device 50, such defect can be prevented assuredly.

Furthermore, since the chamfering work (the chamfered portion 21a) is given to the peripheral edge portion of the tip end portion 20a of the guide 20, the backpressure of the material of the processing scheduled portion 2 of the raw material 1 effectively acts on the tip end portion 20a of the guide 20 at the time of the processing. Consequently, the driving force of the guide driving apparatus 60 for moving the guide 20 can be decreased, which makes it possible to miniaturize the guide driving apparatus 60.

Here, in the third embodiment, although the guide 20 is moved by the driving force of the guide driving apparatus 60 at the time of the upsetting, the present invention does not necessarily require that the guide 20 is moved by such driving force. That is, in the present invention, the guide 20 can be moved by the pressing-back force acting on the guide 20 caused by pressing the material of the processing scheduled portion 2 of the raw material 1 into the molding dented portion 12. In this case, the guide 20 can be moved without using the guide driving apparatus 60, resulting in a simplified upsetting apparatus 1C.

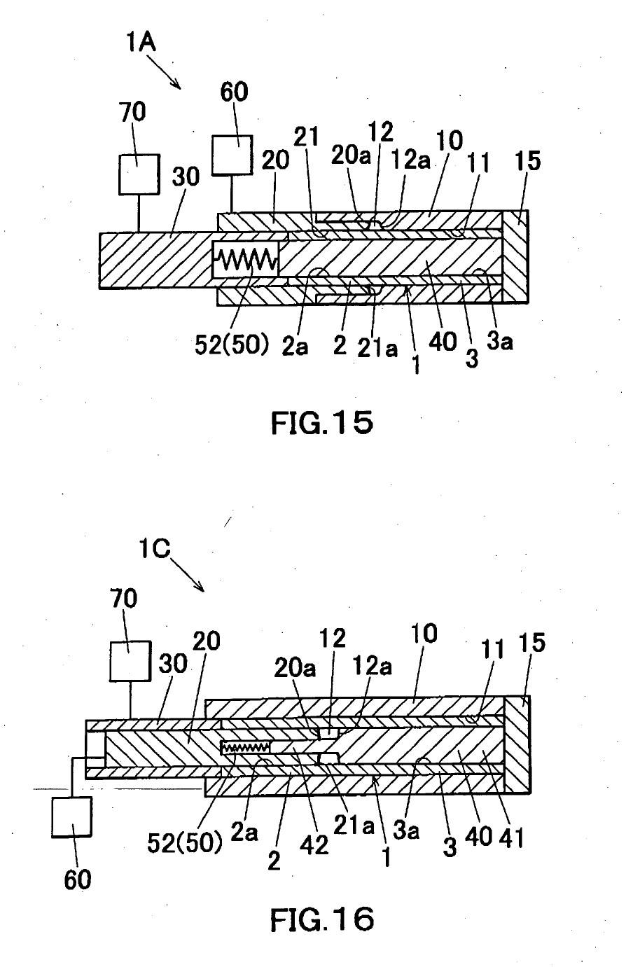

FIG. 15 is a schematic view showing a modified embodiment of the upsetting apparatus 1A of the first embodiment.

In this modification, a compression spring 52 is used as the extensible device 50. This spring 52 is configured to be compressed with the movement of the punch 30 at the time of the processing.

This spring 52 can also be applied to each extensible device 50 in the upsetting apparatus 1B of the second embodiment.

FIG. 16 is a schematic view showing another modification of the upsetting apparatus 1C of the third embodiment.

In this modification, a coil spring 52 is used as the extensible device 50. This spring 52 is configured to extend with the movement of the guide 20 at the time of the processing.

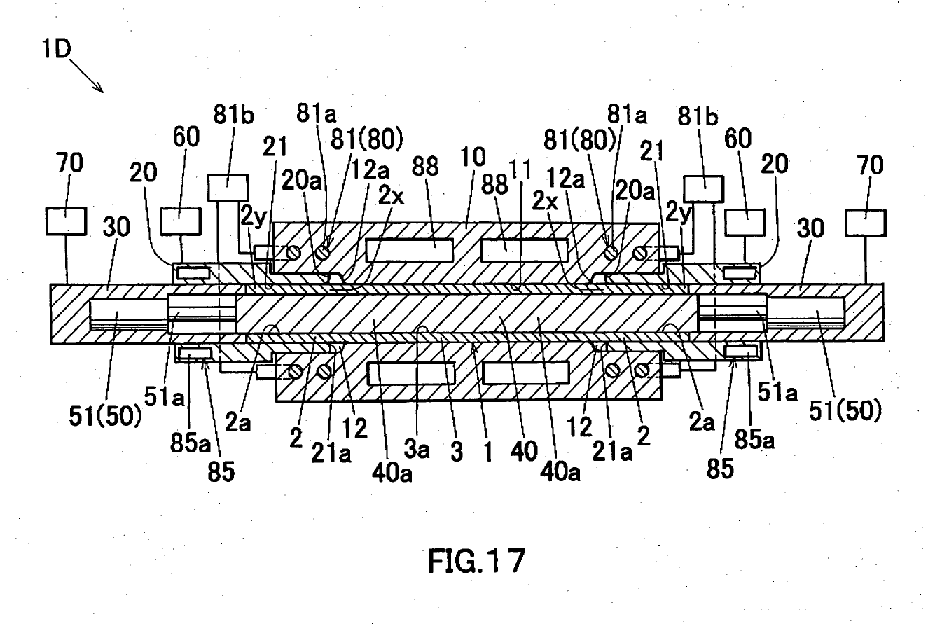

FIGS. 17 to 19 are schematic views for explaining an upsetting method using an upsetting apparatus for a cylindrical raw material according to the fourth embodiment of the present invention.

In FIG. 17, “1D” denotes an upsetting apparatus for a cylindrical raw material according to the fourth embodiment. In FIGS. 17 to 19, the same mark is allotted to the same component as the structural element of the upsetting apparatus 1B of the second embodiment shown in FIGS. 7 to 10. Hereinafter, the structure of the upsetting apparatus 1D of the fourth embodiment will be explained focusing on the difference with the structure of the upsetting apparatus 1B of the second embodiment.

The cylindrical upsetting manufactured product manufactured by the upsetting apparatus 1D of the fourth embodiment is the same as the cylindrical upsetting manufactured product 6B shown in FIG. 11.

As shown in FIG. 17, this upsetting apparatus 1D is further equipped with two heating means 80 and 80 and two cooling means 85 and 85 in addition to all of the structures of the upsetting apparatus 1B of the second embodiment shown in FIG. 17.

Two heating means 80 and 80 are the same in structure. Each heating means 80 partially heats the portion 2x corresponding to the tip end portion 20a of the guide 20 in each processing scheduled portion 2 of the raw material 1. The heating means 80 is an induction heating means 81 having an induction heating coil 81a and a power supply portion 81b for supplying AC current (or AC voltage) to the coil 81a.

The surface of the induction heating coil 81a is covered with an insulating layer (not shown) consisting of, e.g., an insulating tape. Furthermore, the coil 81a is embedded in the axial both end portions of the restraining die 10 in such a manner that it surrounds the corresponding molding dented portion 12.

The restraining die 10 is made of hard conductive material (e.g., heat resistant metal material) having heat resistance, such as, e.g., steel material.

With this induction heating means 81, when a current (voltage) of a prescribed frequency (e.g., high frequency or low frequency) is supplied to the coil 81a by the power supply portion 81b, the axial end portion of the restraining die 10 is partially induction-heated by the coil 81a of the induction heating means 81. With this, the portion 2x of the processing scheduled portion 2 of the raw material 1 corresponding to the tip end portion 20a of the guide 20 is partially heated by the heat of the axial end portion of the restraining die 10. That is, it is configured such that the heat of the axial end portion of the restraining die 10 is conducted to the portion 2x of the raw material 1 to thereby partially heat the portion 2x. Furthermore, this induction heating means 81 is configured such that the portion 2x can be partially heated into a half-molten state by increasing the current supplying amount or the like to the coil 81a to thereby raise the heating temperature of the portion 2x of the raw material 1.

Two cooling means 85 and 85 are the same in structure. Each cooling means 85 partially cools the portion 2y of each processing scheduled portion 2 of the raw material 1 corresponding to the basal end side portion of the guide rather than the tip end portion 20a of the guide 20. This cooling means 85 has a cooling fluid passage 85a. This cooling fluid passage 85a is formed in the basal end portion of the guide 20 as the basal end side portion rather than the tip end portion 20a of the guide 20. This cooling means 85 is configured to partially cool the portion 2y of the raw material 1 by circulating cooling fluid, such as, e.g., cooling water, in this cooling fluid passage 85a.

In addition, “88” and “88” denote two cooling fluid passages formed in the axial intermediate portion of the restraining die 10. Each cooling fluid passage 88 controls the conduction of the heat generated by the coil 81a of the induction heating means 81 to the other portions of the restraining-die 10 by circulating the cooling fluid therein.

The other structure of the upsetting apparatus 1D of this fourth embodiment is the same as the structure of the upsetting apparatus 1B of the second embodiment.

Next, the upsetting method using the upsetting apparatus 1D of the fourth embodiment will be explained below.

First, as shown in FIG. 17, the non-processing scheduled portion 3 of the raw material 1 is inserted in the restraining hole 11 of the restraining die 10. With this, each processing scheduled portion 2 of the raw material 1 is placed in the corresponding molding dented portion 12 of the restraining die 10. In this state, the external peripheral surface of the non-processing scheduled portion 3 of the raw material 1 is restrained by the peripheral surface of the restraining hole 11.

Next, the setting work of the core bar 40 and the setting work of the punch 30, which were explained in the second embodiment, are performed. With this, the internal peripheral surfaces of both the processing scheduled portions 2 and 2 and the non-processing scheduled portion 3 of the raw material 1 are restrained by the peripheral surface of the core bar 40 (in detail, both the core bar halves 40a and 40a).

Furthermore, each processing scheduled portion 2 of the raw material 1 is inserted in the corresponding insertion hole 21 of each guide 20. With this, the external peripheral surface of each processing scheduled portion 2 of the raw material 1 is restrained by the peripheral surface of the insertion hole 21.

Furthermore, depending on the needs, it is preferable to form an initial clearance X (see FIG. 8) between the tip end portion 20a of each guide 20 and the bottom portion 12a of the corresponding molding dented portion 12.

Furthermore, the axial both end portions of the restraining die 10 are partially induction-heated by the coil 81a of each induction heating means 81 by supplying a current of a prescribed frequency to the coil 81a of each induction heating means 81 by the power-supply portion 81b. With this, the portion 2x of each processing scheduled portion 2 of the raw material 1 corresponding to the tip end portion 20a of the guide 20 is partially heated by the heat of the axial end portion of the restraining die 10. Consequently, the deformation resistance in the portion 2x of the raw material 1 decreases partially.

This heating temperature is not specifically limited, and can be a temperature which causes deterioration of the deformation resistance of the portion 2x of the raw material 1. Concrete examples of the preferable heating temperature are as follows.

For example, in cases where the raw material 1 is made of aluminum or aluminum alloy, 200 to 580° C. (especially preferably 350 to 540° C.) can be exemplified as a preferable heating temperature range. Furthermore, in cases where the portion 2x of the raw material 1 is heated into a half-molten state, 580 to 625° C. (especially preferably 600 to 615° C.) can be exemplified as a preferable heating temperature range. However, in the present invention, the heating temperature is not limited to the aforementioned range.

Furthermore, the portion 2y of each processing scheduled portion 2 of the raw material 1 corresponding to the basal end side portion of the guide 20 rather than the tip end portion of the guide is partially cooled by circulating cooling fluid, such as, e.g., cooling water of a normal temperature, in the cooling fluid passage 85a of each cooling means 85. With this, the deterioration of the deformation resistance of the portion 2y of the raw material 1 can be controlled.

As the preferable cooling temperature in this case, 30 to 80° C. (especially preferably 40 to 60° C.) can be exemplified. In the present invention, however, the cooling temperature is not limited to the aforementioned range.

Moreover, cooling fluid of a normal temperature is circulated in each cooling fluid passage 88 formed in the restricted die 10. With this, the conduction of the heat generated by the coil 81a of each induction heating means 81 to other portions of the restraining die 10 can be controlled.

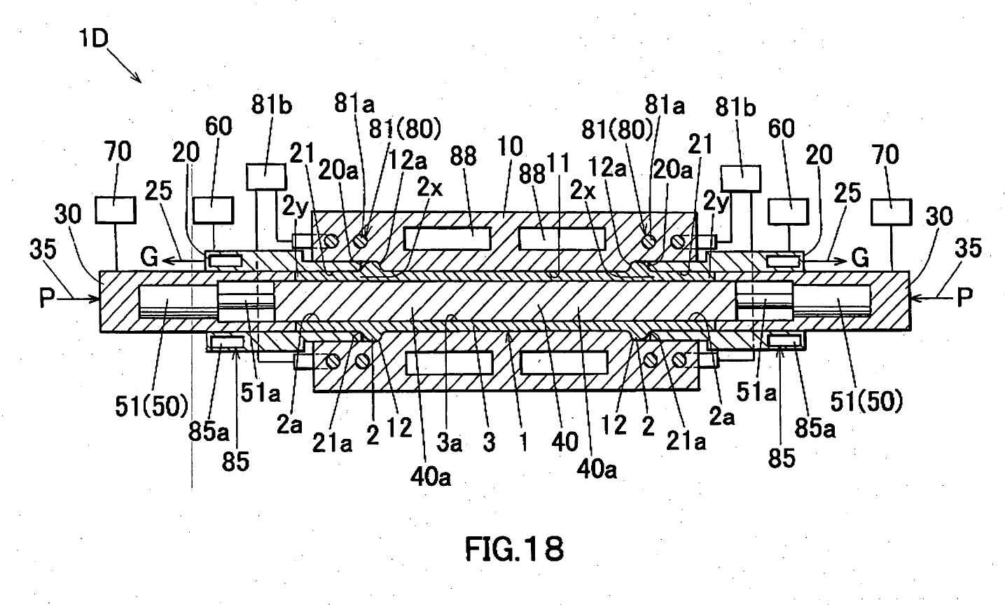

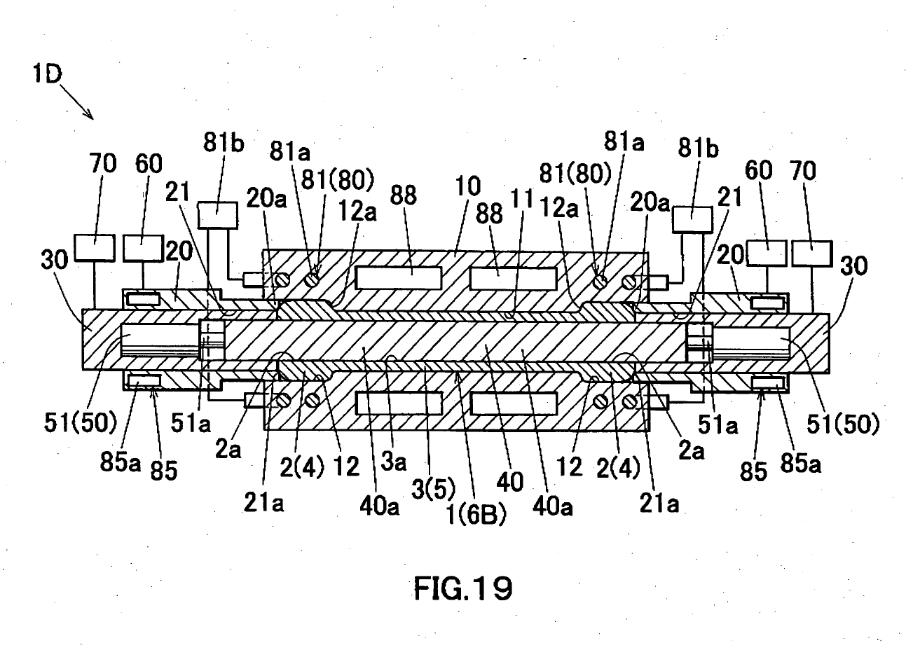

Next, while maintaining such a state, as shown in FIGS. 18 and 19, in the same procedures as in the upsetting method shown in the second embodiment, both the processing scheduled portions 2 and 2 of the raw material 1 are simultaneously expanded outward in the molding dented portion 12 and 12 so that the wall thickness increases.

After expanding both the processing scheduled portions 2 and 2 of the raw material 1 into a designed shape, the pulling out work of the core bar 40 and the removal work of punch 30, which were explained in the second embodiment, are performed. Thereafter, by removing the raw material 1 from the restraining hole 11 of the restraining die 10, the cylindrical upsetting manufactured product 6B shown in FIG. 11 is obtained.

In this upsetting method, it is preferable that the average moving speed G of each guide 20 from the moving initiation thereof satisfies the aforementioned equation (i).

Thus, in the upsetting method of the fourth embodiment, there are the following advantages in addition to the same advantages as those of the upsetting method of the second embodiment.

That is, since each processing scheduled portion 2 of the raw material 1 is expanded with the portion 2x of each processing scheduled portion 2 of the raw material 1 corresponding to the tip end portion 20a of the guide 20 partially heated, the portion 2x of each processing scheduled portion 2 of the raw material 1 partially deteriorates in deformation resistance. As a result, the molding pressure can be reduced. On the other hand, as to the portion 2y of each processing scheduled portion 2 of the raw material 1 corresponding to the basal end side portion of the guide 20 rather than the tip end portion 20a of the guide 20, since it is not heated, the portion does not deteriorate in deformation resistance. Therefore, the increase in the molding pressure produced when each end portion of the raw material 1 is crushed in the insertion hole 21 of the guide 20 by the pressure from the punch 30 can be prevented.

Furthermore, since the portion 2x of each processing scheduled portion 2 of the raw material 1 corresponding to the tip end portion 20a of the guide 20 is partially heated with the heat of the axial end portion of restraining die 10 by partially induction-heating the axial both end portions of the restraining die 10 with the induction heating means 81, the portion 2x of the raw material 1 can be heated assuredly and efficiently.

And, in the fourth embodiment, the portion 2x of the raw material 1 can be heated into a half-molten state partially by raising the heating temperature. In this case, the molding pressure can be reduced substantially. The upsetting in this case is classified under the category of Thixomolding.

Furthermore, each processing scheduled portion 2 of the raw material 1 is expanded in a state in which the portion 2y of each processing scheduled portion 2 of the raw material 1 corresponding to the basal end side portion of the guide 20 rather than the tip end portion 20a of guide 20 is partially cooled by the cooling means 85. Therefore, the heating of the portion 2y of the raw material 1 can be prevented assuredly, which in turn can assuredly prevent the deterioration of the deformation resistance of the portion 2y of the raw material 1.

Therefore, according to the upsetting method of the fourth embodiment, a high quality cylindrical upsetting manufactured product 6B having an expanded portion 4 outwardly expanded with the increased wall thickness at each of the axial both end portions can be manufactured.

In the fourth embodiment, the portion 2x of each processing scheduled portion 2 of the raw material 1 corresponding to the tip end portion 20a of the guide 20 is partially heated with the heat of the axial end portion of the restraining die 10 by partially induction heating both the axial end portions of the restraining die 10 by the induction heating means 81. In the present invention, however, the portion 2x of the raw material 1 can be partially induction-heated by the induction heating means 81. In this case, the portion 2x of the raw material 1 can be heated assuredly and very efficiently. Furthermore, in this case, the restraining die 10 can be made of hard conductive material (e.g., heat resistant metal material) having heat resistance, such as, e.g., steel material, and also can be hard non-conductive material having heat resistance, such as, e.g., ceramics.

Furthermore, in the fourth embodiment, the number of the processing scheduled portion 2 of the raw material 1 is two. In the present invention, however, the number of the processing scheduled portion 2 can be one.

Here, in the fourth embodiment, each guide 20 is moved by the driving force of the guide driving apparatus 60 at the time of the upsetting. In the present invention, however, it is not necessarily required that each guide 20 is moved by such driving force. That is, in the present invention, each guide 20 can be moved by the pressing-back force acting on the guide 20 caused by the pressing of the molding dented portion 12 of the material of each processing scheduled portion 2 of the raw material 1. In this case, each guide 20 can be moved without using each guide driving apparatus 60, resulting in simplification of the upsetting apparatus 1D.

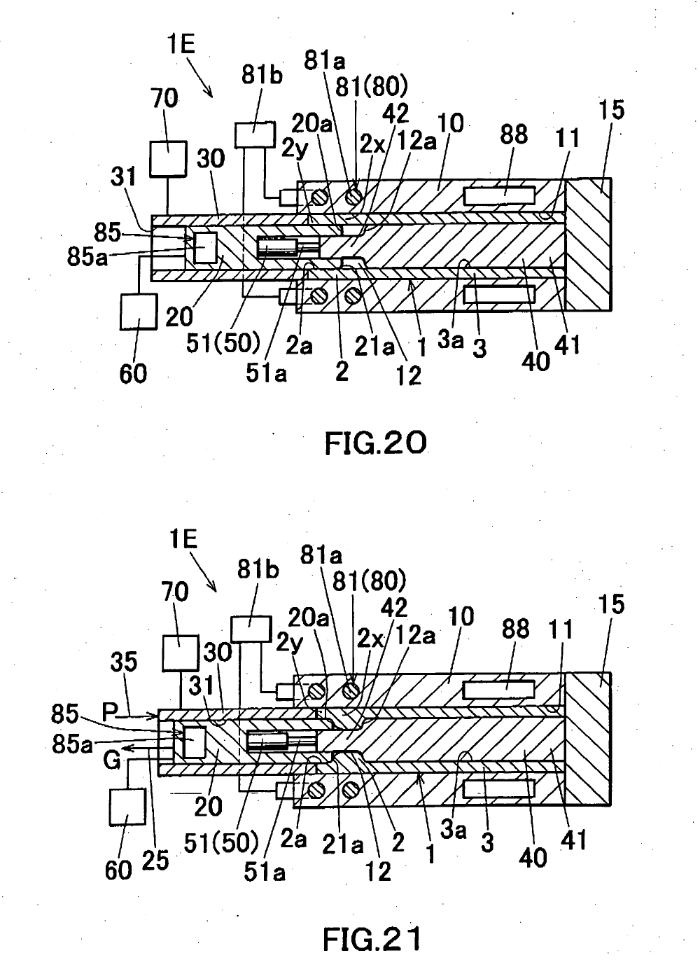

FIGS. 20 to 22 are schematic views for explaining an upsetting method using an upsetting apparatus for a cylindrical raw material according to the fifth embodiment of the present invention.

In FIG. 20, “1E” denotes an upsetting apparatus for a cylindrical raw material according to the fifth embodiment. In FIGS. 20 to 22, the same reference mark is allotted to the same component as the structure element of the upsetting apparatus 1C of the third embodiment shown in FIGS. 12 to 14. Hereinafter, the structure of the upsetting apparatus 1E of the fifth embodiment will be explained focusing on the difference with the structure of the upsetting apparatus 1C of the third embodiment and the upsetting apparatus 1D of the fourth embodiment.

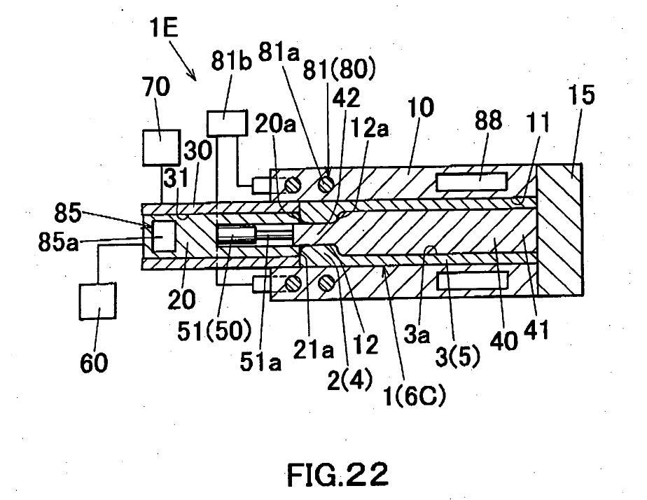

The cylindrical upsetting manufactured product manufactured by the upsetting apparatus 1E of the fifth embodiment has, as shown in FIG. 22, an expanded portion 4 inwardly expanded so that the wall thickness increases at the axial one end portion, i.e., it is the same as the cylindrical upsetting manufactured product 6C manufactured by the upsetting apparatus 1C of the third embodiment.

As shown in FIG. 20, this upsetting apparatus 1E is equipped with a heating means 80 and a cooling means 85 in addition to all of the structures of the upsetting apparatus 1C of the third embodiment.

The heating means 80 partially heats the portion 2x of the processing scheduled portion 2 of the raw material 1 corresponding to the tip end portion 20a of the guide 20. The heating means 80 is an induction heating means 81 having an induction heating coil 81a and a power-supply portion 81b for supplying AC current (or AC voltage) to the coil 81a.

The surface of the induction heating coil 81a is covered by an insulating layer (not shown) consisting of an insulating tape, etc. Furthermore, this coil 81a is embedded in the axial one end portion of the restraining die 10 so as to surround the molding dented portion 12.

The restraining die 10 is made of hard conductive material (e.g., heat resistant metal material) having heat resistance, such as, e.g., steel material, or hard non-conductive material having heat resistance, such as ceramics.

With this induction heating means 81, when a current (voltage) of a prescribed frequency (e.g., high frequency or low frequency) is supplied to the coil 81a by the power supply portion 81b, the portion 2x of the processing scheduled portion 2 of the raw material 1 corresponding to the tip end portion 20a of the guide 20 is partially heated by the coil 81a of the induction heating means 81. Furthermore, this induction heating means 81 is configured such that the portion 2x of the raw material 1 can be partially heated into a half-molten state by increasing the current supplying amount or the like to the coil 81a to thereby raise the heating temperature of the portion 2x of the raw material 1.

The cooling mean 85 partially cools the portion 2y of each processing scheduled portion 2 of the raw material 1 corresponding to the basal end side portion of the guide rather than the tip end portion 20a of the guide 20. This cooling means 85 has a cooling fluid passage 85a formed in the basal end portion of the guide 20. This cooling means 85 is configured to partially cool the portion 2y of the raw material 1 by circulating cooling fluid, such as, e.g., cooling water, in this cooling fluid passage 85a.

“88” denotes a cooling fluid passage formed in the restraining die 10. The cooling fluid passage 88 controls the conduction of the heat generated by the coil 81a of the induction heating mean 81 to the other portions of the restraining die 10 by circulating the cooling fluid therein.

The other structure of the upsetting apparatus 1E of this fifth embodiment is the same as the structure of the upsetting apparatus 1C of the third embodiment.

Next, the upsetting method using the upsetting apparatus 1E of the fifth embodiment will be explained below.

First, as shown in FIG. 20, the processing scheduled portion 2 and the non-processing scheduled portion 3 of the raw material 1 are inserted in the restraining hole 11 of the restraining die 10. With this, the external peripheral surfaces of the processing scheduled portion 2 and the non-processing scheduled portion 3 of the raw material 1 are restrained by the peripheral surface of the restraining hole 11 in a buckling preventing state.

Next, in the state in which the core bar 40 is connected to the guide 20 via the fluid pressure cylinder 51, the core bar main body 41 is inserted in the hollow portion 3a of the non-processing scheduled portion 3 of the raw material 1, and the small diameter portion 42 of the core bar 40 is inserted in the hollow portion 2a of the processing scheduled portion 2 [Setting work of the core bar 40]. With this operation, at least the tip end portion 20a of the guide 20 is placed in the hollow portion 2a of the processing scheduled portion 2 of the raw material 1 [Setting work of the guide 20]. In this state, the internal peripheral surface of the processing scheduled portion 2 of the raw material 1 is restrained by the peripheral surface of guide 20 in a buckling preventing state.

Furthermore, depending on the needs, it is preferable to set an initial clearance X (see FIG. 12) between the tip end portion 20a of each guide 20 and the bottom portion 12a of the corresponding molding dented portion 12.

Furthermore, the portion 2x of the processing scheduled portion 2 of the raw material 1 is partially induction-heated by the coil 81a of the induction heating means 81 by supplying a current of a prescribed frequency to the coil 81a of the induction heating means 81 by the power-supply portion 81b. With this, the portion 2x of the processing scheduled portion 2 of the raw material 1 is partially decreased in deformation resistance.

The preferable heating temperature range in this case is the same as the preferable heating temperature range in the fourth embodiment.

Furthermore, the portion 2y of the processing scheduled portion 2 of the raw material 1 corresponding to the basal end side portion of the guide 20 rather than the tip end portion of the guide 20 is partially cooled by circulating cooling fluid, such as, e.g., cooling water of a normal temperature, in the cooling fluid passage 85a of each cooling means 85. With this, the deterioration of the deformation resistance of the portion 2y of the raw material 1 can be controlled.

The preferable cooling temperature range in this case is the same as the preferable cooling temperature range in the fourth embodiment.

Moreover, cooling fluid of a normal temperature is circulated in the cooling fluid passage 88 formed in the restricted die 10. With this, the conduction of the heat generated by the coil 81a of the induction heating means 81 to other portions of the restraining die 10 can be controlled.

Next, while maintaining such a state, as shown in FIGS. 21 and 22, in the same procedures as in the upsetting method shown in the third embodiment, the processing scheduled portion 2 of the raw material 1 is expanded inward in the molding dented portion 12 and 12 so that the wall thickness increases.

After expanding the processing scheduled portion 2 of the raw material 1 into a designed shape, the fluid pressure cylinder 51 and the core bar 40 are detached, and the bottom portion 15 of the restraining die 10 is removed. Then, the core bar 40 is pulled out of the hollow portion 3a of the non-processing scheduled portion 3 of the raw material 1, and the guide 20 and the punch 30 are also removed. With this, a desired cylindrical upsetting manufactured product 6C is obtained.

In this upsetting method, it is preferable that the average moving speed G of each guide 20 from the moving initiation thereof satisfies the aforementioned equation (i).

Thus, in the upsetting method of the fifth embodiment, there are the following advantages in addition to the same advantages as those of the upsetting method of the third embodiment.

That is, since the processing scheduled portion 2 of the raw material 1 is expanded with the portion 2x of the processing scheduled portion 2 of the raw material 1 corresponding to the tip end portion 20a of the guide 20 partially heated, only the portion 2x of the processing scheduled portion 2 of the raw material 1 partially deteriorates in deformation resistance. As a result, the molding pressure can be reduced. On the other hand, as to the portion 2y of the processing scheduled portion 2 of the raw material 1 corresponding to the basal end side portion of the guide 20 rather than the tip end portion 20a of the guide 20, since it is not heated, the portion does not deteriorate in deformation resistance. Therefore, the increase in the molding pressure produced when the end portion of the raw material 1 is crushed in the insertion hole 21 of the guide 20 by the pressure from the punch 30 can be prevented.

Furthermore, since the portion 2x of the processing scheduled portion 2 of the raw material 1 corresponding to the tip end portion 20a of the guide 20 is partially heated with the induction heating means 81, the portion 2x of the raw material 1 can be heated assuredly and efficiently.

And, in the fifth embodiment, the portion 2x of the raw material 1 can be heated into a half-molten state partially by raising the heating temperature. In this case, the molding pressure can be reduced substantially. The upsetting in this case is classified under the category of Thixomolding.

Furthermore, the processing scheduled portion 2 of the raw material 1 is expanded in a state in which the portion 2y of the processing scheduled portion 2 of the raw material 1 corresponding to the basal end side portion of the guide 20 rather than the tip end portion 20a of guide 20 is partially cooled by the cooling means 85. Therefore, the heating of the portion 2y of the raw material 1 can be prevented assuredly, which in turn can assuredly prevent the deterioration of the deformation resistance of the portion 2y of the raw material 1.

Therefore, according to the upsetting method of the fifth embodiment, as shown in FIG. 22, a high quality cylindrical upsetting manufactured product 6C in which an expanded portion 4 is formed at the axial end portion so that the wall thickness increases can be manufactured.

In the fifth embodiment, the portion 2x of the processing scheduled portion 2 of the raw material 1 corresponding to the tip end portion 20a of the guide 20 is partially heated with the induction heating means 81. In the present invention, however, the axial one end portion of the restraining die 10 can be partially induction-heated by the induction heating means 81, to thereby partially heat the portion 2x of the raw material 1 with the heat of the axial one end portion of the restraining die 10. In this case, the portion 2x of the raw material 1 can be heated assuredly and efficiently. Furthermore, in this case, it is preferable that the restraining die 10 is made of hard conductive material (e.g., heat resistant metal material) such as, e.g., steel material.

Here, in the fifth embodiment, the guide 20 is moved by the driving force of the guide driving apparatus 60 at the time of the upsetting. In the present invention, however, it is not necessarily required that the guide 20 is moved by such driving force. That is, in the present invention, the guide 20 can be moved by the pressing-back force acting on the guide 20 caused by the pressing of the molding dented portion 12 of the material of the processing scheduled portion 2 of the raw material 1. In this case, the guide 20 can be moved without using the guide driving apparatus 60, resulting in simplification of the upsetting apparatus 1E.

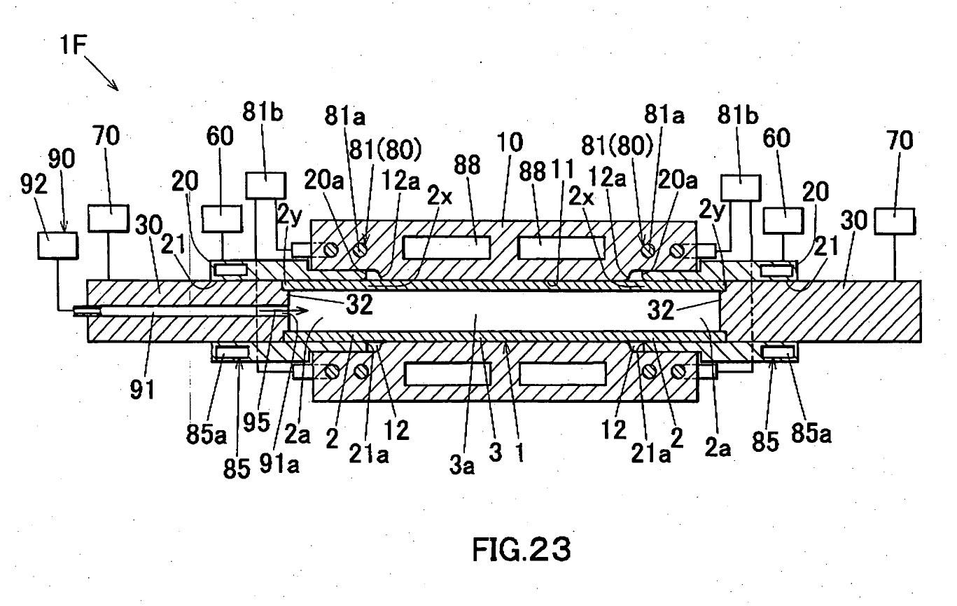

FIGS. 23 to 25 are schematic views for explaining an upsetting method using an upsetting apparatus for a cylindrical raw material according to the sixth embodiment of the present invention.

In FIG. 23, “1F” denotes an upsetting apparatus for a cylindrical raw material according to the sixth embodiment. In FIGS. 23 to 25, the same mark is allotted to the same component as that of the structure element of the upsetting apparatus 1B of the second embodiment shown in FIGS. 7 to 10. Hereafter, the structure of upsetting apparatus 1F of this sixth embodiment will be explained focusing on the difference with the structure of the upsetting apparatus 1B of the second embodiment and that of the upsetting apparatus 1D of the fourth embodiment.

The cylindrical upsetting manufactured product manufactured by the upsetting apparatus 1F of the sixth embodiment is the same as the cylindrical upsetting manufactured product 6B shown in FIG. 11.

Unlike the upsetting apparatus 1D of the fourth embodiment, this upsetting apparatus 1F is not equipped with the core bar and the extensible device as shown in FIG. 23. This upsetting apparatus 1F is equipped with two heating means 80 and 80, two cooling means 85 and 85, and a pressure fluid filling means 90.

The two heating means 80 and 80 are the same in structure. Each heating means 80 is the same in structure as the heating means 80 of the upsetting apparatus 1D of the fourth embodiment, i.e., each heating means 80 is an induction heating means 81 having an induction heating coil 81a and a power-supply portion 81b.

The two cooling means 85 and 85 are the same in structure. Each cooling means 85 is the same in structure as the cooling means 85 of the upsetting apparatus 1D of the fourth embodiment, i.e., each cooling means 85 has a cooling fluid passage 85a.

The pressure fluid filling means 90 fills pressure fluid (pressure medium) 95 in the hollow portions 3a, 2a and 2a of the non-processing scheduled portion 3 located at the axial intermediate portion of the cylindrical raw material 1 and the processing scheduled portion 2 and 2 located at the axial both end portions, to thereby restrain the internal peripheral surfaces of the non-processing scheduled portion 3 of the raw material 1 and both the processing scheduled portions 2 and 2 by the fluid pressure (i.e., pressure of the pressure fluid) in a buckling preventing state.

This pressure fluid filling means 90 has a pressure fluid supplying passage 91 formed in one of the punches 30 and 30 in an axially penetrated manner, and a pressure fluid supplying portion 92 for supplying the pressure fluid 95 into the hollow portion 3a, 2a and 2a of the raw material 1 through the supplying passage 91. The supplying port 9a of the pressure fluid supplying passage 92 is provided at the tip end face of the punch 30 in communication with the hollow portion 2a. The pressure fluid supplying portion 92 has a pressure tank (not shown) in which the pressure fluid is filled as a pressure fluid supplying source.

Gas, such as, e.g., argon or air, is used as the pressure fluid 95. In the present invention, however, the pressure fluid 95 is not limited to gas, and can be liquid, such as, e.g., water or oil.

At the tip end portion of each punch 30, a fitting convex portion 32 to be fitted in the opening portion of the axial end portion of the raw material 1 is formed. This fitting convex portion 32 prevents the deformation of the axial end of the raw material 1 by supporting the axial end portion from its inner side.

Next, the upsetting method using the upsetting apparatus 1F of the sixth embodiment will be explained below.

First, as shown in FIG. 23, the non-processing scheduled portion 3 of the raw material 1 is inserted in the restraining hole 11 of the restraining die 10. With this, each processing scheduled portion 2 of the raw material 1 is placed in the corresponding molding dented portion 12 of the restraining die 10. In this state, the external peripheral surf ace of the non-processing scheduled portion 3 of the raw material 1 is restrained by the peripheral surface of the restraining hole 11.

Next, the corresponding processing scheduled portion 2 of the raw material 1 is inserted in the insertion hole 21 of each guide 20. With this, the external peripheral surface of each processing scheduled portion 2 of the raw material 1 is restrained by the peripheral surface of insertion hole 21 in a buckling preventing state.

Furthermore, the corresponding punch 30 is inserted in the insertion hole 21 of each guide 20. With this, each punch 30 is placed at the initial position located at the axial end portion of the raw material 1, and each fitting convex portion 32 of the tip end portion of each punch 30 is closely fitted in the opening portion of the axial end portion of the raw material 1 to support the end portion in a deformation prevention state by the convex portion 32 from its inner side. Furthermore, the opening portions of both the axial end portions of the raw material 1 are blocked by the fitting of the fitting convex portion 32 as mentioned above.

Next, the pressure fluid 95 is fully filled in the hollow portions 3a, 2a and 2a of the non-processing scheduled portion 3 and both the processing scheduled portion 2 and 2 by the pressure fluid filling means 90 from the pressure fluid supplying portion 92 through the pressure fluid supplying passage 91. At the time of this filling, it is preferable to set a gap between the opening portion of one of the axial end portions of the raw material 1 and the tip end portion of the punch 30 since it becomes easy to fill the pressure fluid 95 in the hollow portion 3a, 2a and 2a of the raw material 1. It is preferable that the filling pressure of the pressure fluid 95 is set so as to fall within the range of 5 to 50 MPa (especially preferably 15 to 30 MPa). In the present invention, however, the range of the filling pressure is not limited to the aforementioned range, and the filling pressure can fall within the range in which the non-processing scheduled portion 3 and both the processing scheduled portion 2 and 2 of the raw material 1 are not buckled inwardly at the time of the processing.

Furthermore, according to need, it is preferable to set an initial clearance X (see FIG. 8) between the tip end portion 20a of each guide 20 and the corresponding bottom portion 12a of the molding dented portion 12.

Furthermore, the axial both end portions of the restraining die 10 is partially induction-heated by the coil 81a of each induction heating means 81 by supplying current of a prescribed frequency to the coil 81a of each induction heating means 81 by the power-supply portion 81b. With this, the portion 2x of each processing scheduled portion 2 of the raw material 1 corresponding to the tip end portion 20a of the guide 20 is partially heated by the heat of the axial end portion of the restraining die 10. Consequently, the deformation resistance of the portion 2x of the raw material 1 deteriorates partially.

The preferable heating temperature range in this case is the same as the preferable heating temperature range in the fourth embodiment.

Furthermore, the portion 2y of the processing scheduled portion 2 of the raw material 1 corresponding to the basal end side portion of the guide 20 rather than the tip end portion of the guide 20 is partially cooled by circulating cooling fluid, such as, e.g., cooling water of a normal temperature, in the cooling fluid passage 85a of each cooling means 85. With this, the deterioration of the deformation resistance of the portion 2y of the raw material 1 can be controlled.

The preferable cooling temperature range in this case is the same as the preferable cooling temperature range in the fourth embodiment.

Moreover, cooling fluid of a normal temperature is circulated in the cooling fluid passage 88 formed in the restricted die 10. With this, the conduction of the heat generated by the coil 81a of the induction heating means 81 to other portions of the restraining die 10 can be controlled.

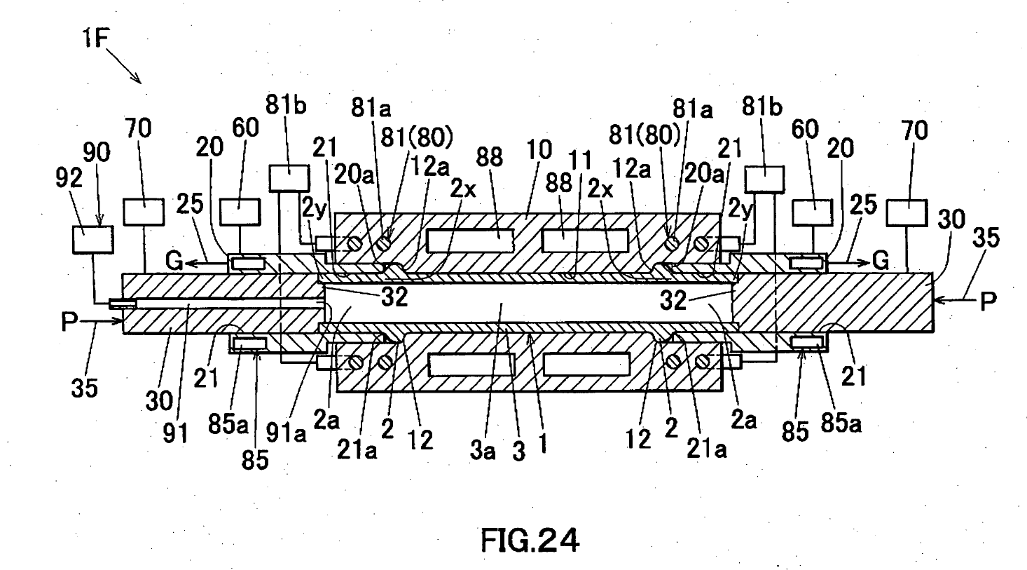

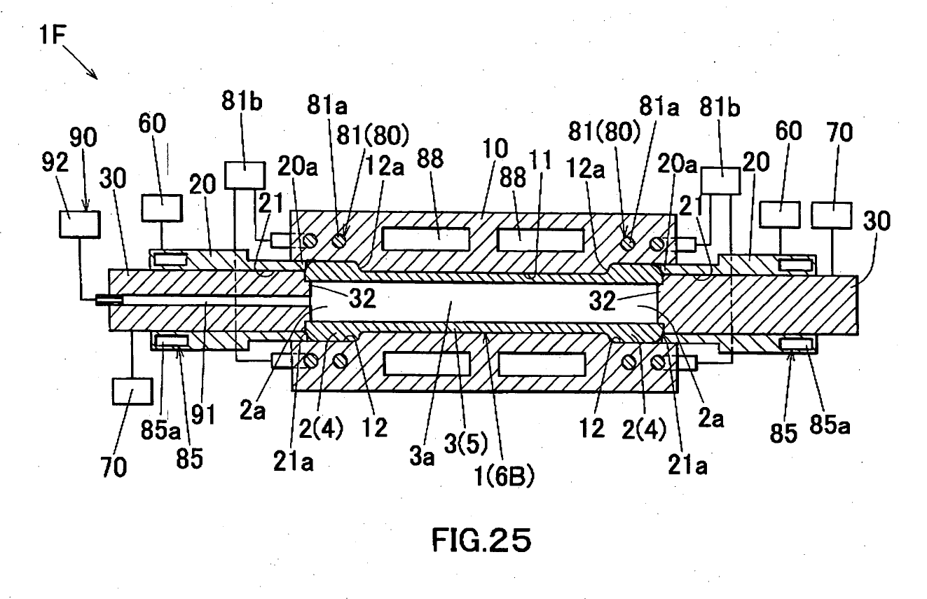

Next, while maintaining such a state, as shown in FIGS. 24 and 25, in the same procedures as in the upsetting method shown in the second embodiment, both the processing scheduled portions 2 of the raw material 1 are simultaneously expanded outward in the molding dented portion 12 and 12 so that the wall thickness increases. When both the processing scheduled portions 2 and 2 of the raw material 1 are being expanded, it is preferable to adjust the fluid pressure so that the fluid pressure in the hollow portion 3a, 2a and 2a of the raw material 1 becomes constant.

After expanding both the processing scheduled portions 2 of the raw material 1 into a designed shape, a desired cylindrical upsetting manufactured product 6B is obtained by removing the raw material 1 from the restraining hole 11 of the restraining die 10.

In this upsetting method, it is preferable that the average moving speed G of each guide 20 from the moving initiation thereof satisfies the aforementioned equation (i).

Thus, in the upsetting method of the sixth embodiment, there are the following advantages.

That is, at the time of pressuring each processing scheduled portion 2 of the raw material 1 with the punch 30, the internal peripheral surfaces of the non-processing scheduled portion 3 and both the processing scheduled portion 2 and 2 are pressurized and retrained by the fluid pressure, and the external peripheral surface of the non-processing scheduled portion 3 is restrained by the peripheral surface of the restraining hole 11 of the restraining die 10. Therefore, the inward and outward buckling of the non-processing scheduled portion 3 of raw material 1 is prevented, and the inward buckling of each processing scheduled portion 2 is prevented. And, each processing scheduled portion 2 of the raw material 1 is placed in the insertion hole 21 of the guide 20, and therefore the external peripheral surface of each processing scheduled portion 2 is restrained by the peripheral surface of the insertion hole 21. This prevents the outward buckling of the processing scheduled portion 2. Performing the upsetting in this state assuredly and efficiently enables each processing scheduled portion 2 of the raw material 1 to be expanded within the molding dented portion 21 so that the wall thickness increases, resulting in a high quality cylindrical upsetting manufactured product 6B.

Furthermore, since the hollow portion 3a, 2a and 2a of the processing scheduled portion 2 and both the processing scheduled portions 2 and 2 are filled with not a core bar but pressure fluid 25, the frictional force which acts on each processing scheduled portion 2 at the time of the processing can be reduced. This significantly reduces the molding pressure. Furthermore, there is an advantage that there is no need to remove a core bar from the hollow portion of the upsetting manufactured product 6B after completion of the processing.

Furthermore, since each processing scheduled portion 2 of the raw material 1 is expanded in a state in which the portion 2x of each processing scheduled portion 2 of the raw material 1 corresponding to the tip end portion 20a of the guide 20 is heated partially, only the portion 2x of each processing scheduled portion 2 of the raw material 1 corresponding to the tip end portion 20a of the guide 20 partially deteriorates in deformation resistance. Therefore, the molding pressure can be reduced. On the other hand, since the portion 2y of each processing scheduled portion 2 of the raw material 1 corresponding to the basal end side portion of the guide 20 rather than the tip end portion 20a of the guide 20 is not heated, the deformation resistance does not deteriorate. Therefore, it is possible to prevent that each end portion of the raw material 1 is crushed and deformed by the pressure from the punch 30.

Furthermore, since the portion 2x of each processing scheduled portion 2 of the raw material 1 corresponding to the tip end portion 20a of the guide 20 is partially heated with the heat of the axial end portion of the restraining die 10 by partially induction heating with the induction heating means 81, the portion 2x of the raw material 1 can be heated assuredly and efficiently.

And, in the sixth embodiment, the portion 2x of the raw material 1 can be heated into a half-molten state by raising the heating temperature. In this case, the molding pressure can be reduced substantially. The upsetting in this case is classified under the category of Thixomolding.

Furthermore, each processing scheduled portion 2 of the raw material 1 is expanded in a state in which the portion 2y of each processing scheduled portion 2 of the raw material 1 corresponding to the basal end side portion of the guide 20 rather than the tip end portion 20a of guide 20 is partially cooled by the cooling means 85. Therefore, the heating of the portion 2y of the raw material 1 can be prevented assuredly, which in turn can assuredly prevent the deterioration of the deformation resistance of the portion 2y of the raw material 1.

Therefore, according to the upsetting method of the sixth embodiment, a high quality cylindrical upsetting manufactured product 6B having an expanded portion 4 outwardly expanded with the increased wall thickness at each of the axial both end portions can be manufactured.

In the sixth embodiment, the portion 2x of each processing scheduled portion 2 of the raw material 1 corresponding to the tip end portion 20a of the guide 20 is partially heated by partially induction heating both the axial end portions of the restraining die 10 by the induction heating means 81. However, in the present invention, the portion 2x of the raw material 1 can be partially induction-heated by the induction heating means 81. In this case, the portion 2x of the raw material 1 can be heated assuredly and very efficiently. Furthermore, in this case, the restraining die 10 can be made of hard conductive material (e.g., heat resistant metal material) having heat resistance, such as, e.g., steel material, and also can be hard non-conductive material having heat resistance, such as, e.g., ceramics.

Furthermore, in the sixth embodiment, the number of the processing scheduled portion 2 of the raw material 1 is two. However, in the present invention, the number of the processing scheduled portion 2 can be one.

Here, in the sixth embodiment, each guide 20 is moved by the driving force of the guide driving apparatus 60 at the time of the upsetting. In the present invention, however, it is not necessarily required that each guide 20 is moved by such driving force. That is, in the present invention, each guide 20 can be moved by the pressing-back force acting on the guide 20 caused by the pressing of the molding dented portion 12 of the material of each processing scheduled portion 2 of the raw material 1. In this case, each guide 20 can be moved without using each guide driving apparatus 60, resulting in simplification of the upsetting apparatus 1F.

Although some embodiments of the present invention were explained above, the present invention is not limited to the aforementioned embodiments, and the embodiments can be modified in a various manner.

For example, the upsetting apparatus according to the present invention is not limited to an apparatus for manufacturing a preform for color members for bushes, a preform for a shank portion member for an arm for vehicles, or a cylindrical jointing member for friction stir welding, but also can be used as an apparatus for manufacturing preforms for various products.

Furthermore, in the present invention, a processing scheduled portion of a raw material located at the axial intermediate portion of the raw material can be inwardly or outwardly expanded by the upsetting method of the present invention so that the wall thickness increases to thereby form an expanded portion at the axial central portion of the raw material.

Furthermore, in the present invention, the processing scheduled portion of a raw material can be processed with the raw material heated to a prescribed temperature or with the raw material not heated. That is, the upsetting method according to the present invention can be a hot upsetting method or a cold upsetting method.

In the present invention, the restraining die and the guide can be divided members. In addition, the dividing number and the dividing position of the restraining die and the guide can be variously set according to the shape of the raw material and/or the upsetting manufactured product.

In the present invention, the raw material can be a cylindrical member, or an angular member for example.

Furthermore, in the present invention, the heating means 80 is not limited to the induction heating means 81, and can be any other heating means.

### EXAMPLE

Next, concrete examples of the present invention will be shown below. However, the present invention is not limited to the examples shown here.

A cylindrical raw material 1 made of extruded material was prepared. The raw material 1 was 30 mm in internal diameter, 40 mm in external diameter, and 5 mm in wall thickness. Each processing scheduled portion 2 of the raw material 1 was 120 mm in length. The material of the raw material 1 was JIS (Japanese Industrial Standards) A6061 aluminum alloy.

In Example 1, the raw material 1 was subjected to the upsetting by the same method as the upsetting method explained in the sixth embodiment using the upsetting apparatus 1F of the fourth embodiment. The molding pressure required at the time of the upsetting was measured. The results are shown in Table 1.

In Example 2, the raw material 1 was subjected to the upsetting by the same method as the upsetting method explained in the fourth embodiment using the upsetting apparatus 1D of the sixth embodiment. The molding pressure required at the time of the upsetting was measured. The results are shown in Table 1.

In Example 3, the raw material 1 was subjected to the upsetting using the upsetting apparatus 1D of the fourth embodiment. In Example 3, however, the entire raw material 1 was heated and was subjected to the upsetting. The molding pressure required at the time of the upsetting was measured. The results are shown in Table 1.

TABLE 1

| | Restraining | Heating | Heating | | Forming |
|---|---|---|---|---|---|
| | means | mode | temperature | Cooling | pressure |
| Example 1 | Pressure | Partial | 500° C. | Yes | 1.8 × 10⁷ Pa |
| | fluid | heating | | | |
| Example 2 | Core bar | Partial | 500° C. | Yes | 2.7 × 10⁷ Pa |
| | | heating | | | |
| Example 3 | Core bar | Entire | 400° C. | No | 4.7 × 10⁷ Pa |
| | | heating | | | |

In Table 1, “Restraining means” denotes a means for restraining the internal peripheral surfaces of the non-processing scheduled portion 3 and both the processing scheduled portions 2 and 2. In Example 1, as the restraining means, pressure fluid 95 consisting of argon gas was used. In Examples 2 and 3, as the restraining means, a core bar 40 was used.

In the “Heating mode” column, “Partial heating” denotes the case in which the portion 2x of each processing scheduled portion 2 of the raw material 1 corresponding to the tip end portion 20a of the guide 20 was heated partially. “Entire heating” denotes the case in which the entire raw material 1 was heated with the heating furnace, and then this raw material 1 in the heated state was quickly set to the upsetting apparatus 1D and subjected to the upsetting.

In the “Cooling” column, “Yes” denotes the case in which the portion 2y of each processing scheduled portion 2 of the raw material 1 corresponding to the portion of the basal end side rather than the tip end portion 20a of the guide 20 was partially cooled by each cooling means 85. “No” denotes the case in which no cooling was performed.

As shown in Table 1, when the pressure fluid 95 was used as a restricted means (Example 1), the molding pressure could have been reduced as compared with the case (Examples 2 and 3) where the core bar 40 was used.

Furthermore, when partial heating was performed (Examples 1 and 2), the molding pressure could have been reduced as compared with the case (Example 3) where the entire heating was performed.

It should be understood that the terms and expressions used herein are used for explanation and have no intention to be used to construe in a limited manner, do not eliminate any equivalents of features shown and mentioned herein, and allow various modifications falling within the claimed scope of the present invention.

### INDUSTRIAL APPLICABILITY

The present invention can be applied to an upsetting method for an cylindrical raw material capable of inwardly or outwardly expanding the processing scheduled portion of the cylindrical raw material so that the wall thickness increases, and an upsetting apparatus for a cylindrical raw material.

What is claimed is:

1. An upsetting method for a cylindrical raw material, comprising:
disposing a core bar in hollow portions of a processing scheduled portion and a non-processing scheduled portion of the cylindrical raw material, to thereby restrain internal peripheral surfaces of the processing scheduled portion and the non-processing scheduled portion by a peripheral surface of the core bar;
disposing the non-processing scheduled portion of the raw material in a restraining hole formed in a restraining die and extended in an axial direction thereof, to thereby restrain an external peripheral surface of the non-processing scheduled portion with a peripheral surface of the restraining hole;
disposing the processing scheduled portion of the raw material in a molding dented portion formed at an axial end portion of the restraining die;
disposing the processing scheduled portion of the raw material in an insertion hole formed in a guide and extended in the axial direction thereof; and
then, moving the guide in a direction opposite to a moving direction of a punch while pressurizing the processing scheduled portion of the raw material with the punch in an axial direction to thereby outwardly expand the processing scheduled portion of the raw material within the molding dented portion so that a wall thickness of the raw material increases.

2. The upsetting method for a cylindrical raw material as recited in claim 1, wherein the guide is moved by driving force of a guide driving apparatus.

3. The upsetting method for a cylindrical raw material as recited in claim 1, wherein “G” satisfies an equation of
G=(X_{g}−X)P/(L₀−Xₚ−Pt₀)
where
“P” denotes an average moving speed of the punch from the moving initiation thereof,
“G” denotes an average moving speed of the guide from the moving initiation thereof,
“X₀” denotes a buckling limit length at a cross-sectional area of the processing scheduled portion of the raw material before the upsetting,
“X” denotes an initial clearance between a tip end portion of the guide and a bottom portion of the molding dented portion (0≦X≦X₀),
“L₀” denotes a length of the raw material before the upsetting required for the expanded portion,
“X_{P}” denotes a stop position of the tip end portion of the punch with respect to the bottom portion of the molding dented portion obtained from a design volume of the expanded portion,
“X_{g}” denotes a stop position of the tip end portion of the guide with respect to the bottom portion of the molding dented portion defined by the design, and
“t₀” denotes a time lag from the moving initiation of the punch to the moving initiation of the guide (0≦t₀).

4. The upsetting method for a cylindrical raw material as recited in claim 1, wherein the guide is moved by pressing-back force acting on the guide generated by press-fitting the material of the processing scheduled portion of the raw material into the molding dented portion.

5. The upsetting method for a cylindrical raw material as recited in claim 1, wherein the tip end portion of the punch is formed into a cross-sectional shape corresponding to a cross-sectional shape of an axial end portion of the raw material.

6. The upsetting method for a cylindrical raw material as recited in claim 1, wherein the core bar is connected to the punch in such a manner that the core bar extends in an axial direction of the punch.

7. The upsetting method for a cylindrical raw material as recited in claim 6, wherein the core bar is connected to the punch via an extensible device capable of being extended and contracted in an axial direction, and
wherein the extensible device is contracted with a movement of the punch.

8. The upsetting method for a cylindrical raw material as recited in claim 1, wherein the processing scheduled portion of the raw material is expanded in a state in which the portion of the processing scheduled portion of the raw material corresponding to the tip end portion of the guide is partially heated.

9. The upsetting method for a cylindrical raw material as recited in claim 8, wherein the portion of the processing scheduled portion of the raw material corresponding to the tip end portion of the guide is partially induction-heated by an induction heating means.

10. The upsetting method for a cylindrical raw material as recited in claim 8, wherein the axial end portion of the restraining die is partially induction-heated by an induction heating means to thereby partially heat the portion of the processing scheduled portion of the raw material corresponding to the tip end portion of the guide.

11. The upsetting method for a cylindrical raw material as recited in claim 8, wherein the portion of the processing scheduled portion of the raw material corresponding to the tip end portion of the guide is partially heated into a half-molten state.

12. The upsetting method for a cylindrical raw material as recited in claim 8, wherein the processing scheduled portion of the raw material is expanded in a state in which the portion of the processing scheduled portion of the raw material corresponding to the portion of the basal end side of the guide rather than the tip end portion of the guide is partially cooled by a cooling means.

13. An upsetting manufactured product obtained by the upsetting method for a cylindrical raw material as recited in claim 1.

14. An upsetting method for a cylindrical raw material, comprising:
disposing a core bar in hollow portions of a non-processing scheduled portion of an axial intermediate portion of a cylindrical raw material and a processing scheduled portion of both axial end portions of the cylindrical raw material, to thereby restrain internal peripheral surfaces of the non-processing scheduled portion and both the processing scheduled portions by a peripheral surface of the core bar;
disposing the non-processing scheduled portion of the raw material in a restraining hole formed in a restraining die and extended in an axial direction thereof, to thereby restrain an external peripheral surface of the non-processing scheduled portion with a peripheral surface of the restraining hole;
disposing both the processing scheduled portions of the raw material in molding dented portions formed at both axial end portions of the restraining die;
disposing each processing scheduled portion of the raw material in an insertion hole formed in a guide and extended in the axial direction thereof; and
then, moving each guide in a direction opposite to a moving direction of the punch while simultaneously pressurizing each processing scheduled portion of the raw material with the punch in an axial direction to thereby outwardly expand each processing scheduled portion of the raw material within the corresponding molding dented portion so that a wall thickness of the raw material increases.

15. The upsetting method for a cylindrical raw material as recited in claim 14, wherein each guide is moved by driving force of a corresponding guide driving apparatus.

16. The upsetting method for a cylindrical raw material as recited in claim 14, wherein, in at least one of guides and a punch corresponding to the one of guides, “G” satisfies an equation of
G=(X_{g}−X)P/(L₀−Xₚ−Pt₀)
where
“P” denotes an average moving speed of the punch from the moving initiation thereof,
“G” denotes an average moving speed of the guide from the moving initiation thereof,
“X₀” denotes a buckling limit length at a cross-sectional area of the processing scheduled portion of the raw material before the upsetting,
“X” denotes an initial clearance between a tip end portion of the guide and a bottom portion of the molding dented portion (0≦X≦X₀),
“L₀” denotes a length of the raw material before the upsetting required for the expanded portion,
“X_{P}” denotes a stop position of the tip end portion of the punch with respect to the bottom portion of the molding dented portion obtained from a design volume of the expanded portion,
“X_{g}” denotes a stop position of the tip end portion of the guide with respect to the bottom portion of the molding dented portion defined by the design, and
“t₀” denotes a time lag from the moving initiation of the punch to the moving initiation of the guide (0≦t₀).

17. The upsetting method for a cylindrical raw material as recited in claim 14, wherein each guide is moved by pressing-back force acting on the guide generated by press-fitting the material of the corresponding processing scheduled portion of the raw material into the molding dented portion.

18. The upsetting method for a cylindrical raw material as recited in claim 14, wherein the tip end portion of each punch is formed into a cross-sectional shape corresponding to a cross-sectional shape of a corresponding axial end portion of the raw material.

19. The upsetting method for a cylindrical raw material as recited in claim 14, wherein the core bar is divided into divided core bar halves at the axial intermediate portion thereof, and
wherein each core bar half is connected to a corresponding punch with the divided core bar half extended in an axial direction of the punch.

20. The upsetting method for a cylindrical raw material as recited in claim 19, wherein each core bar half is connected to the corresponding punch via an extensible device capable of being extended and contracted in an axial direction, and
wherein each extensible device is contracted with a movement of the corresponding punch.

21. The upsetting method for a cylindrical raw material as recited in claim 14, wherein each processing scheduled portion of the raw material is expanded in a state in which the portion of each processing scheduled portion of the raw material corresponding to the tip end portion of the guide is partially heated.

22. The upsetting method for a cylindrical raw material as recited in claim 21, wherein the portion of each processing scheduled portion of the raw material corresponding to the tip end portion of the guide is partially induction-heated by an induction heating means.

23. The upsetting method for a cylindrical raw material as recited in claim 21, wherein both the axial end portions of the restraining die are partially induction-heated by induction heating means to thereby partially heat the portion of each processing scheduled portion of the raw material corresponding to the tip end portion of the guide.

24. The upsetting method for a cylindrical raw material as recited in claim 21, wherein the portion of each processing scheduled portion of the raw material corresponding to the tip end portion of the guide is partially heated into a half-molten state.

25. The upsetting method for a cylindrical raw material as recited in claim 21, wherein each processing scheduled portion of the raw material is expanded in a state in which the portion of each processing scheduled portion of the raw material corresponding to the portion of the basal end side of the guide rather than the tip end portion of the guide is partially cooled by a cooling means.

26. An upsetting manufactured product obtained by the upsetting method for a cylindrical raw material as recited in claim 14.

27. An upsetting method for a cylindrical raw material, comprising:
preparing a core bar having a core bar main body and a small diameter portion formed at an axial end portion of the core bar main body and smaller in diameter than the core bar main body;
disposing the core bar main body and the small diameter portion of the core bar in a hollow portion of a non-processing scheduled portion of a cylindrical raw material and a hollow portion of the processing scheduled portion of the cylindrical raw material, respectively, to thereby restrain the internal peripheral surface of the non-processing scheduled portion by a peripheral surface of the core bar main body and form a molding dented portion between an internal peripheral surface of the processing scheduled portion and the small diameter portion;
disposing the processing scheduled portion and the non-processing scheduled portion of the raw material in a restraining hole formed in a restraining die and extended in an axial direction, to thereby restrain external peripheral surfaces of the processing scheduled portion and the non-processing scheduled portion by a peripheral surface of the restraining hole;
disposing a guide in the hollow portion of the processing scheduled portion of the raw material, to thereby restrain the internal peripheral surface of the processing scheduled portion by the peripheral surface of the guide; and
then, moving the guide in a direction opposite to a moving direction of the punch while pressurizing the processing scheduled portion of the raw material with the punch in an axial direction to thereby inwardly expand the processing scheduled portion of the raw material within the molding dented portion so that a wall thickness of the raw material increases.

28. The upsetting method for a cylindrical raw material as recited in claim 27, wherein the guide is moved by driving force of a guide driving apparatus.

29. The upsetting method for a cylindrical raw material as recited in claim 27, wherein “G” satisfies an equation of
G=(X_{g}−X)P/(L₀−Xₚ−Pt₀)
where
“P” denotes an average moving speed of the punch from the moving initiation thereof,
“G” denotes an average moving speed of the guide from the moving initiation thereof,
“X₀” denotes a buckling limit length at a cross-sectional area of the processing scheduled portion of the raw material before the upsetting,
“X” denotes an initial clearance between a tip end portion of the guide and a bottom portion of the molding dented portion (0≦X≦X₀),
“L₀” denotes a length of the raw material before the upsetting required for the expanded portion,
“X_{P}” denotes a stop position of the tip end portion of the punch with respect to the bottom portion of the molding dented portion obtained from a design volume of the expanded portion,
“X_{g}” denotes a stop position of the tip end portion of the guide with respect to the bottom portion of the molding dented portion defined by the design, and
“t₀” denotes a time lag from the moving initiation of the punch to the moving initiation of the guide (0≦t₀).

30. The upsetting method for a cylindrical raw material as recited in claim 27, wherein the guide is moved by pressing-back force acting on the guide generated by press-fitting the material of the processing scheduled portion of the raw material into the molding dented portion.

31. The upsetting method for a cylindrical raw material as recited in claim 27, wherein the tip end portion of the punch is formed into a cross-sectional shape corresponding to a cross-sectional shape of an axial end portion of the raw material.

32. The upsetting method for a cylindrical raw material as recited in claim 27, wherein the core bar is connected to the guide in such a manner that the core bar extends in an axial direction of the guide.

33. The upsetting method for a cylindrical raw material as recited in claim 32, wherein the core bar is connected to the guide via an extensible device capable of being extended and contracted in an axial direction, and
wherein the extensible device is extended with a movement of the guide.

34. The upsetting method for a cylindrical raw material as recited in claim 27, wherein the processing scheduled portion of the raw material is expanded in a state in which the portion of the processing scheduled portion of the raw material corresponding to the tip end portion of the guide is partially heated.

35. The upsetting method for a cylindrical raw material as recited in claim 34, wherein the portion of the processing scheduled portion of the raw material corresponding to the tip end portion of the guide is partially induction-heated by an induction heating means.

36. The upsetting method for a cylindrical raw material as recited in claim 34, wherein the axial end portion of the restraining die is partially induction-heated by an induction heating means to thereby partially heat the portion of the processing scheduled portion of the raw material corresponding to the tip end portion of the guide.

37. The upsetting method for a cylindrical raw material as recited in claim 34, wherein the portion of the processing scheduled portion of the raw material corresponding to the tip end portion of the guide is partially heated into a half-molten state.

38. The upsetting method for a cylindrical raw material as recited in claim 34, wherein the processing scheduled portion of the raw material is expanded in a state in which the portion of the processing scheduled portion of the raw material corresponding to the portion of the basal end side of the guide rather than the tip end portion of the guide is partially cooled by a cooling means.

39. A cylindrical upsetting manufactured product obtained by the upsetting method for a cylindrical raw material as recited in claim 27.

40. An upsetting apparatus for a cylindrical raw material for outwardly expanding a processing scheduled portion of the cylindrical raw material so that a wall thickness of the processing scheduled portion increases, the upsetting apparatus, comprising:
a core bar disposed in hollow portions of the processing scheduled portion and a non-processing scheduled portion of the cylindrical raw material;
a restraining die having a restraining hole extended in an axial direction, wherein the non-processing scheduled portion of the raw material is to be disposed in the restraining hole;
a molding dented portion formed at an axial end portion of the restraining die;
a guide having an insertion hole extended in an axial direction, wherein the processing scheduled portion of the raw material is to be disposed in the insertion hole; and
a punch for pressurizing the processing scheduled portion of the raw material in the axial direction,
wherein the guide is movable in a direction opposite to a moving direction of the punch.

41. The upsetting apparatus for a cylindrical raw material as recited in claim 40, further comprising a guide driving apparatus for moving the guide in a direction opposite to the moving direction of the punch.

42. The upsetting apparatus for a cylindrical raw material as recited in claim 40, wherein the tip end portion of the punch is formed into a cross-sectional shape corresponding to a cross-sectional shape of an axial end portion of the raw material.

43. The upsetting apparatus for a cylindrical raw material as recited in claim 40, wherein the core bar is connected to the punch in such a manner that the core bar extends in an axial direction of the punch.

44. The upsetting apparatus for a cylindrical raw material as recited in claim 43, wherein the core bar is connected to the punch via an extensible device capable of being extended and contracted in an axial direction.

45. The upsetting apparatus for a cylindrical raw material as recited in claim 44, wherein the punch is equipped with the extensible device therein.

46. The upsetting apparatus for a cylindrical raw material as recited in claim 44, wherein the extensible device has a fluid pressure cylinder or a spring capable of being extended and contracted in an axial direction.

47. The upsetting apparatus for a cylindrical raw material as recited in claim 40, wherein chamfering work is given to the insertion hole opening edge portion of the tip end portion of the guide.

48. The upsetting apparatus for a cylindrical raw material as recited in claim 40, further comprising a heating means for partially heating the portion of the processing scheduled portion of the raw material corresponding to the tip end portion of the guide.

49. The upsetting apparatus for a cylindrical raw material as recited in claim 48, wherein the heating means is an induction heating means configured to partially induction-heat the portion of the processing scheduled portion of the raw material corresponding to the tip end portion of the guide.

50. The upsetting apparatus for a cylindrical raw material as recited in claim 48, wherein the heating means is an induction heating means configured to partially induction-heat the axial end portion of the restraining die to thereby partially heat the portion of the processing scheduled portion of the raw material corresponding to the tip end portion of the guide.

51. The upsetting apparatus for a cylindrical raw material as recited in claim 48, wherein the heating means is capable of partially heating the portion of the processing scheduled portion of the raw material corresponding to the tip end portion of the guide into a half-molten state.

52. The upsetting apparatus for a cylindrical raw material as recited in claim 48, further comprising a cooling means configured to partially cool the portion of the processing scheduled portion of the raw material corresponding to the portion of the basal end side of the guide rather than the tip end portion of the guide.

53. An upsetting apparatus for a cylindrical raw material for outwardly expanding processing scheduled portions of both axial end portions of the cylindrical raw material so that a wall thickness of each processing scheduled portion increases, the upsetting apparatus, comprising:
a core bar disposed in hollow portions of a non-processing scheduled potion of an axial intermediate portion of the cylindrical raw material and the processing scheduled portion of both axial end portions of the cylindrical raw material;
a restraining die having a restraining hole extended in an axial direction, wherein the non-processing scheduled portion of the raw material is to be disposed in the restraining hole;
two molding dented portions formed at axial both end portions of the restraining die;
two guides each having an insertion hole extended in an axial direction, wherein each processing scheduled portion of the raw material is to be disposed in the insertion hole; and
two punches each for pressurizing each processing scheduled portion of the raw material in the axial direction,
wherein each guide is movable in a direction opposite to a moving direction of the punch.

54. The upsetting apparatus for a cylindrical raw material as recited in claim 53, further comprising two guide driving apparatuses each for moving the corresponding guide in a direction opposite to the moving direction of the punch.

55. The upsetting apparatus for a cylindrical raw material as recited in claim 53, wherein the tip end portion of each punch is formed into a cross-sectional shape corresponding to a cross-sectional shape of a corresponding axial end portion of the raw material.

56. The upsetting apparatus for a cylindrical raw material as recited in claim 53, wherein the core bar is divided into divided core bar halves at the axial intermediate portion thereof, and
wherein each core bar half is connected to a corresponding punch with the divided core bar half extended in an axial direction of the punch.

57. The upsetting apparatus for a cylindrical raw material as recited in claim 56, wherein each core bar half is connected to the corresponding punch via an extensible device capable of being extended and contracted in an axial direction.

58. The upsetting apparatus for a cylindrical raw material as recited in claim 57, wherein each punch is equipped with the corresponding extensible device therein.

59. The upsetting apparatus for a cylindrical raw material as recited in claim 57, wherein the extensible device has a fluid pressure cylinder or a spring capable of being extended and contracted in an axial direction.

60. The upsetting apparatus for a cylindrical raw material as recited in claim 53, wherein chamfering work is given to the insertion hole opening edge portion of the tip end portion of each guide.

61. The upsetting apparatus for a cylindrical raw material as recited in claim 53, further comprising two heating means each for partially heating the portion of each processing scheduled portion of the raw material corresponding to the tip end portion of the guide.

62. The upsetting apparatus for a cylindrical raw material as recited in claim 61, wherein each heating means is an induction heating means configured to partially induction-heat the portion of each processing scheduled portion of the raw material corresponding to the tip end portion of the guide.

63. The upsetting apparatus for a cylindrical raw material as recited in claim 61, wherein each heating means is an induction heating means configured to partially induction-heat both the axial end portions of the restraining die to thereby partially heat the portion of each processing scheduled portion of the raw material corresponding to the tip end portion of the guide.

64. The upsetting apparatus for a cylindrical raw material as recited in claim 61, wherein each heating means is capable of partially heating the portion of the processing scheduled portion of the raw material corresponding to the tip end portion of the guide into a half-molten state.

65. The upsetting apparatus for a cylindrical raw material as recited in claim 61, further comprising two cooling means each configured to partially cool the portion of each processing scheduled portion of the raw material corresponding to the portion of the basal end side of the guide rather than the tip end portion of the guide.

66. An upsetting apparatus for a cylindrical raw material for inwardly expanding a processing scheduled portion of a cylindrical raw material so that a wall thickness increases, the upsetting apparatus, comprising:
a core bar having a core bar main body and a small diameter portion formed at an axial end portion of the core bar main body and smaller in diameter than the core bar main body, wherein the core bar main body and the small diameter portion are disposed in a hollow portion of the processing scheduled portion of the cylindrical raw material and a hollow portion of a non-processing scheduled portion of the cylindrical raw material, respectively, to thereby form a molding dented portion between an internal peripheral surface of the non-processing scheduled portion and the small diameter portion;
a restraining die having a restraining hole extended in an axial direction, wherein the processing scheduled portion and the non-processing scheduled portion of the raw material are to be disposed in the restraining hole;
a guide to be disposed in the hollow portion of the processing scheduled portion of the raw material; and
a punch configured to pressurize the processing scheduled portion of the raw material in an axial direction,
wherein the guide is movable in a direction opposite to a moving direction of the punch.

67. The upsetting apparatus for a cylindrical raw material as recited in claim 66, further comprising a guide driving apparatus for moving the guide in a direction opposite to the moving direction of the punch.

68. The upsetting apparatus for a cylindrical raw material as recited in claim 66, wherein the tip end portion of the punch is formed into a cross-sectional shape corresponding to a cross-sectional shape of an axial end portion of the raw material.

69. The upsetting apparatus for a cylindrical raw material as recited in claim 66, wherein the guide is disposed in a hollow portion formed in the punch and extended in an axial direction in a manner such that the guide is movable in an axial direction of the punch.

70. The upsetting apparatus for a cylindrical raw material as recited in claim 66, wherein the core bar is connected to the guide in such a manner that the core bar extends in an axial direction of the guide.

71. The upsetting apparatus for a cylindrical raw material as recited in claim 70, wherein the core bar is connected to the guide via an extensible device capable of being extended and contracted in an axial direction.

72. The upsetting apparatus for a cylindrical raw material as recited in claim 71, wherein the guide is equipped with the extensible device therein.

73. The upsetting apparatus for a cylindrical raw material as recited in claim 71, wherein the extensible device has a fluid pressure cylinder or a spring capable of being extended and contracted in an axial direction.

74. The upsetting apparatus for a cylindrical raw material as recited in claim 66, wherein chamfering work is given to a peripheral edge portion of a tip end portion of the guide.

75. The upsetting apparatus for a cylindrical raw material as recited in claim 66, further comprising a heating means for partially heating the portion of the processing scheduled portion of the raw material corresponding to the tip end portion of the guide.

76. The upsetting apparatus for a cylindrical raw material as recited in claim 75, wherein the heating means is an induction heating means configured to partially induction-heat the portion of the processing scheduled portion of the raw material corresponding to the tip end portion of the guide.

77. The upsetting apparatus for a cylindrical raw material as recited in claim 75, wherein the heating means is an induction heating means configured to partially induction-heat the axial end portion of the restraining die to thereby partially heat the portion of the processing scheduled portion of the raw material corresponding to the tip end portion of the guide.

78. The upsetting apparatus for a cylindrical raw material as recited in claim 75, wherein the heating means is capable of partially heating the portion of the processing scheduled portion of the raw material corresponding to the tip end portion of the guide into a half-molten state.

79. The upsetting apparatus for a cylindrical raw material as recited in claim 75, further comprising a cooling means configured to partially cool the portion of the processing scheduled portion of the raw material corresponding to the portion of the basal end side of the guide rather than the tip end portion of the guide.

80. An upsetting method for a cylindrical raw material, comprising:
filling hollow portions of a processing scheduled portion and a non-processing scheduled portion of a cylindrical raw material with pressure fluid, to thereby pressurize and restrain internal peripheral surfaces of the processing scheduled portion and the non-processing scheduled portion with the fluid pressure;
disposing the non-processing scheduled portion of the raw material in a restraining hole formed in a restraining die and extended in an axial direction, to thereby restrain an external peripheral surface of the non-processing scheduled portion with a peripheral surface of the restraining hole;
disposing the processing scheduled portion of the raw material in a molding dented portion formed at an axial end portion of the restraining die;
disposing the processing scheduled portion of the raw material in an insertion hole formed in a guide and extended in an axial direction;
then, moving the guide in a direction opposite to a moving direction of the punch while pressurizing the processing scheduled portion of the raw material with the punch in an axial direction to thereby outwardly expand the processing scheduled portion of the raw material within the molding dented portion so that a wall thickness of the raw material increases.

81. An upsetting method for a cylindrical raw material as recited in claim 80, wherein the guide is moved by driving force of a guide driving apparatus.

82. The upsetting method for a cylindrical raw material as recited in claim 80, wherein “G” satisfies an equation of
G=(X_{g}−X)P/(L₀−Xₚ−Pt₀)
where
“P” denotes an average moving speed of the punch from the moving initiation thereof,
“G” denotes an average moving speed of the guide from the moving initiation thereof,
“X₀” denotes a buckling limit length at a cross-sectional area of the processing scheduled portion of the raw material before the upsetting,
“X” denotes an initial clearance between a tip end portion of the guide and a bottom portion of the molding dented portion (0≦X≦X₀),
“L₀” denotes a length of the raw material before the upsetting required for the expanded portion,
“X_{P}” denotes a stop position of the tip end portion of the punch with respect to the bottom portion of the molding dented portion obtained from a design volume of the expanded portion,
“X_{g}” denotes a stop position of the tip end portion of the guide with respect to the bottom portion of the molding dented portion defined by the design, and
“t₀” denotes a time lag from the moving initiation of the punch to the moving initiation of the guide (0≦t₀).

83. The upsetting method for a cylindrical raw material as recited in claim 80, wherein the guide is moved by pressing-back force acting on the guide generated by press-fitting the material of the processing scheduled portion of the raw material into the molding dented portion.

84. The upsetting method for a cylindrical raw material as recited in claim 80, wherein the tip end portion of the punch is formed into a cross-sectional shape corresponding to a cross-sectional shape of an axial end portion of the raw material.

85. The upsetting method for a cylindrical raw material as recited in claim 80, wherein the processing scheduled portion of the raw material is expanded in a state in which the portion of the processing scheduled portion of the raw material corresponding to the tip end portion of the guide is partially heated.

86. The upsetting method for a cylindrical raw material as recited in claim 85, wherein the portion of the processing scheduled portion of the raw material corresponding to the tip end portion of the guide is partially induction-heated by an induction heating means.

87. The upsetting method for a cylindrical raw material as recited in claim 85, wherein the axial end portion of the restraining die is partially induction-heated by an induction heating means to thereby partially heat the portion of the processing scheduled portion of the raw material corresponding to the tip end portion of the guide.

88. The upsetting method for a cylindrical raw material as recited in claim 85, wherein the portion of the processing scheduled portion of the raw material corresponding to the tip end portion of the guide is partially heated into a half-molten state.

89. The upsetting method for a cylindrical raw material as recited in claim 85, wherein the processing scheduled portion of the raw material is expanded in a state in which the portion of the processing scheduled portion of the raw material corresponding to the portion of the basal end side of the guide rather than the tip end portion of the guide is partially cooled by a cooling means.

90. A cylindrical upsetting manufactured product obtained by the upsetting method for a cylindrical raw material as recited in claim 80.

91. An upsetting method for a cylindrical raw material, comprising:
filling hollow portions of a non-processing scheduled potion of an axial intermediate portion of the cylindrical raw material and a processing scheduled portion of both axial end portions of the cylindrical raw material with pressure fluid, to thereby pressurize and restrain internal peripheral surfaces of the processing scheduled portion and the non-processing scheduled portion with the fluid pressure;
disposing the non-processing scheduled portion of the raw material in a restraining hole formed in a restraining die and extended in an axial direction, to thereby restrain an external peripheral surface of the non-processing scheduled portion with a peripheral surface of the restraining hole;
disposing both the processing scheduled portions of the raw material in molding dented portions formed at both axial end portions of the restraining die;
disposing each processing scheduled portion of the raw material in an insertion hole formed in a guide and extended in an axial direction;
then, moving each guide in a direction opposite to a moving direction of the punch while simultaneously pressurizing each processing scheduled portion of the raw material with the punch in an axial direction to thereby outwardly expand each processing scheduled portion of the raw material within the corresponding molding dented portion so that a wall thickness of the raw material increases.

92. The upsetting method for a cylindrical raw material as recited in claim 91, wherein each guide is moved by driving force of a corresponding guide driving apparatus.

93. The upsetting method for a cylindrical raw material as recited in claim 91, wherein, in at least one of guides and a punch corresponding to the one of guides, “G” satisfies an equation of
G=(X_{g}−X)P/(L₀−Xₚ−Pt₀)
where
“P” denotes an average moving speed of the punch from the moving initiation thereof,
“G” denotes an average moving speed of the guide from the moving initiation thereof,
“X₀” denotes a buckling limit length at a cross-sectional area of the processing scheduled portion of the raw material before the upsetting,
“X” denotes an initial clearance between a tip end portion of the guide and a bottom portion of the molding dented portion (0≦X≦X₀),
“L₀” denotes a length of the raw material before the upsetting required for the expanded portion,
“X_{P}” denotes a stop position of the tip end portion of the punch with respect to the bottom portion of the molding dented portion obtained from a design volume of the expanded portion,
“X_{g}” denotes a stop position of the tip end portion of the guide with respect to the bottom portion of the molding dented portion defined by the design, and
“t₀” denotes a time lag from the moving initiation of the punch to the moving initiation of the guide (0≦t₀).

94. The upsetting method for a cylindrical raw material as recited in claim 91, wherein each guide is moved by pressing-back force acting on the guide generated by press-fitting the material of the corresponding processing scheduled portion of the raw material into the molding dented portion.

95. The upsetting method for a cylindrical raw material as recited in claim 91, wherein the tip end portion of each punch is formed into a cross-sectional shape corresponding to a cross-sectional shape of a corresponding axial end portion of the raw material.

96. The upsetting method for a cylindrical raw material as recited in claim 91, wherein each processing scheduled portion of the raw material is expanded in a state in which the portion of each processing scheduled portion of the raw material corresponding to the tip end portion of the guide is partially heated.

97. The upsetting method for a cylindrical raw material as recited in claim 96, wherein the portion of each processing scheduled portion of the raw material corresponding to the tip end portion of the guide is partially induction-heated by an induction heating means.

98. The upsetting method for a cylindrical raw material as recited in claim 96, wherein both the axial end portions of the restraining die are partially induction-heated by induction heating means to thereby partially heat the portion of each processing scheduled portion of the raw material corresponding to the tip end portion of the guide.

99. The upsetting method for a cylindrical raw material as recited in claim 96, wherein the portion of each processing scheduled portion of the raw material corresponding to the tip end portion of the guide is partially heated into a half-molten state.

100. The upsetting method for a cylindrical raw material as recited in claim 96, wherein each processing scheduled portion of the raw material is expanded in a state in which the portion of each processing scheduled portion of the raw material corresponding to the portion of the basal end side of the guide rather than the tip end portion of the guide is partially cooled by a cooling means.

101. A cylindrical upsetting manufactured product obtained by the upsetting method for a cylindrical raw material as recited in claim 91.

102. An upsetting apparatus for a cylindrical raw material for outwardly expanding a processing scheduled portion of the cylindrical raw material so that a wall thickness of the processing scheduled portion increases, the upsetting apparatus, comprising:
a pressure fluid filling means configured to fill hollow portions of a processing scheduled portion and a non-processing scheduled portion of the cylindrical raw material with pressure fluid;
a restraining die having a restraining hole extended in an axial direction, wherein the non-processing scheduled portion of the raw material is to be disposed in the restraining hole;
a molding dented portion formed in an axial end portion of the restraining die;
a guide having an insertion hole extended in an axial direction, wherein the processing scheduled portion of the raw material is to be disposed in the insertion hole; and
a punch for pressurizing the processing scheduled portion of the raw material in the axial direction,
wherein the guide is movable in a direction opposite to a moving direction of the punch.

103. The upsetting apparatus for a cylindrical raw material as recited in claim 102, further comprising a guide driving apparatus for moving the guide in a direction opposite to the moving direction of the punch.

104. The upsetting apparatus for a cylindrical raw material as recited in claim 102, wherein the tip end portion of the punch is formed into a cross-sectional shape corresponding to a cross-sectional shape of an axial end portion of the raw material.

105. The upsetting apparatus for a cylindrical raw material as recited in claim 102, wherein chamfering work is given to the insertion hole opening edge portion of the tip end portion of the guide.

106. The upsetting apparatus for a cylindrical raw material as recited in claim 102, further comprising a heating means for partially heating the portion of the processing scheduled portion of the raw material corresponding to the tip end portion of the guide.

107. The upsetting apparatus for a cylindrical raw material as recited in claim 106, wherein the heating means is an induction heating means configured to partially induction-heat the portion of the processing scheduled portion of the raw material corresponding to the tip end portion of the guide.

108. The upsetting apparatus for a cylindrical raw material as recited in claim 106, wherein the heating means is an induction heating means configured to partially induction-heat the axial end portion of the restraining die to thereby partially heat the portion of the processing scheduled portion of the raw material corresponding to the tip end portion of the guide.

109. The upsetting apparatus for a cylindrical raw material as recited in claim 106, wherein the heating means is capable of partially heating the portion of the processing scheduled portion of the raw material corresponding to the tip end portion of the guide into a half-molten state.

110. The upsetting apparatus for a cylindrical raw material as recited in claim 106, further comprising a cooling means configured to partially cool the portion of the processing scheduled portion of the raw material corresponding to the portion of the basal end side of the guide rather than the tip end portion of the guide.

111. An upsetting apparatus for a cylindrical raw material for outwardly expanding processing scheduled portions of both axial end portions of the cylindrical raw material so that a wall thickness of the processing scheduled portion increases, the upsetting apparatus, comprising:
a pressure fluid filling means configured to fill hollow portions of a non-processing scheduled portion of an axial intermediate portion of the cylindrical raw material and processing scheduled portions of both axial end portions of the cylindrical raw material with pressure fluid;
a restraining die having a restraining hole extended in an axial direction, wherein the non-processing scheduled portion of the raw material is to be disposed in the restraining hole;
two molding dented portions formed at both axial end portions of the restraining die;
two guides each having an insertion hole extended in an axial direction, wherein the processing scheduled portion of the raw material is to be disposed in the insertion hole; and
two punches each for pressurizing the processing scheduled portion of the raw material in the axial direction,
wherein each guide is movable in a direction opposite to a moving direction of the punch.

112. The upsetting apparatus for a cylindrical raw material as recited in claim 111, further comprising two guide driving apparatuses each for moving the corresponding guide in a direction opposite to the moving direction of the punch.

113. The upsetting apparatus for a cylindrical raw material as recited in claim 111, wherein the tip end portion of each punch is formed into a cross-sectional shape corresponding to a cross-sectional shape of a corresponding axial end portion of the raw material.

114. The upsetting apparatus for a cylindrical raw material as recited in claim 111, wherein chamfering work is given to the insertion hole opening edge portion of the tip end portion of each guide.

115. The upsetting apparatus for a cylindrical raw material as recited in claim 111, further comprising two heating means each for partially heating the portion of each processing scheduled portion of the raw material corresponding to the tip end portion of the guide.

116. The upsetting apparatus for a cylindrical raw material as recited in claim 115, wherein each heating means is an induction heating means configured to partially induction-heat the portion of each processing scheduled portion of the raw material corresponding to the tip end portion of the guide.

117. The upsetting apparatus for a cylindrical raw material as recited in claim 115, wherein each heating means is an induction heating means configured to partially induction-heat both the axial end portions of the restraining die to thereby partially heat the portion of the processing scheduled portion of the raw material corresponding to the tip end portion of the guide.

118. The upsetting apparatus for a cylindrical raw material as recited in claim 115, wherein each heating means is capable of partially heating the portion of the processing scheduled portion of the raw material corresponding to the tip end portion of the guide into a half-molten state.

119. The upsetting apparatus for a cylindrical raw material as recited in claim 115, further comprising two cooling means each configured to partially cool the portion of each processing scheduled portion of the raw material corresponding to the portion of the basal end side of the guide rather than the tip end portion of the guide.
